(19) United States
(12) Patent Application Publication
(10) Pub. No.: US 2019/0171665 A1
(43) Pub. Date: Jun. 6, 2019

(54) IMAGE SIMILARITY SEARCH VIA HASHES WITH EXPANDED DIMENSIONALITY AND SPARSIFICATION

(71) Applicant: Salk Institute for Biological Studies, La Jolla, CA (US)

(72) Inventors: Saket Navlakha, La Jolla, CA (US); Charles F. Stevens, La Jolla, CA (US)

(73) Assignee: Salk Institute for Biological Studies, La Jolla, CA (US)

(21) Appl. No.: 16/211,190

(22) Filed: Dec. 5, 2018

Related U.S. Application Data
(60) Provisional application No. 62/594,977, filed on Dec. 5, 2017.
(60) Provisional application No. 62/594,966, filed on Dec. 5, 2017.

(51) Int. Cl. G06F 16/532; G06K 9/62; G06F 16/51; G06F 16/538; G06F 16/56

(52) U.S. Cl. CPC G06F 16/532; G06K 9/6215; G06F 16/56; G06F 16/538; G06F 16/51

(57) ABSTRACT

Image similarity searching can be achieved by improving utilization of computing resources so that computing power can be reduced while maintaining accuracy or accuracy can be improved using a same level of computing power. Such a similarity search can be achieved via an expansion matrix that expands the number of dimensions in an input feature vector of a query image. Dimensionality of an input feature vector can be increased, resulting in a higher dimensional hash. Sparsification can then be applied to the resulting higher dimensional hash. Sparsification can use a winner-take-all technique or setting a threshold, resulting in a hash of reduced length, but can still be considered of the expanded dimensionality. Matching the query image against a corpus of sample images can be achieved via nearest neighbor techniques via the resulting hashes to find sample images matching the query image.

### CROSS REFERENCE TO RELATED APPLICATIONS

This application claims the benefit of U.S. Provisional Application No. 62/594,977, filed Dec. 5, 2017, and U.S. Provisional Application No. 62/594,966, filed Dec. 5, 2017, both of which are hereby incorporated herein by reference in their entirety.

### FIELD

The field relates to image similarity search technologies implemented via hashes with expanded dimensionality and sparsification.

### BACKGROUND

Similarity search is a fundamental computing problem faced by large-scale information retrieval systems. Although a number of techniques have been developed to increase efficiency, there still remains room for improvement.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In one embodiment, a computer-implemented method of performing an image similarly search comprises, for a query image, generating a query image hash via a hash model, wherein generating the query image hash comprises expanding dimensionality of a query image feature vector representing the query image and sparsifying the hash after expanding dimensionality; matching the query image hash against hashes in a sample image hash database, wherein the hashes in the sample image hash database are previously generated via the hash model for respective sample images and represent the respective sample images, and wherein the matching identifies one or more matching hashes in the database; and outputting the one or more matching hashes as a result of the similarity search.

In another embodiment, an image similarity search system comprises one or more processors; and memory coupled to the one or more processors, wherein the memory comprises computer-executable instructions causing the one or more processors to perform a process comprising, for a query image, generating a query image hash via a hash model, wherein generating the query image hash comprises expanding dimensionality of a query image feature vector representing the query image and sparsifying the hash after expanding dimensionality; matching the query image hash against hashes in a sample image hash database, wherein the hashes in the sample image hash database are previously generated via the hash model for respective sample images and represent the respective sample images, and wherein the matching identifies one or more matching hashes in the database; and outputting the one or more matching hashes as a result of the similarity search.

In a further embodiment, one or more computer-readable media has encoded thereon computer-executable instructions that, when executed, cause a computing system to perform a similarity search method comprising receiving one or more sample images; extracting feature vectors from the sample images, the extracting generating sample image feature vectors; normalizing the sample image feature vectors; with a hash model, generating sample image hashes from the normalized sample image feature vectors, wherein the hash model expands dimensionality of the normalized sample image feature vectors and subsequently sparsifies the sample image hashes after expanding dimensionality; storing the hashes generated from the normalized sample image feature vectors into a sample image hash database; receiving a query image; extracting a feature vector from the query image, the extracting generating a query image feature vector; normalizing the query image feature vector; with the hash model, generating a query image hash from the normalized query image feature vector, wherein the hash model expands dimensionality of the normalized query image feature vector and subsequently sparsifies the query image hash after expanding dimensionality; matching the query image hash against hashes in the sample image hash database; and outputting matching sample image hashes of the sample image hash database as a result of the similarity search.

As described herein, a variety of other features and advantages can be incorporated into the technologies as desired.

### BRIEF DESCRIPTION OF THE DRAWINGS

FIG. 1 is a block diagram of an example system implementing similarity search via hashes with expanded dimensionality and sparsification.

FIG. 2 is a flowchart of an example method implementing similarity search via hashes with expanded dimensionality and sparsification.

FIG. 3 is a block diagram of an example system implementing feature extraction.

FIG. 4 is a flowchart of an example method of implementing feature extraction.

FIG. 5 is a block diagram of an example system implementing feature vector normalization.

FIG. 6 is a flowchart of an example method of implementing feature vector normalization.

FIG. 7 is a block diagram of an example system implementing hash generation that expands dimensionality and sparsifies the hash.

FIG. 8 is a flowchart of an example method implementing hash generation that expands dimensionality and sparsifies the hash.

FIG. 9 is a block diagram of an example sparse, binary random expansion matrix.

FIG. 10 is a block diagram of an example system implementing matching.

FIG. 11 is a flowchart of an example method implementing matching.

FIG. 12 is a block diagram of an example system implementing sparsification.

FIG. 13 is a flowchart of an example method implementing sparsification.

FIG. 14 is a flowchart of an example method of configuring a system as described herein.

FIG. 15 is a data flow diagram of a system implementing similarity search technologies described herein.

FIG. 16 is a block diagram of an example system implementing similarity search via pseudo-hashes with reduced dimensionality.

FIG. 17 is a flowchart of an example method implementing similarity search via pseudo-hashes with reduced dimensionality.

FIG. 18 is a block diagram of an example system implementing similarity search via hashes with expanded dimensionality and sparsification using candidate matches from pseudo-hashing with reduced dimensionality.

FIG. 19 is a flowchart of an example method implementing similarity search via hashes with expanded dimensionality and sparsification using candidate matches from pseudo-hashing with reduced dimensionality.

FIG. 20 is a block diagram of an example system implementing pseudo-hash generation that reduces dimensionality of a hash.

FIG. 21 is a flowchart of an example method implementing similarity search via pseudo-hashes with reduced dimensionality.

FIG. 22 is a block diagram of an example system implementing matching.

FIG. 23 is a flowchart of an example method implementing matching.

FIG. 24 is a block diagram of an example system implementing hash generation that expands dimensionality and sparsifies the hash.

FIG. 25 is a flowchart of an example method implementing hash generation that expands dimensionality and sparsifies the hash.

FIG. 26 is a block diagram of an example system implementing sparsification.

FIG. 27 is a flowchart of an example method implementing sparsification.

FIG. 28 is a data flow diagram of a system implementing similarity search technologies described herein.

FIG. 29 is a diagram of an example computing system in which described embodiments can be implemented.

FIGS. 30A-30C show mapping between the fly olfactory circuit and locality-sensitive hashing (LSH). FIG. 30A shows a schematic of the fly olfactory circuit. In step 1, 50 ORNs in the fly's nose send axons to 50 PNs in the glomeruli; as a result of this projection, each odor is represented by an exponential distribution of firing rates, with the same mean for all odors and all odor concentrations. In step 2, the PNs expand the dimensionality, projecting to 2000 KCs connected by a sparse, binary random projection matrix. In step 3, the KCs receive feedback inhibition from the anterior paired lateral (APL) neuron, which leaves only the top 5% of KCs to remain firing spikes for the odor. This 5% corresponds to the tag (hash) for the odor. FIG. 30B illustrates odor responses. Similar pairs of odors (e.g., methanol and ethanol) are assigned more similar tags than are dissimilar odors. Darker shading denotes higher activity. FIG. 30C shows differences between conventional LSH and the fly algorithm. In the example, the computational complexity for LSH and the fly are the same. The input dimensionality d=5. LSH computes m=3 random projections, each of which requires 10 operations (five multiplications plus five additions). The fly computes m=15 random projections, each of which requires two addition operations. Thus, both require 30 total operations. x, input feature vector; r, Gaussian random variable; w, bin width constant for discretization.

FIGS. 31A and 31B show an empirical comparison of different random projection types and tag-selection methods. In all plots, the x axis is the length of the hash, and the y axis is the mean average precision denoting how accurately the true nearest neighbors are found (higher is better). FIG. 31A shows that sparse, binary random projections offer near-identical performance to that of dense, Gaussian random projections, but the former provide a large savings in computation. FIG. 31B shows that the expanded-dimension (from k to 20 k) plus winner-take-all (WTA) sparsification further boosts performance relative to non-expansion (the top line in all three graphs) compared with either expanded-dimension (from k to 20 k) plus sparsification using random selection (random) or no expansion. The results for expanded-dimension (from k to 20 k) plus sparsification using random selection (random) and no expansion overlap as the bottom line in all three graphs. Results are consistent across all three benchmark data sets. Error bars indicate standard deviation over 50 trials.

FIG. 32 shows an overall comparison between the fly algorithm and LSH. In all plots, the x axis is the length of the hash, and the y axis is the mean average precision (higher is better). A 10 d expansion was used for the fly. Across all three data sets, the fly's method outperforms LSH, most prominently for short hash lengths. Error bars indicate standard deviation over 50 trials.

FIG. 33 shows a table indicating the generality of locality-sensitive hashing in the brain. Shown are the steps used in the fly olfactory circuit and their potential analogs in vertebrate brain regions.

FIG. 34 shows a comparison of different sampling levels in the sparse, binary random projection. As shown at the left and right, the 10% and 50% lines overlap (top overlapping lines) in both the SIFT and MNIST datasets, but all three sampling levels overlap with the GLOVE dataset (middle).

FIGS. 35A-35C show an analysis of the GIST dataset. FIG. 35A shows a similar performance of sparse, binary compared to dense, Gaussian random projections. FIG. 35B shows performance gains using winner-take-all compared to random tag selection. FIG. 35C shows further performance gains for the fly algorithm with a 10 d expansion compared to a 20 k expansion in FIG. 35B.

FIG. 36 shows the fly (top line in each graph) versus LSH using binary locality-sensitive hashing.

FIG. 37 shows an overview of the fly hashing algorithms.

FIGS. 38A and 38B show precision-recall for the MNIST, GLoVE, LabelMe, and Random datasets (the bars for the different algorithms are indicated as SimHash, WTAHash, FlyHash, and DenseFly, left to right, for each hash length). In FIG. 38A, k=20. In FIG. 38B, k=4. In each panel, the x-axis is the hash length, and the y-axis is the area under the precision-recall curve (higher is better). For all datasets and hash lengths, DenseFly performs the best.

FIG. 39 shows precision-recall for the SIFT-1M and GIST-1M datasets (the bars for the different algorithms are indicated as SimHash, WTAHash, FlyHash, and DenseFly, left to right, for each hash length). In each panel, the x-axis is the hash length, and the y-axis is the area under the precision-recall curve (higher is better). The first two panels shows results for SIFT-1M and GIST-1M using k=4; the latter two show results fork=20. DenseFly is comparable to or outperforms all other algorithms.

FIGS. 40A and 40B shows query time versus mAP for the 10 k-item datasets. In FIG. 40A, k=20. In FIG. 40B, k=4. In each panel, the x-axis is query time, and the y-axis is the mean average precision (higher is better) of ranked candidates using a hash length m=16. Each successive dot on each curve corresponds to an increasing search radius. For nearly all datasets and query times, DenseFly with pseudo-hash binning performs better (top line in each graph) than SimHash with multi-probe binning The arrow in each panel indicates the gain in performance for DenseFly at a query time of 0.01 seconds.

FIG. 41 shows the performance of multi-probe hashing for four datasets. Across all datasets, DenseFly achieves similar mAP as SimHash, but with 2× faster query times, 4× fewer hash tables, 4-5× less indexing time, and 2-4× less memory usage. FlyHash-MP evaluates the multi-probe technique applied to the original FlyHash algorithm. DenseFly and FlyHash-MP require similar indexing time and memory, but DenseFly achieves higher mAP. FlyHash without multi-probe ranks the entire database per query; it therefore does not build an index and has large query times. Performance is shown normalized to that of SimHash. WTA factor, k=4 and hash length, m=16 were used.

FIG. 42 shows Kendall-τ rank correlations for all 10 k-item datasets. Across all datasets and hash lengths, DenseFly achieves a higher rank correlation between l₂ distance in input space and l₁ distance in hash space. Averages and standard deviations are shown over 100 queries. All results shown are for WTA factor, k=20. Similar performance gains for DenseFly over other algorithms with k=4 (not shown).

FIGS. 43A-43E show an example algorithm of a hash with sparse, binary random projection and winner-take-all (WTA) sparsification.

### DETAILED DESCRIPTION

Unless otherwise explained, all technical and scientific terms used herein have the same meaning as commonly understood by one of ordinary skill in the art to which this invention belongs. The singular terms “a,” “an,” and “the” include plural referents unless context clearly indicates otherwise. Similarly, the word “or” is intended to include “and” unless the context clearly indicates otherwise. Hence “comprising A or B” means including A, or B, or A and B.

### EXAMPLE 1

### Example Overview

A wide variety of hashing techniques can be used that implement expanded dimensionality and sparsification. The resulting hashes can be used for similarity searching. Similarity searching implementations using such hashes can maintain a level of accuracy observed in conventional approaches while reducing overall computing power. Similarly, the same or less computing power can be applied while increasing accuracy.

### EXAMPLE 2

### Example System Implementing Similarity Search via Hashes with Expanded Dimensionality and Sparsification

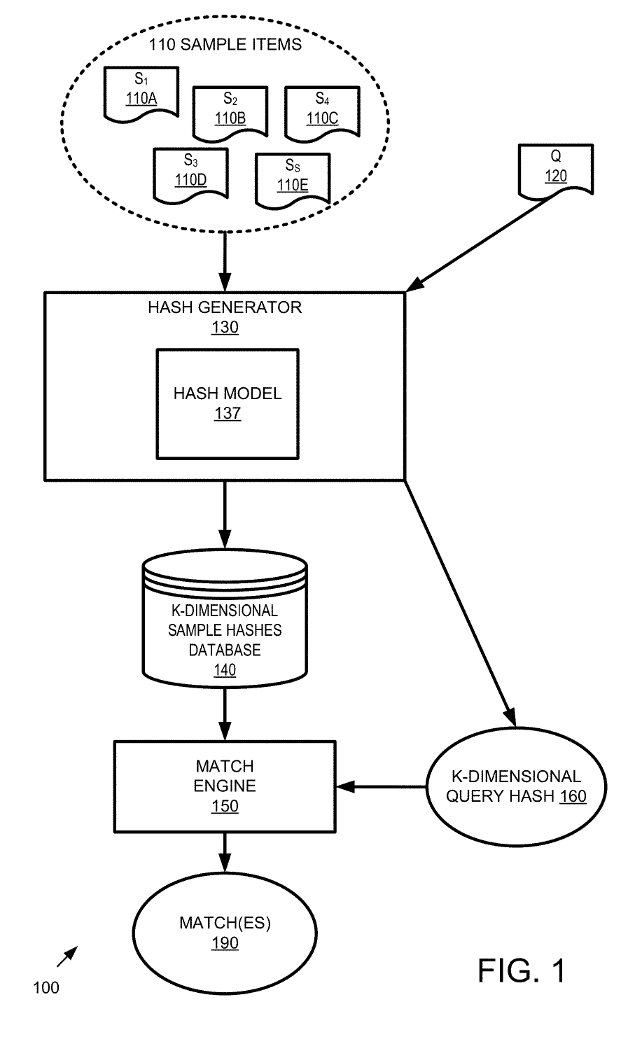

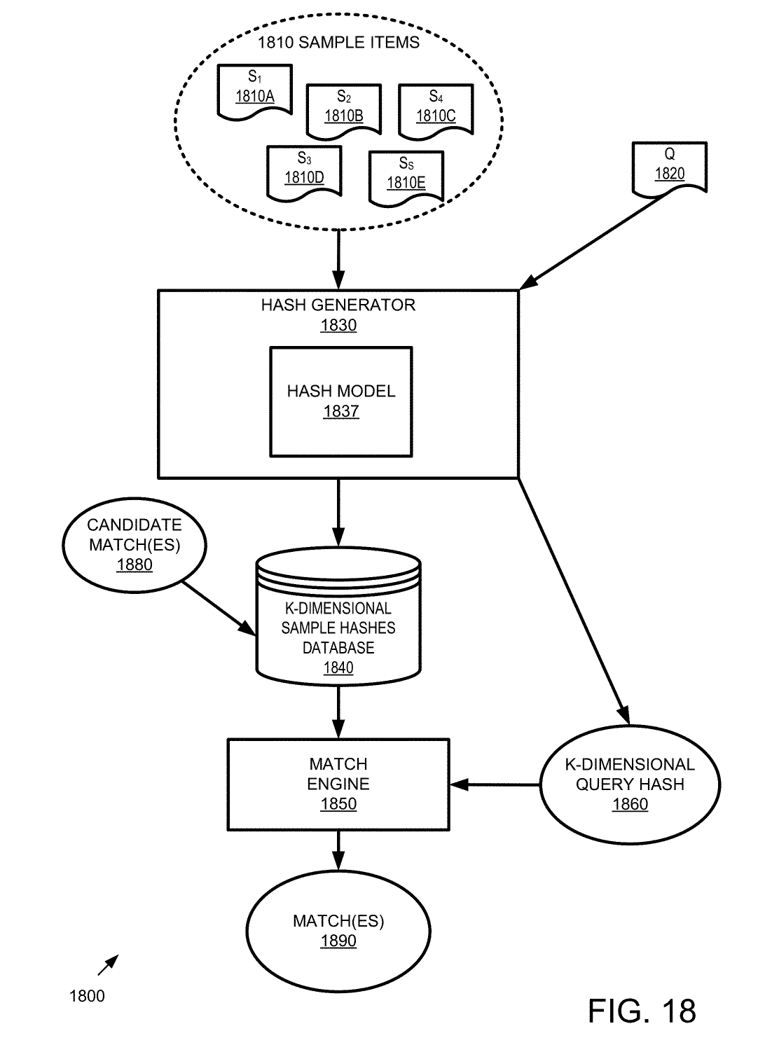

FIGS. 1 and 18 are block diagrams of example systems 100 and 1800, respectively, implementing similarity search via hashes with expanded dimensionality and sparsification.

In the illustrated example, both training and use of the technologies are shown. However, in practice, either phase of the technology can be used independently (e.g., a system can be trained and then deployed to be used independently of any training activity) or in tandem (e.g., training continues after deployment). A hash generator 130 or 1830 can receive a corpus of a plurality of sample items 110A-E or 1810A-E and generate a respective K-dimensional sample hashes stored in a database 140 or 1840. In practice, the sample items 110A-E or 1810A-E can be converted to feature vectors for input to the hash generator 130 or 1830. So, the actual sample items 110A-E 1810A-E need not be received to implement training Feature vectors can be received instead. Normalization can be implemented as described herein. The hashes in the database 140 or 1840 represent respective sample items 110A-E or 1810A-E.

The hash generators 130 and 1830 comprise hash models 137 and 1837, respectively, that expand dimensionality of the incoming feature vectors and also subsequently implement sparsification of the hash as described herein. Various features can be implemented by the model 137 or 1837, including winner-take-all functionality, setting a threshold, random projection, binary projection, dense projection, Gaussian projection, and the like as described herein.

To use the similarity searching technologies, a query item 120 or 1820 is received. Similar to the sample items 110A-E or 1810A-E, the query item 120 or 1820 can be converted into a feature vector for input to the hash generator 130 or 1830. So, the actual query item 120 or 1820 need not be received to implement searching. A feature vector can be received instead. Normalization can be implemented as described herein.

The hash generator 130 or 1830 generates a K-dimensional query hash 160 or 1860 for the query item 120 or 1820. The same or similar features used to generate hashes for the sample items 110A-E or 1810A-E can be used as described herein.

The match engine 150 or 1850 receives the K-dimensional query hash 160 or 1860 and finds one or more matches 190 or 1890 from the hash database 140 or 1840. In practice, an intermediate result indicating one or more matching hashes can be used to determine the one or more corresponding matching sample items (e.g., the items associated with the matching hashes) or one or more bins assigned to the sample items.

Although databases 140 and 1840 are shown, in practice, the sample hashes can be stored in a variety of ways without being implemented in an actual database. For example, a hash table, binary object, unstructured storage, or the like can be used. In practice, all sample hashes can be stored in a database (e.g., database 140) or a subset of sample hashes (e.g., database 1840), for example, sample hashes for candidate matches determined using intermediate matching results (e.g., via pseudo-hashing, for example, using method 1700).

In any of the examples herein, although some of the subsystems are shown in a single box, in practice, they can be implemented as systems having more than one device. Boundaries between the components can be varied. For example, although the hash generator is shown as a single entity, it can be implemented by a plurality of devices across a plurality of physical locations.

In practice, the systems shown herein, such as system 100 or 1800, can vary in complexity, with additional functionality, more complex components, and the like. For example, additional services can be implemented as part of the hash generator 130 or 1830. Additional components can be included to implement cloud-based computing, security, redundancy, load balancing, auditing, and the like.

The described systems can be networked via wired or wireless network connections to a global computer network (e.g., the Internet). Alternatively, systems can be connected through an intranet connection (e.g., in a corporate environment, government environment, educational environment, research environment, or the like).

The system 100 or 1800 and any of the other systems described herein can be implemented in conjunction with any of the hardware components described herein, such as the computing systems described below (e.g., processing units, memory, and the like). In any of the examples herein, the inputs, outputs, feature vectors, hashes, matches, and the like can be stored in one or more computer-readable storage media or computer-readable storage devices. The technologies described herein can be generic to the specifics of operating systems or hardware and can be applied in any variety of environments to take advantage of the described features.

### EXAMPLE 3

### Example Method Implementing Similarity Search via Hashes with Expanded Dimensionality and Sparsification

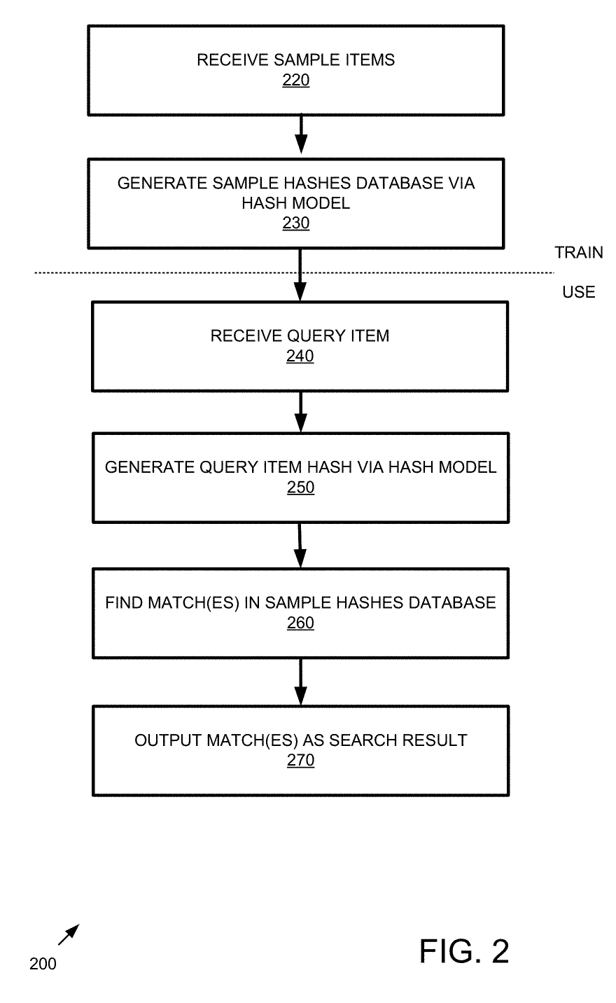

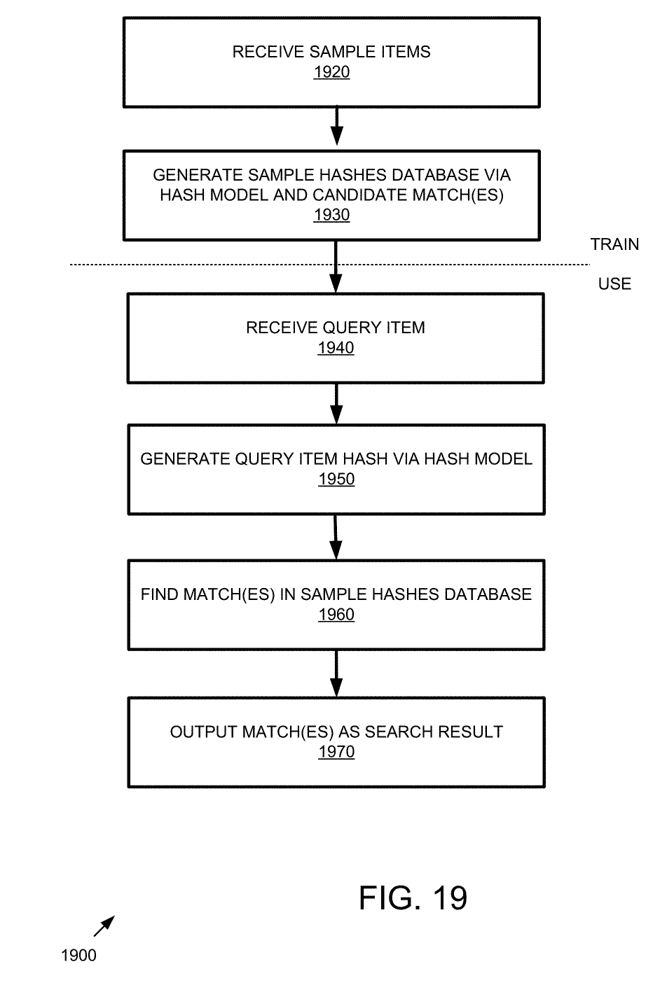

FIGS. 2 and 19 are flowcharts of example methods 200 and 1900, respectively, of implementing similarity search via hashes with expanded dimensionality and sparsification and can be implemented in any of the examples herein, such as, for example, the system shown in FIGS. 1 and 18.

In the example, both training and use of the technologies can be implemented. However, in practice, either phase of the technology can be used independently (e.g., a system can be trained and then deployed to be used independently of any training activity) or in tandem (e.g., training continues after deployment).

At 220 or 1920, sample items are received. Sample items can take the form as described herein.

Further, items can be received with or without a preprocessing step. For example, the method can include converting the item(s) into a feature vector, or the item(s) can be provided as feature vector(s). Other preprocessing steps are possible. For example, other preprocessing steps can include principle component analysis (PCA), clustering, or any other dimensionality reduction techniques. In some examples, other preprocessing for performing a similarity search of items with N-dimensions can include constructing a lower dimensional feature vector using PCA and then performing hashing using the lower dimensional feature vector. In a non-limiting example, other preprocessing for performing a similarity search of images with P-dimensions (e.g., P pixels, where the dimension is scaled to the number of pixels) can include constructing a lower dimensional image feature vector using PCA and then performing image hashing using the lower dimensional image feature vector.

At 230 or 1930, a sample hashes database is generated using a hash model. In practice, sample items are input into the hash model as feature vectors, and sample item hashes are output. As shown, the sample item hashes can be entered into a database, such as for comparison with other hashes (e.g., a query item hash).

At 240 or 1940, one or more query items are received. In practice, any item can be received as a query item. Exemplary query items include genomic sequences; documents; audio, image (e.g., biological, medical, facial, or handwriting images), video, geographical, geospatial, seismological, event (e.g., geographical, physiological, and social), app, statistical, spectroscopy, chemical, biological, medical, physical, physiological, or secure data; and fingerprints.

Further, the query items can be received with or without a preprocessing step. For example, the method can include converting the query item(s) into a feature vector, or the item(s) can be provided as feature vector(s). Other preprocessing steps are possible. In a typical use case of the technologies, a feature vector is received as input, and a hash is output as a result that can be used for further processing, such as matching as described herein.

At 250 or 1950, a hash of the query item(s) is generated using a hash model that includes expanding the dimension of a feature vector for an incoming query item and sparsifying the hash. In practice, any such hash model can be used. In example hash models, winner-take-all functionality, setting a threshold, random projection, binary projection (such as sparse, binary projection), dense projection, Gaussian projection, and the like can be used as described herein.

At 260 or 1960, matches the query item hash(es) to the sample hashes database. In practice, any matching can be used that includes a distance function. Exemplary matching includes a nearest neighbor search (e.g., an exact, an approximate, or a randomized nearest neighbor search). A search function typically receives the query item hash and a reference to the database and outputs the matching hashes from the database, either as values, reference, or the like.

At 270 or 1970, the matches are output as a search result. In practice, the matches indicate that the query item and sample item hashes are similar (e.g., a match). For example, in an image context, matching hashes indicate similar images. In other examples, the matches can be used to identify similar documents or eliminate document redundancy where the sample and query items are documents. In some examples, the matches can be used to identify matching fingerprints where the sample and query items are fingerprints. In another example, the matches can indicate similar genetic traits where the sample and query items are genomic sequences. In still further examples, the matches can be used to identify similar data, where the sample and query items are, for example, audio, image (e.g., biological, medical, facial, or handwriting images), video, geographical, geospatial, seismological, event (e.g., geographical, physiological, and social), app, statistical, spectroscopy, chemical, biological, medical, physical, physiological, or secure data. In additional examples, hash matches for query a sample items that are data can be used to aid in predicting unknown or prospective events or conditions.

### EXAMPLE 4

### Example Digital Items

In any of the examples herein, a digital item (“sample item,” “query item,” or simply “item”) can take a variety of forms. Although image similarity searching is exemplified herein, in practice, any digital item or a representation of the digital item (e.g., feature vector) be used as input to the technologies. In practice, a digital item can take the form of a digital or electronic item such as a file, binary object, digital resource, or the like. Example digital items include documents, audio, images, videos, strings, data records, lists, sets, keys, or other digital artifacts. In specific examples, images that can be used as digital items herein include video, biological, medical, facial, or handwriting images. Images as described herein can be in any digital format or are capable of being represented by any digital format (e.g., raster image formats, such as where data describe the characteristics of each individual pixel; vector image formats, such as image formats that use a geometric description that can be rendered smoothly at any display size; and compound formats that include raster image data and vector image data) at any dimension (e.g., 2- and 3-dimensional images). Data represented can include geographical, geospatial, seismological, events (e.g., geographical, physiological, and social), statistical, spectroscopy, chemical, biological, medical, physical, physiological, or secure data, genomic sequences, fingerprint representations, and the like. In some cases, the digital item can represent an underlying physical item (e.g., a photograph of a physical thing, subject, or person; an audio scan of someone's voice; measurements of a physical item or system by one or more sensors; or the like).

In practice, the matching technologies can be used for a variety of applications, such as finding similar images, person (e.g., facial, iris, or the like) recognition, song matching, location identification, detecting faulty conditions, detecting near-failure conditions, matching genomic sequences or expression thereof, matching protein sequences or expression thereof, collaborative filtering (e.g., recommendation systems, such as video, music, or any type of product recommendation systems), plagiarism detection, matching chemical structures, or the like.

Further, in any of the examples herein, items can be used with or without a preprocessing step. For example, the method can include converting the query item(s) into a feature vector, or the item(s) can be provided as feature vector(s). Other preprocessing steps are possible, such as convolution, normalization, standardization, projection, and the like.

In any of the examples herein, a digital item or its representation can be stored in a database (e.g., a sample item or query item database). The database can include items with or without a preprocessing step. In particular examples, items are stored as a feature vector in a feature vector database (e.g., sample item feature vectors or query item feature vectors can be stored in a feature vector database or query item feature vectors can be stored in a feature vector database). Precompiled item databases may also be used. For example, an application that already has access to a database of pre-computed hashes can take advantage of the technologies without having to compile such a database. Such a database can be available locally, at a server, in the cloud, or the like. In practice, a different storage mechanism than a database can be used (e.g., hash table, index, or the like).

### EXAMPLE 5

### Example Feature Vectors

In any of the examples herein, a feature vector can represent an item and be used as input to the technologies. In practice, any feature vector can be used that provides a digital or electronic representation of an item (e.g., a sample item or a query item). In particular, non-limiting examples, a feature vector can provide a numerical representation of an item. In practice, the feature vector can take the form of a set of values, and a feature vector of any dimension can be used (e.g., a D-dimensional feature vector). In practice, the technologies can be used across any of a variety of feature extraction techniques used to assign a numerical value to features of the item, including features not detectable by manual observation.

Methods for extracting features from an image can include SIFT, HOG, GIST, Autoencoders, and the like. Other techniques for extracting features can include techniques based on independent component analysis, isomap, kernel PCA, latent semantic analysis, partial least squares, principal component analysis, multifactor dimensionality reduction, nonlinear dimensionality reduction, multilinear principal component analysis, multilinear subspace learning, semidefinite embedding, and the like.

One or more pre-extracted feature vectors can also be used. In some examples, one or more feature vectors are extracted and stored in a database (e.g., a feature vector database, such as a sample item feature vector database or a query item feature vector database). In further examples, a precompiled feature vector database can be used. Non-limiting examples of feature vector databases that can be used include SIFT, GLOVE, MNIST, GIST or the like. Other examples of feature vector databases that can be used include Nus, Rand, Cifa, Audio, Sun, Enron, Trevi, Notre, Yout, Msong, Deep, Ben, Imag, Gauss, UQ-V, BANN, and the like.

In any of the examples herein, the number of features extracted can be tuned. In particular non-limiting examples, the number of features extracted becomes the number of D dimensions in a feature vector. In some examples, where more than one item with various numbers of features are involved, then the item feature numbers can be adjusted to be the same, and the raw feature values can be used in the feature vector. In other examples, the same number of feature descriptors for each item can be extracted, regardless of the item differences.

In any of the examples herein where the item is an image, the D-dimensional vector can represent the image in a variety of ways. For example, if an image has P number of pixels, D can equal P with one value per pixel value. In some examples, images of various sizes can be involved, and the images can be adjusted to the same size, and the raw pixel values can be used as features. In other examples, the same number of feature descriptors for each image can be extracted, regardless of size. The image feature descriptions can also be scale-invariant, rotation-invariant, or both, which can reduce dependence on image size.

### EXAMPLE 6

### Example Normalization

In any of the examples herein, a variety of normalization techniques can be used on digital items or their representations, such as feature vectors. In practice, any type of normalization can be used that enhances any of the techniques described herein. When normalization is performed, it can consider only one feature vector at a time or more than one feature vector (e.g., normalization is performed across multiple feature vectors). Example normalization includes any type of rescaling, mean-centering, distribution conversion (e.g., converting the item input, such as a feature vector, to an exponential distribution), Z-score, or the like. In any of the examples herein, any of the normalization techniques can be performed alone or in combination.

Examples of rescaling include setting the values in a feature vector to a positive or negative number, scaling the values in a feature vector to fall within a certain range of numbers, or restricting the range of values in the in a feature vector to a certain range of numbers. In particular non-limiting examples, normalization can include setting the values in a feature vector to a positive number (e.g., by adding a constant to values in the vector).

Examples of mean-centering include setting the same mean for each feature vector for more than one feature vector. In specific non-limiting examples, the mean can be a large, positive number, such as at least 10, 20, 30, 40, 50, 60, 70, 80, 90, 100, 200, 500, or 1000, or about 100.

### EXAMPLE 7

### Example Hash

In any of the examples herein, a hash can be generated for input digital items (e.g., by performing a hash function on a feature vector representing the digital item). In practice, any type of hashing can be used that aids in identifying similar items. Both data-dependent and data-independent hashing can be used. Example hashing includes locality-sensitive hashing (LSH), locality-preserving hashing (LPH), and the like. Other types of hashing can be used, such as PCA hashing, spectral hashing, semantic hashing, and deep hashing.

In practice, the hash can take the form of a vector (e.g., K values). As described herein, elements of the hash (e.g., the numerical values of the hash vector) can be quantized, sparsified, and the like.

In some examples, LSH or LPH can be used that includes a distance function. In practice, any type of distance function can be used. Example distance functions include Euclidean distance, Hamming distance, cosine similarity distance, spherical distance or the like.

Extensions to hashing are possible. Example extensions include using multiple hash tables (e.g., to boost precision), multiprobe (e.g., to group similar hash tags), quantization, learning (e.g., data-dependent hashing), and the like.

### EXAMPLE 8

### Example Hash Model

In any of the examples herein, a hash generator applying a hash model can be used to generate hashes. In practice, the same hash model used to generate hashes for sample items can be used to generate a hash for a query item, thereby facilitating accurate matching of the query item to the sample items. In practice, any hash model can be used that aids in hashing items for a similarity search. In any of the examples herein, a hash model can include one or more expansion matrices that transform an item's features (e.g., the feature vector of the item) into a hash with expanded dimensions.

In practice, the hash model applies (e.g., multiplies, calculates a dot product, or the like) the expansion matrix to the input feature vector, thereby generating the resulting hash. Thus, the digital item is transformed into a digital hash of the digital item via the feature vector representing the digital item.

Various parameters can be input to the model for configuration as described herein.

In further examples, the hash model can include quantization of the matrix. In practice, any type of quantization can be used that can map a range of values into a single value to better discretize the hashes. In some examples, quantization can be performed across the entire matrix. In other examples, the quantization ranges can be selected based on optimal input values. In particular, non-limiting examples, the quantization can map real values into integers, for example by rounding up or by rounding down to the nearest integer. Thus, for example, hash values in the range of 2.00 to 2.99 can be quantized to 2 by using a floor function.

In any of the examples herein, quantization can be performed before or after sparsification.

In any of the examples herein, the hash model can perform sparsification of values in the hash. In practice, any type of sparsification can be used that enhances identification or isolation of more important hash elements of the hash vector (e.g., deemphasizing or elimination the lesser important hashes). Exemplary sparsification includes winner-take-all (WTA), MinHash, and the like. Thus, an important hash element can remain or be represented as a “1,” while lesser important hash elements are disregarded in the resulting hash.

The hash model can also include binning In practice, any type of binning can be used that stores the hash into a discrete “bin,” where items assigned to the same bin are considered to be similar. In such a case, the hash can serve as an intermediary similarity search result, and the ultimate result is the bin in which the hash or similar hashes appear(s). In non-limiting examples, multiprobe, any non-LSH hash function, or the like can be used for binning

### EXAMPLE 9

### Example Expansion Matrix

In any of the examples herein, an expansion matrix (or simply “matrix”) can be used to generate a hash that increases the dimensionality of the input (e.g., feature vector).

Example expansion matrices include random matrices, random projection matrices, Gaussian matrices, Gaussian projection matrices, Gaussian random projection matrices, sparse matrices, dense matrices, binary matrices, non-binary matrices, the like, or any combination thereof. Binary matrices can be implemented such that each element of the matrix is either a 0 or a 1. Other implementations may include other numerical bases (e.g., a ternary matrix or the like).

In some examples of matrices, the matrix can be represented as an adjacency matrix (e.g., an adjacency matrix of a bipartite graph), such as a binary projection matrix represented as an adjacency matrix of a bipartite graph. In non-limiting examples, the matrix can be a binary projection matrix summarized by an m×d adjacency matrix M, where M:

$${M}_{ji} = \{ \begin{matrix}1 & if {x}_{i} connects to {y}_{j} \\ 0 & otherwise\end{matrix} .$$

In other words, if an element is set to 1 in the matrix, the feature vector element corresponding to the matrix element (e.g., at position i) is incorporated into the hash vector element corresponding to the matrix element (e.g., at position j). Otherwise, the feature vector element is not incorporated into the hash vector element. Using a binary matrix can reduce the complexity of calculating a hash as compared to conventional locality-sensitive hashing techniques. Other matrix representations are possible.

Random matrices can be generated using random pseudo-random techniques to populate the elements (e.g., values) of the matrix. In similarity searching scenarios, the same random matrix can be used across digital items to facilitate the matching process. Parameters (e.g., distribution, sparseness, etc.) can be tuned according to the characteristics of the feature vectors to facilitate generation of random matrixes that produce superior results.

Although some examples show a hash model using a sparse, binary random projection matrix, it is possible to implement a dense or sparse Gaussian matrix instead.

Matrices of any dimension can be used. In particular, non-limiting examples, the dimension of the matrix can be represented as K×D, where D represents the dimension of the input, and any K dimension can be selected (e.g., the ultimate number of dimensions in the resulting hash). In some examples, D is greater or much greater than K, such as where the dimension of the input is reduced. In other examples, K is greater or much greater than D, such as where the dimension of the input is expanded.

In some examples, the density of the matrix can take the form of a parameter that can be selected (e.g., an “S” sparsity parameter). In some examples, the sparsity parameter can be selected based on the optimal input sampling. For example, a matrix that is too sparse may not sample enough of the input, but a matrix that is too dense may not provide sufficient discrimination. In particular, non-limiting examples, the sparsity selected is at least about 1%, 2%, 3%, 4%, 5%, 6%, 7%, 8%, 9%, 10%, 11%, 12%, 13%, 14%, 15%, 20%, 25%, 30%, 40%, 45%, or about 1%, 10%, or 45%, or 10%. In other non-limiting examples, the matrix is a binary matrix, and the sparsity parameter, S, can be represented as the number of is in each column of the matrix with the remainder of the matrix set at zero. Non-sparse implementations (e.g., about 50%, 75% or the like) can also be implemented.

In practice, the expansion matrix can serve as a feature mask that increases dimensionality of the hash vector vis-à-vis the feature vector, but selectively masks (e.g., ignores) certain values of the feature vector when generating the hash vector. In other words, a hash vector is generated with greater dimensionality than the feature vector via the expansion matrix, but certain values of the feature vector are masked or ignored when generating some of the elements of the hash vector. In the case of a sparse random expansion matrix of sufficient size, the resulting hash vector can actually perform as well as a dense Gaussian matrix, even after sparsification, which reduces the computing complexity needed to perform similarity computations between such hashes. The actual size of the expansion matrix can vary depending on the characteristics of the input and can be empirically determined by evaluating the accuracy of differently-sized matrices.

### EXAMPLE 10

### Example Dimension Expansion

In any of the examples herein, the resulting hash can increase the dimensionality of the input (e.g., a feature vector representing a digital item). In practice, such dimension expansion can preserve distances of the input. In some examples, hash model expansion matrices are designed to facilitate dimension expansion. As described herein, a variety of expansion matrices can be used.

In practice, an expansion matrix can be generated for use across digital items to facilitate matching. The dimensions of the expansion matrix can be chosen so that the resulting hash (e.g., obtained by multiplying the feature vector by the expansion matrix) has more dimensions that the feature vector. Thus, dimensionality is expanded or increased.

In any of the expansion scenarios described herein, the dimension of the matrix can be represented as K×D, where D represents the dimension of the input, and any K dimension can be selected. For example, K can be selected to be greater or much greater than D. An example K can be greater than input D by at least about 2-fold, 3-fold, 4-fold, 5-fold, 6-fold, 7-fold, 8-fold, 9-fold, 10-fold, 15-fold, 20-fold, 30-fold, 40-fold, 50-fold, 60-fold, 70-fold, 80-fold, 90-fold, 100-fold, 200-fold, 500-fold, or 1000-fold or 40-fold or 100-fold.

In any of the examples herein, dimension expansion can apply to any step or steps of the example. For example, in the above scenario, dimension expansion can occur where D is less than K, even if the dimension of the output is reduced to less than D at a later step.

### EXAMPLE 11

### Example Sparsification

In any of the examples herein, sparsification can be used when generating a hash (e.g., by a hash generator employing a hash model). For example, after a hash is generated with an expansion matrix, the resulting hash (e.g., hash vector) can be sparsified. In practice, any type of sparsification can be used that results in an output hash having a lower length (e.g., non-zero values) than the length of the input hash. Exemplary sparsification includes winner-take-all (WTA), setting a threshold, MinHash, and the like.

Hash length can refer to the number of values remaining in the hash after sparsification (e.g., other values beyond the hash length are removed, zeroed, or disregarded) and, in some example, can serve as a target hash length to which the hash length is reduced during sparsification. Any hash length, range of hash lengths, or projected hash length or range of hash lengths can be selected. In practice, the ultimate hash length for a sparsification scenario is less than the number of values input (e.g., the hash length indicates a subset of the values input). In binary hash model scenarios, the hash length can be the number of is returned. In other examples, a non-binary hash model can be used, and the hash length can be the number of non-zero or known values returned.

In practice, the resulting hash vector after sparsification can be considered to have the same dimension; however, the actual number of values (e.g., the length) of the hash is reduced. As a result, computations involving the sparsified hash (e.g., matching by nearest neighbor or the like) can involve fewer operations, resulting in computational savings. Thus, the usual curse of dimensionality can be avoided. Such an approach can be particularly beneficial in big data scenarios that involve a huge number of computations that would overwhelm or unduly burden a computing system using conventional techniques, enabling accurate similarity searching to be provided on a greater number of computing devices, including search appliances, dedicated searching hardware, mobile devices, robotics devices, drones, sensor networks, energy-efficient computing devices, and the like.

For sparsification scenarios, a hash length L can be selected to be less than K. Exemplary L can be less than K by at least about 5-fold, 10-fold, 20-fold, 30-fold, 40-fold, 50-fold, 60-fold, 70-fold, 80-fold, 90-fold, 100-fold, 200-fold, or 500-fold or 10-fold, 20-fold, or 50-fold.

In practice, a hash length L can be selected using any metric that returns values relevant to identifying similar items but reduces the number of values returned by hashing. In some examples, a binary hash model can be used, and L can be the number of is returned, which represent the values input that are, for example, the highest values or a subset of random values. In other examples, a non-binary hash model can be used, and L can be the number of values returned, which represent the values input that are, for example, the highest values or a subset of random values. Exemplary L can be at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 42, 44, 46, 48, 50, 55, 60, 70, 80, 90, 100, 150, 200, 300, 400, 500, 600, 700, 800, 900, 1 thousand (K), 10 K, 20 K, 30 K, 40 K, 50 K, 100 K, 200 K, 300 K, 400 K, 500, 600 K 750 K, 1 million (M), 5 M, 10 M, 15 M, 20 M, 25 M, 50 M, or 100 M or about 2, 4, 8, 16, 20, 24, 28, 32, or 400.

For sparsification scenarios, hash length can be reduced to less than K by setting a threshold T for the values in the expansion matrix, in which values that do not meet the threshold are not included in the hash length. T can be any desirable value, such as values that are greater than or equal to a specific value, values that are greater than a specific value, values that are less than or equal to a specific value, or values that are less than a specific value. Exemplary T can be at least about values that are greater than or equal to 0.

In practice, a threshold T can be selected using any metric that returns values relevant to identifying similar items but reduces the number of values returned by hashing, such as a value that returns a hash length less than K by about 5-fold, 10-fold, 20-fold, 30-fold, 40-fold, 50-fold, 60-fold, 70-fold, 80-fold, 90-fold, 100-fold, 200-fold, or 500-fold or 10-fold, 20-fold, or 50-fold. In some examples, a binary hash model can be used, and T can be the number of is returned, which represent the values input that are, for example, the values that meet or exceed a value threshold. In other examples, a non-binary hash model can be used, and T can be the number of values returned, which represent the values input that are, for example, the values that meet or exceed a value threshold. Exemplary T can return at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 42, 44, 46, 48, 50, 55, 60, 70, 80, 90, 100, 150, 200, 300, 400, 500, 600, 700, 800, 900, 1 thousand (K), 10 K, 20 K, 30 K, 40 K, 50 K, 100 K, 200 K, 300 K, 400 K, 500, 600 K 750 K, 1 million (M), 5 M, 10 M, 15 M, 20 M, 25 M, 50 M, or 100 M or about 2, 4, 8, 16, 20, 24, 28, 32, or 400 values (e.g., 1 s).

### EXAMPLE 12

### Example Winner-Take-All Techniques

In any of the examples herein, a winner-take-all technique can be used to implement sparsification. In practice, L (e.g., the hash length) winners (e.g., hash elements) can be chosen from the hash (e.g., hash elements). For example, the top L numerical values of the hash (e.g., the set of L values having the greatest magnitude out of the elements of the hash vector) can be chosen. The remaining (so-called “non-winning” or “losing” values) can be eliminated (e.g., set to zero in the vector). The winning values can be left as is or converted to binary (e.g., set to “1”). In practice, the resulting hash can be represented as a list of K values (e.g., of which L have an actual value, and the remaining ones are 0).

Other techniques can be used (e.g., choosing the lowest L values, random L values, or the like).

### EXAMPLE 13

### Example Threshold-Setting Techniques

In any of the examples herein, a threshold-setting technique can be used to implement sparsification. In practice, T (e.g., the hash value threshold) winners (e.g., hash elements) can be chosen from the hash (e.g., hash elements). For example, the T numerical values of the hash (e.g., the set of T values meeting or exceeding a specific value out of the elements of the hash vector) can be chosen. The remaining (so-called “non-winning” or “losing” values) can be eliminated (e.g., set to zero in the vector). The winning values can be left as is or converted to binary (e.g., set to “1”). In practice, the resulting hash can be represented as a list of K values (e.g., of which T have an actual value, and the remaining ones are 0).

Other techniques can be used (e.g., choosing the T values that exceed a specific value threshold, T values below or equal to a specific value threshold, T values below a specific value threshold, or the like).

### EXAMPLE 14

### Example System Implementing Feature Extraction

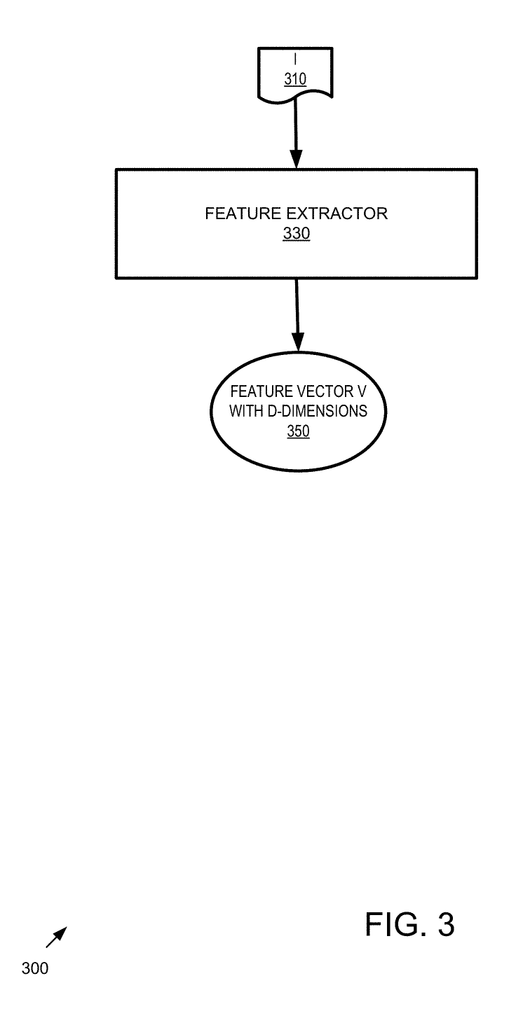

FIG. 3 is a block diagram of an example system 300 implementing feature extraction that can be used in any of the examples herein.

In the example, there is an item I 310A. In practice, any digital item or representation of an item can be used as described herein, such as sample items, query items or both (e.g., sample items 110A-S and query item 120).

The example illustrates extraction of the features of item I 310A by feature extractor 330. Although a particular extraction with feature extractor 330 is shown for illustration, in practice any extraction can be used that provides a digital or electronic representation of the features of one or more items.

The example further illustrates output of feature vector V 350 with D-dimensions. In practice, the feature vector can be any digital or electronic representation of the features of one or more items and can be used as described herein. In practice, the feature vector 350 can be used in place of the digital item that it represents (e.g., the item itself does not need to be received in order to calculate the hash). The item itself can be presented by a reference to the item, especially in cases where the underlying item is particularly large or there are a large number of items.

### EXAMPLE 15

### Example Method Implementing Feature Extraction

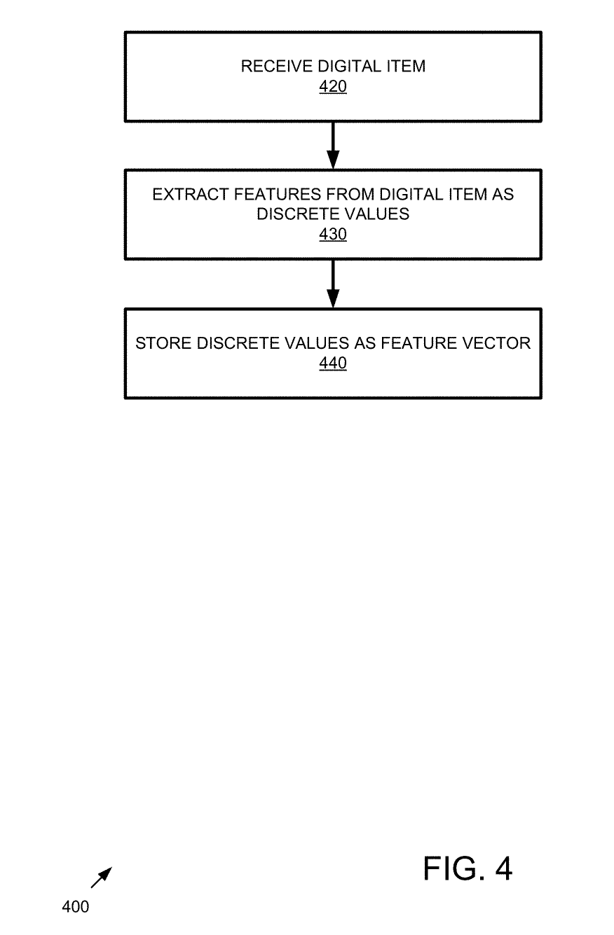

FIG. 4 is a flowchart of example method 400, implementing feature extraction, and can be implemented in any of the examples herein, such as, for example, by the system 300 of FIG. 3 (e.g., by the feature extractor 330).

At 420, a digital item is received (e.g., any digital item or representation of any item as described herein), such as feature extractor 330 of system 300.

At 430, features are extracted as discrete values from the digital item, such as using the feature extractor 330 of system 300. Any features of a digital item can be extracted where the features extracted reduce the amount of resources required to describe the items. For example, in the context of an image, values of the pixels or the distribution of shapes, lines, edges, or colors in the image can be extracted. Other examples of features for extraction are possible that may or may not be detectable by humans.

At 440, the discrete values are stored as a feature vector, such as in feature vector V 350 of system 300. The resulting vector can be used as input to a hash generator. As described herein, normalization or other pre-processing can be performed before or as part of generating the hash.

### EXAMPLE 16

### Example System Implementing Feature Vector Normalization

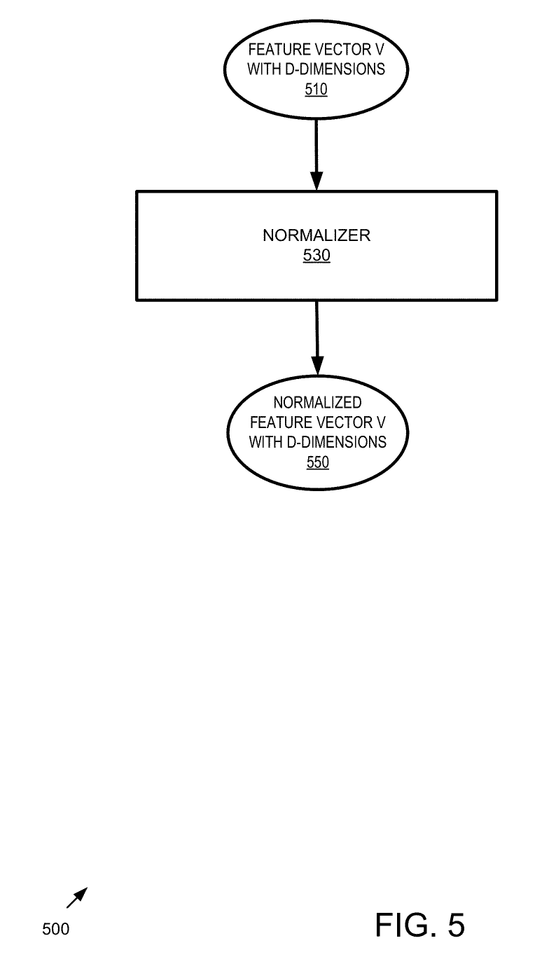

FIG. 5 is a block diagram of example system 500, implementing feature vector normalization that can be used in any of the example herein.

In the example, there is a feature vector V 510 with D-dimensions, which can be any feature vector described herein (e.g., feature vector 350 as output by feature extractor 330 of system 300).

The normalizer 530 accepts the feature vector 510 as input and can perform any normalization technique, such as those described herein. The normalizer 530 generates the normalized feature vector V 550 with D-dimensions as output. The output can then serve as input into hash generator 130.

Normalization can be performed individually (e.g., on a vector, by vector basis) or across vectors (e.g., the normalization function takes values in other vectors, such as for other items in the same corpus, into account).

### EXAMPLE 17

### Example Method Implementing Feature Vector Normalization

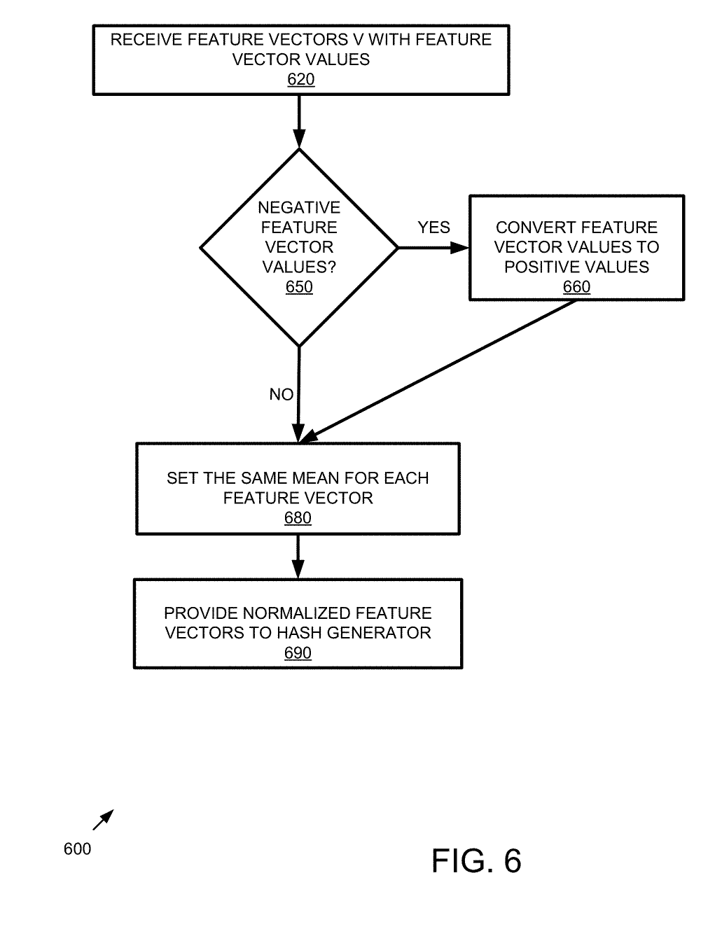

FIG. 6 is a flowchart of example method 600 implementing feature vector normalization, and can be implemented in any of the examples herein, such as, for example, the system 500 (e.g., by the normalizer 530).

At 620, the feature vector V is received (e.g., by hash generator 130 or 730) with feature vector values (e.g., values that represent the features of the input digital item in the feature vector).

At 650, it is determined whether the feature vector contains negative values. If the feature vector contains negative values, then the feature vector values are converted to positive values at 660, such as using normalizer 530, performing any such normalization technique described herein.

At 680, the same mean is set for each feature vector, such as using normalizer 530, performing any such normalization technique described herein.

At 690, the normalized feature vectors to a hash generator, such as hash generator 130 or 730.

### EXAMPLE 18

### Example System Implementing Hash Generation that Expands Dimensionality and Sparsifies the Hash

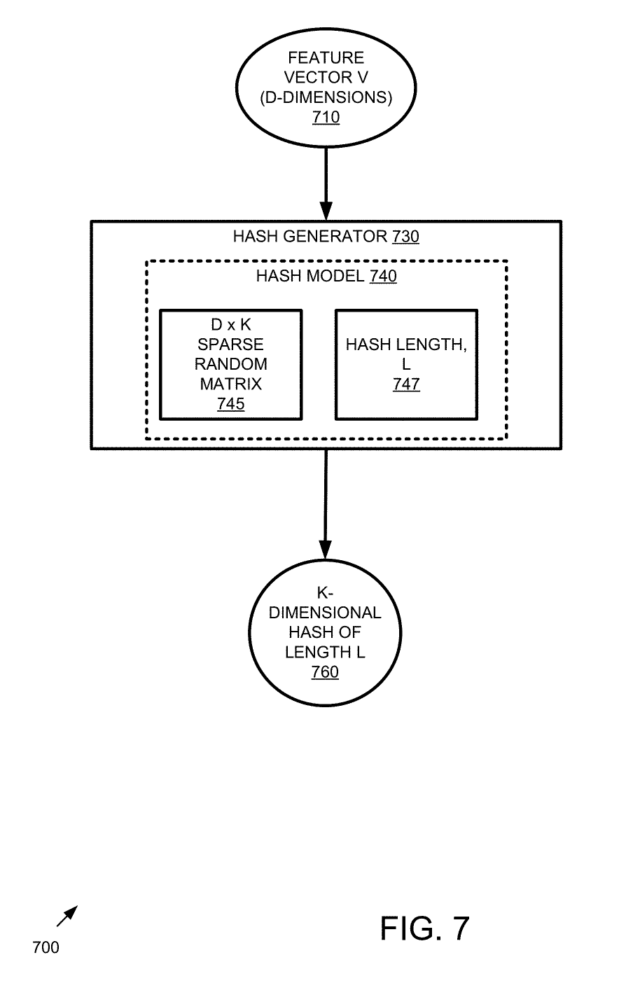

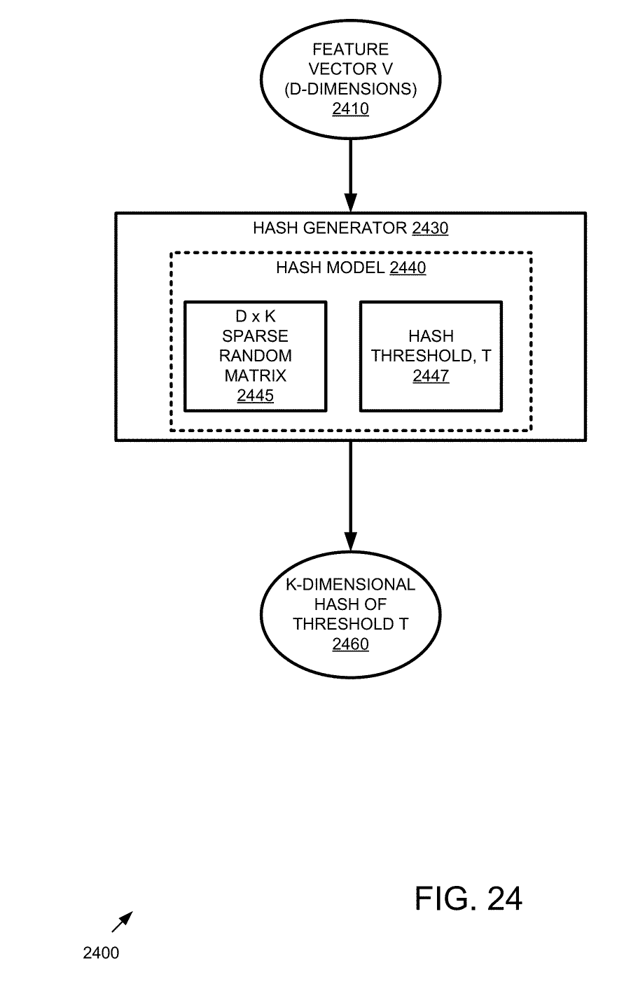

FIGS. 7 and 24 are block diagrams of example systems 700 and 2400, respectively, implementing hash generation that expands dimensionality and sparsifies the hash and can be used in any of the examples herein.

In the examples, there are feature vectors V 710 and 2410 with D-dimensions, which can be any feature vector described herein (e.g., feature vector 350, 510, 550, or the like). In practice, the feature vector represents a digital item.

The hash generators 730 and 2430, comprising respective hash models 740 and 2440, receives feature vector 710 or 2410 as input. The hash models 740 and 2440 can implement any of the various features described for hash models herein (e.g., the features of hash model 137). In the examples, hash models 740 and 2440 can include an expansion (e.g., D×K sparse random) matrix 745 or 2445 that expands dimensionality of a hash; any matrix described herein can be used. The model 740 also includes a stored hash length L 747, which is used for sparsification of the hash (e.g., to length L), such as by winner-take-all (WTA) or any other sparsification method described herein. The model 2440 also includes a stored hash threshold T 2447, which is used for sparsification of the hash (e.g., to a hash length that includes hashes within the threshold T), such as by setting a threshold, for example, equal to or greater than a specific value (e.g., equal to or greater than 0) or any other sparsification method described herein (e.g., greater than a specific value, equal to or below a specific value, or below a specific value).

The examples further show output of a K-dimensional hash of length L 760 or a K-dimensional hash of threshold T 2460, respectively; though any hash described herein can be output, including, for example, K-dimensional hash 160 and the K-dimensional sample hashes of database 140.

### EXAMPLE 19

### Example Method Implementing Hash Generation that Expands Dimensionality and Sparsifies the Hash.

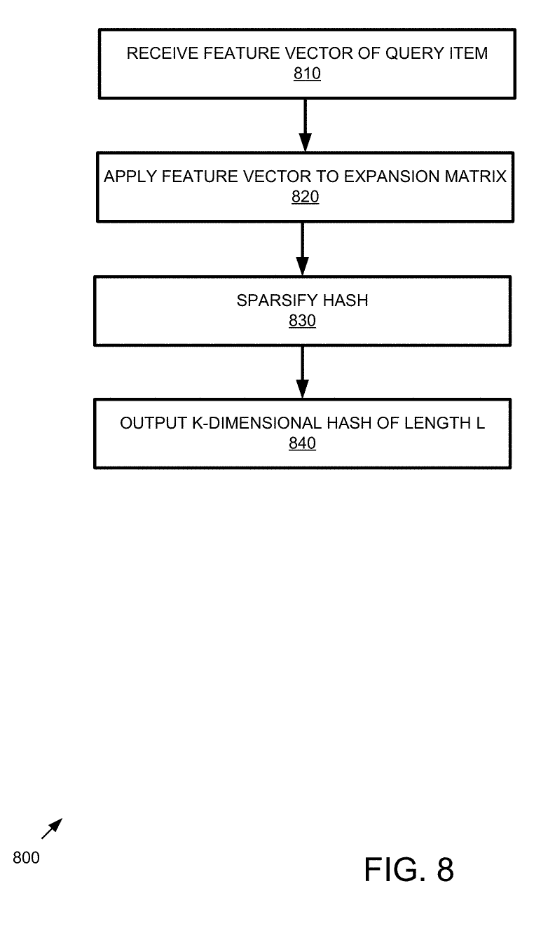

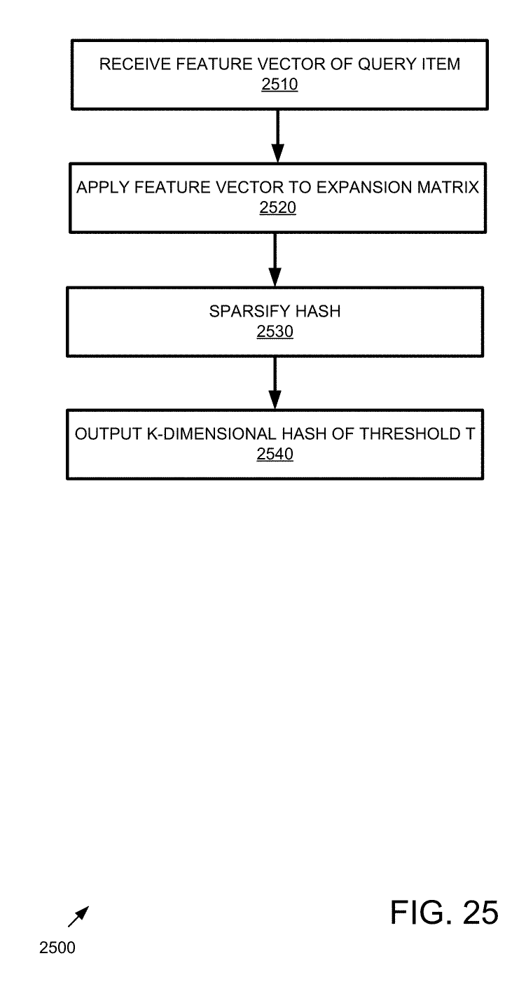

FIGS. 8 and 25 are flowcharts of an example methods 800 and 2500, respectively, implementing hash generation that expands dimensionality and sparsifies the hash and can be implemented in any of the examples herein, such as, for example, by the system shown in FIG. 7 or 24 (e.g., by the hash model of the hash generator).

At 810 or 2510, a feature vector of a query item, such as feature vector 710 or 2410, is received. In practice, the feature vector can be any feature vector as described herein (e.g., feature vector 350, 510, 550, 710, or 2410), extracted using any of the techniques described herein (e.g., using feature extractor 310). The query item can be any digital item or such representation of any item as described herein (e.g., item 120 or 310).

At 820 or 2520, the feature vector is applied to an expansion matrix (e.g., multiplying the feature vector by the matrix), such as by using hash generator 130, 730, or 2430. A random matrix (e.g., sparse, random matrix 745 or 2445), or any matrix described herein can be used. The resulting hash is of expanded dimensionality (e.g., K-dimensional).

At 830 or 2530, the hash is sparsified using any of the techniques described herein (e.g., to reduce the hash to length L).

At 840, the K-dimensional hash of length L (e.g., hash 760) is output. At 2540, the K-dimensional hash of threshold T (e.g., hash 2460) is output. In practice, any hash described herein can be output, including, for example, K-dimensional hash 160 and the K-dimensional sample hashes of database 140).

Quantization can also be performed as described herein.

### EXAMPLE 20

### Example Sparse Binary Random Expansion Matrix

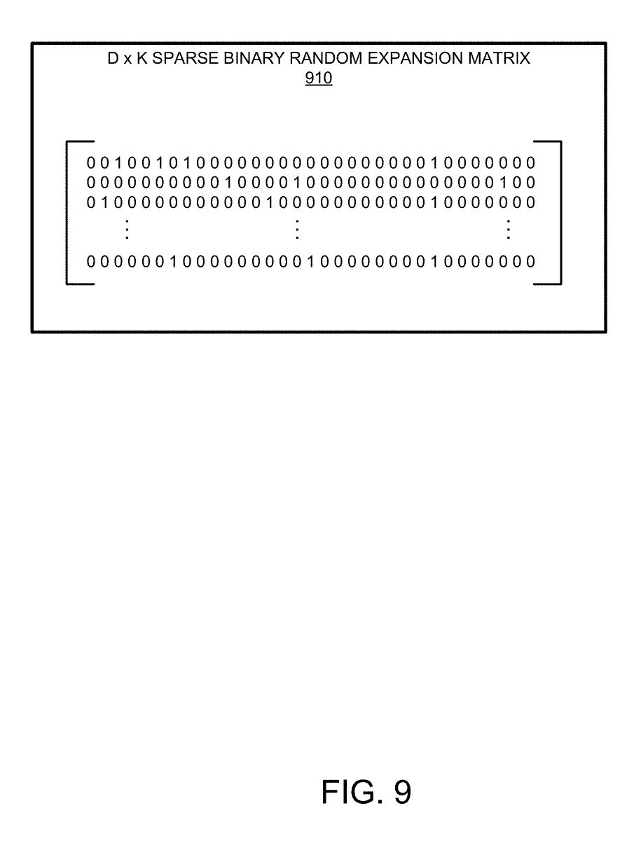

FIG. 9 is a block diagram of an example sparse binary random expansion matrix that can be used in any of the examples herein. The example illustrates a D×K sparse binary random expansion matrix 910 (e.g., matrix 745). The example illustrates random sampling of any input to which the matrix is applied (e.g., a feature vector, such as feature vector 350, 510, or 550) by using is to respecting the values of the input randomly sampled and 0 s to represent the values that are not sampled. Although a D×K sparse binary random expansion matrix is illustrated, any matrix described herein can be used to implement the technologies.

### EXAMPLE 21

### Example System Implementing Matching

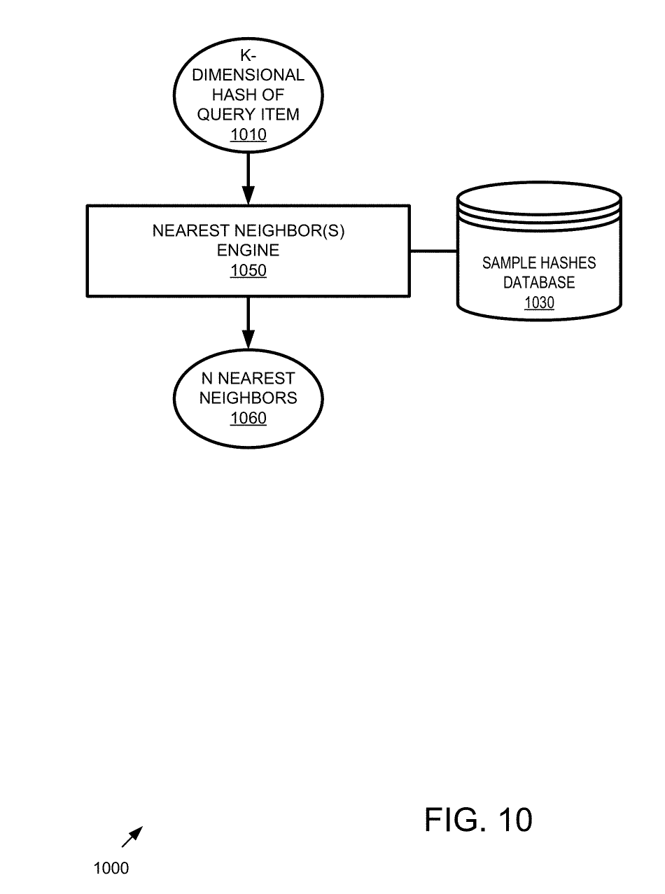

FIG. 10 is a block diagram of example system 1000, that can be used to implement matching in any of the examples herein.

In the example, a K-dimensional hash 1010 of a query item (e.g., hash 160 or 760), such as a hash generated using hash generator 130 or 730, comprising hash model 137 or 737 is shown. The example further shows sample hashes database 1030, which can include any number of any hashes described herein (e.g., the sample hashes of database 140). In practice, the sample hashes database 1030 contains hashes generated by the same model used to generate the hash 1010.

The nearest neighbors engine 1050 accepts the hash 1010 as input and finds matching hashes in the sample hashes database 1030. Although nearest neighbors engine 1050 is shown as connected to sample hashes database 1030, nearest neighbors engine 1050 can receive sample hashes database 1030 in a variety of ways (e.g., sample hashes can be received even if they are not compiled in a database). Matching using nearest neighbors engine 1050 can comprise any matching technique described herein.

Also shown, nearest neighbors engine 1050 can output N nearest neighbors 1060. N nearest neighbors 1060 can include hashes similar to the query item hash 1010 (e.g., hashes that represent digital items or representations thereof that are similar to the query item represented by hash 1010).

Instead of implementing nearest neighbors, in any of the examples herein, a simple match (e.g., exact match) can be implemented (e.g., that finds one or more sample item hashes that match the query item hash).

### EXAMPLE 22

### Example Method Implementing Matching

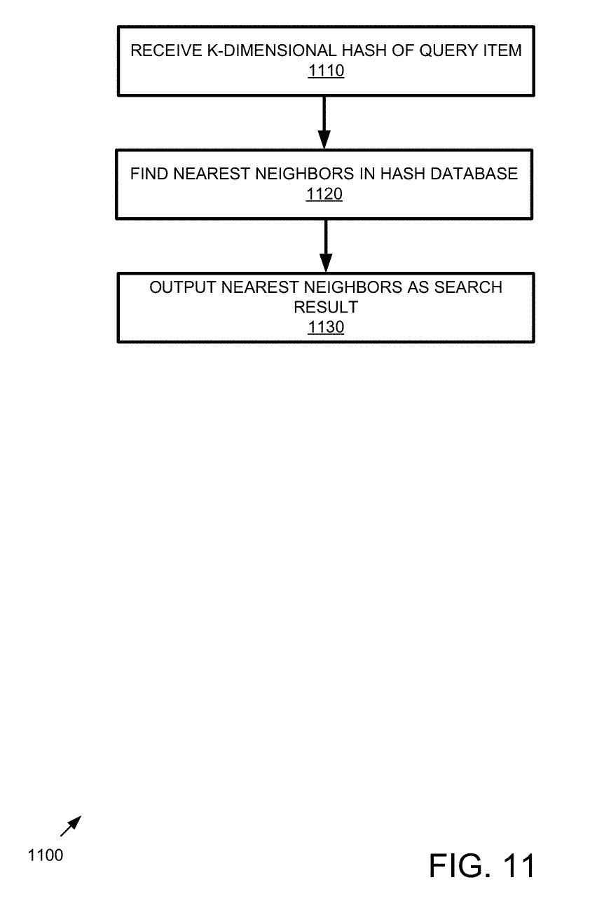

FIG. 11 is a flowchart of example method 1100, implementing matching and can be implemented by any of the example herein, including, for example, by the system 1000 (e.g., by the nearest neighbor(s) engine 1050).

At 1110, a K-dimensional hash of a query item is received. Any hash can be received as described herein, such as K-dimensional hash 1010, of any item described herein, such as item 120 or 310.

At 1120, the nearest neighbors in a hash database are found, such as by using nearest neighbors engine 1050, for finding similar hashes. Any sample hashes or compilation thereof can be used, such as sample hashes database 1030. The sample hashes represent items (e.g., digital items or representations of items, such as items 110A-E or 310).

At 1130, the example further shows outputting nearest neighbors as a search result (e.g., N nearest neighbors 1060). Any hashes similar to query item hash 1010 can be output, such as hashes that represent items similar to the query item can output. In practice, a hash corresponds to a sample item, so a match with a hash indicates a match with the respective sample item of the hash.

### EXAMPLE 23

### Example System Implementing Sparsification

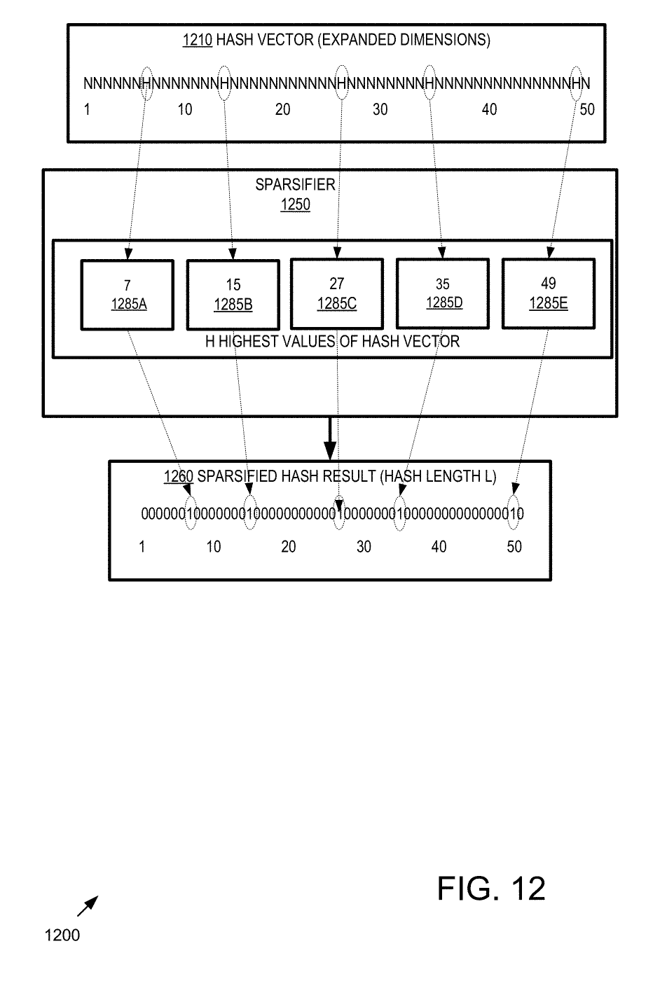

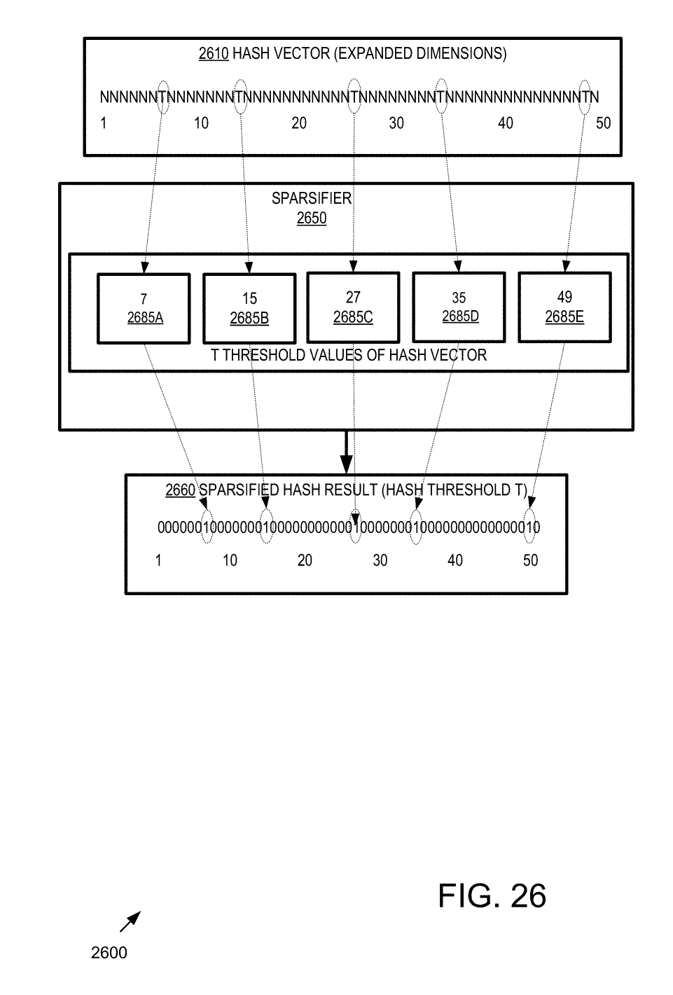

FIGS. 12 and 26 are block diagrams of example systems 1200 and 2600, respectively, implementing sparsification, and can be used in any of the examples herein, such as in a hash model (e.g., hash model 137, 740, or 2440).

The examples illustrate hash vectors 1210 and 2610, such as a vector of a hash generated by a hash model (e.g., hash model 137, 740, or 2440) using any of the hashing techniques described herein. In FIG., further illustrated are H highest values 1285A-E of hash vector 1210. In FIG. 26, further illustrated are T threshold values 2685A-E of hash vector 2610.

The examples show a sparsifier 1250 or 2650, which can implement sparsification for any hash generated by a hash model described herein (e.g., hash model 137, 740, or 2440) using any of the hashing techniques described herein. The sparsifier 1250 or 2650 can sparsify a hash using any sparsification technique described herein.

In FIG. 12, the example further shows sparsified hash result 1260 with hash length L output by sparsifier 1250. In practice, the sparsification can merely zero out non-winning (e.g., losing) values and leave winning values as-is. Or, as shown, the winning values can be converted to 1+s, and the sparsified hash result 1260 output as a binary index of H highest values 1285A-E in hash vector 1210. The sparsified hash result 1260 output can be any sparsification output described herein.

Although the top (e.g., winning values in winner-takes-all) L values are chosen in the example, it is possible to choose random values, bottom values, or other values as described herein.

In FIG. 26, the example further shows sparsified hash result 2660 with hash threshold T output by sparsifier 2650. In practice, the sparsification can merely zero out non-winning (e.g., losing) values and leave winning values as-is. Or, as shown, the winning values can be converted to 1's, and the sparsified hash result 2660 output as a binary index of T threshold values 2685A-E in hash vector 2610. The sparsified hash result 2660 output can be any sparsification output described herein.

Although the top (e.g., winning values in winner-takes-all) L values or the threshold (e.g., values greater than or equal to a specific threshold) T values are chosen in the example, it is possible to choose random values, bottom values, or other values as described herein.

The resulting hash 1260 or 2660 can still be considered a K-dimensional hash, even though it only actually has L or T values (e.g., the other values are zero). Thus, the technologies can both expand dimensionality, but reduce the hash length, leading to the advantages of larger dimensionality while maintaining a manageable computational burden during the matching process.

### EXAMPLE 24

### Example Method Implementing Sparsification

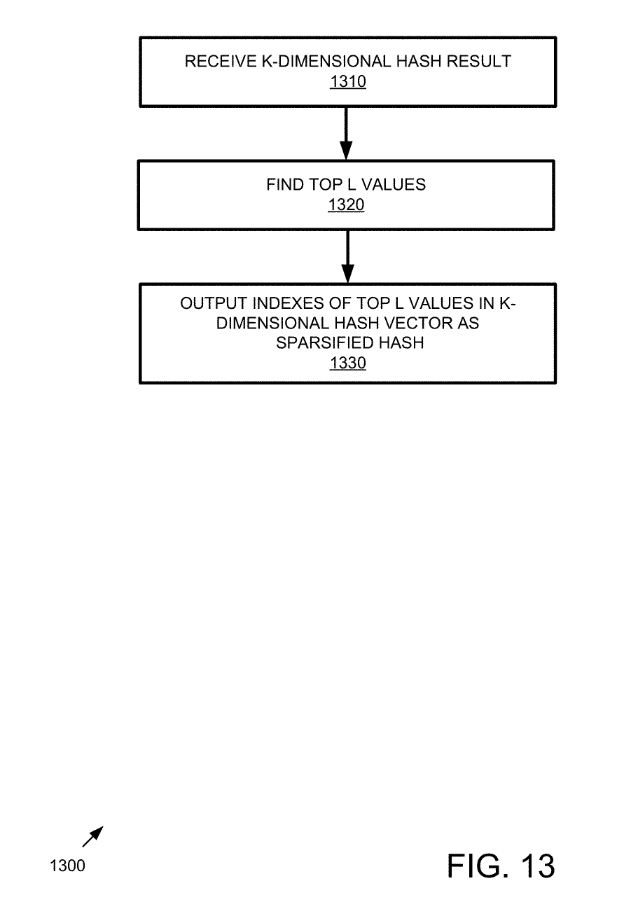

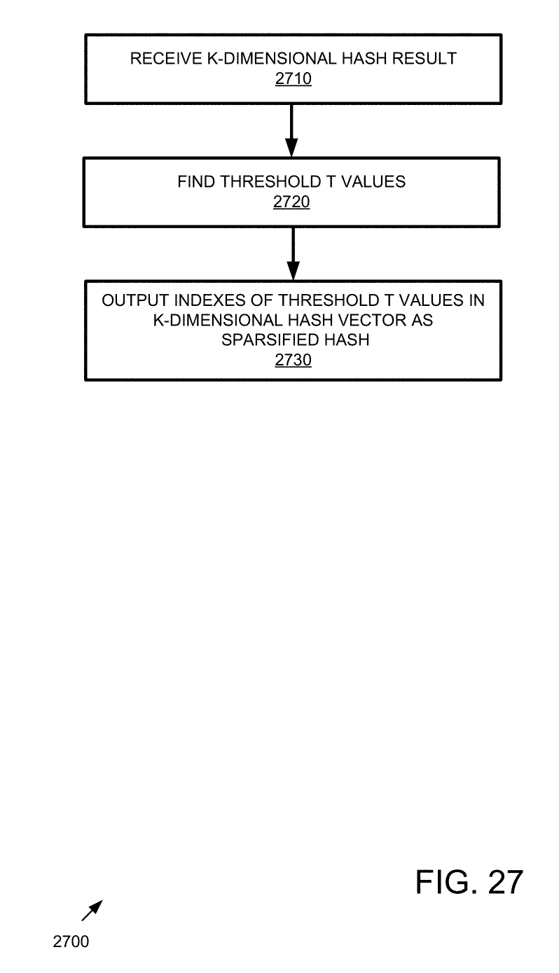

FIGS. 13 and 27 are flowcharts of example methods 1300 and 2700, respectively, implementing sparsification and can be used in any of the examples herein, such as by the system 1200 or 2600 (e.g., by the sparsifier 1250 or 2650).

At 1310 and 2710, the examples illustrate receiving a K-dimensional hash result, such as a hash that includes hash vector 1210 with H highest values 1285A-E or hash vector 2610 with threshold T values 2685A-E, which can be, for example, generated by a hash model (e.g., hash model 137, 740, or 2440). Any K-dimensional hash result described herein can be used (e.g., a hash that has undergone quantization or a hash that has not been quantized).

At 1320 and 2720, the examples show finding the top L values (e.g., the “winners” in a winner-take-all scenario), such as the H highest values 1285A-E of hash vector 1210 (e.g., H=L) or the threshold T values 2685A-E of hash vector 2610 (e.g., H=T). Although the examples show finding the top L values or the threshold T values, any sparsification metric can be used as described herein.

At 1330 and 2730, the example further shows outputting indexes of the top L values in a K-dimensional hash vector as a sparsified hash, such as sparsified hash result 1260 or 2660. Although the example shows outputting indexes of the top L values or threshold T values, any type of sparsified hash with any hash length L or threshold T can be output as described herein.

### EXAMPLE 25

### Example Method of Configuring a System

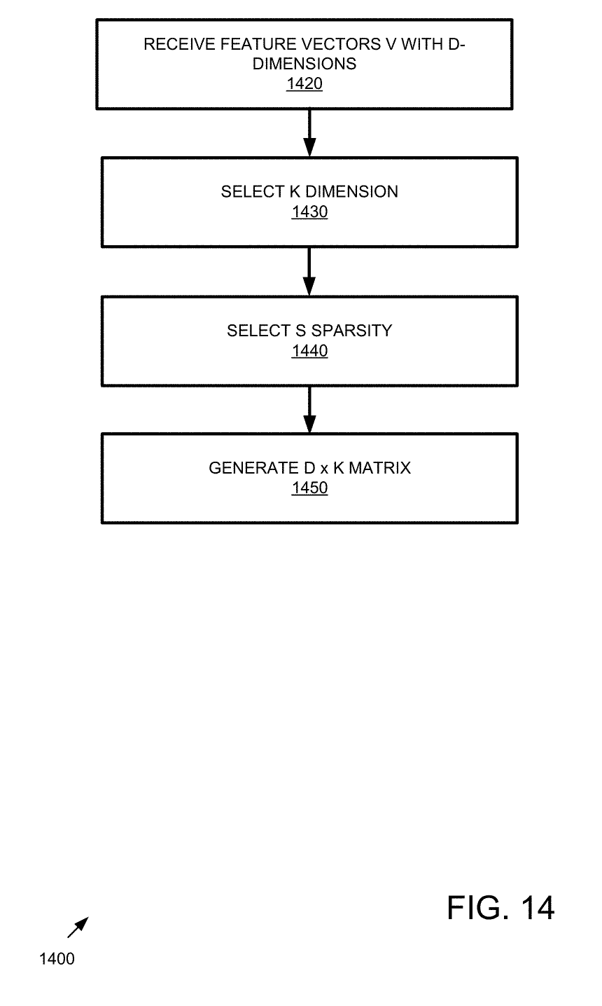

FIG. 14 is a flowchart of example method 1400 of configuring a system as described herein and can be used in any of the examples herein. Configuration is typically performed before computing a hash for a particular query item

At 1420, the example illustrates receiving a feature vectors V with D-dimensions, such as by hash generator hash generator 130, 730, or 2430. Any feature vectors described herein can be used (e.g., feature vector 350, 510, 550, 710, or 2410).

At 1430, the example illustrates selecting a K-dimension, and the example shows selecting S sparsity at 1440. Any K-dimension and S sparsity can be selected as described herein for generating a D×K matrix, as shown in the example at 1450, such as in a hash model (e.g., hash model 137, 740, or 2440).

Subsequently, hashes are calculated and matches are found as described herein.

### EXAMPLE 26

### Example System Implementing the Technologies

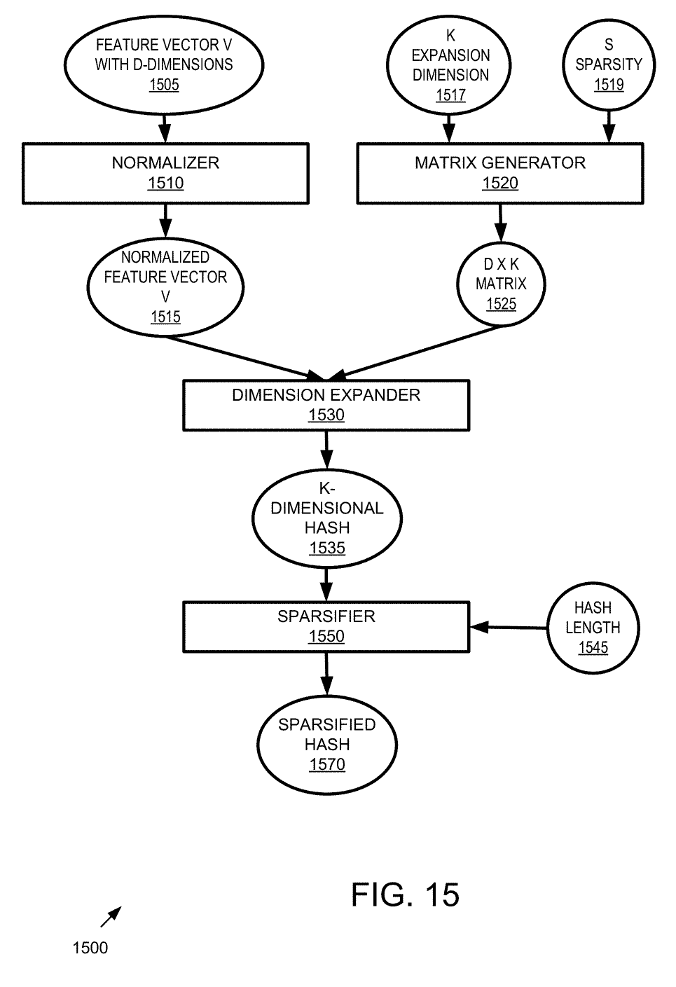

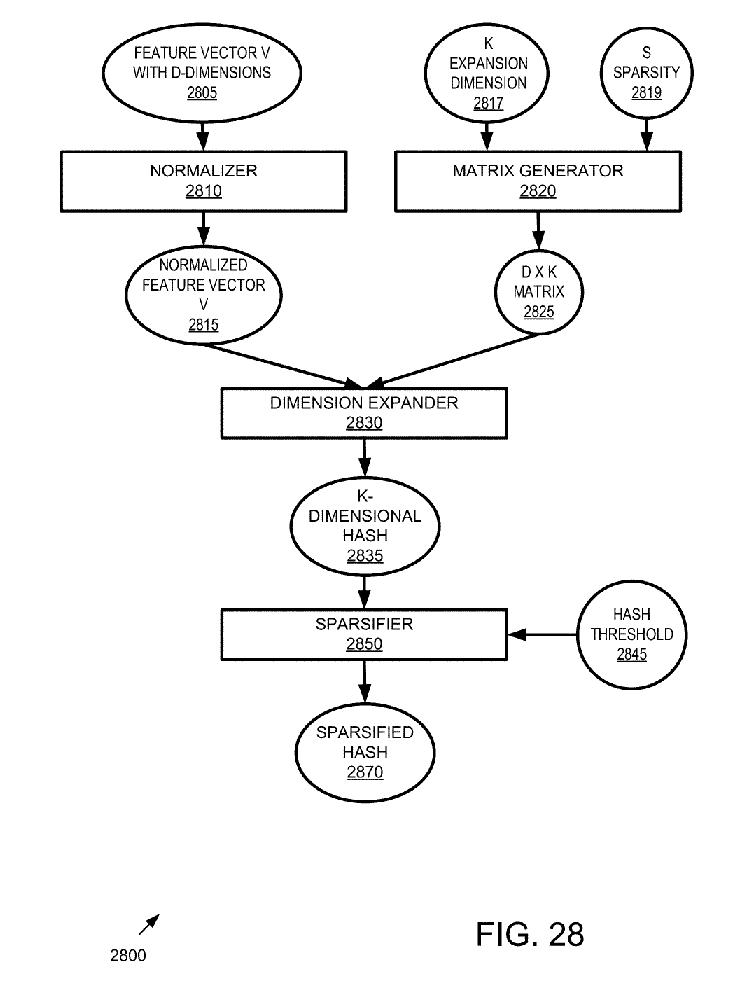

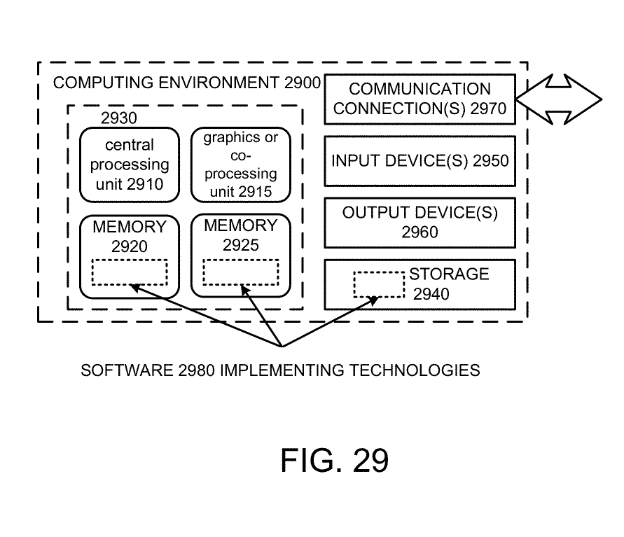

FIGS. 15 and 28 are data flow diagrams of systems 1500 and 2800, respectively, that can be implemented by any system implementing the technologies described herein.

The example shows a feature vector V 1505 or 2805 with D dimensions. Any feature vector described herein can be used, such as feature vector 350, 510, 550, or 710. The example further shows normalizer 1510 or 2810 receiving feature vector 1505 or 2805 as input. The normalizer implements any normalization technique described herein (e.g., as described by method 600) on feature vector 1505 or 2805 and outputs normalized feature vector 1515 or 2815, which can be any output from any normalization technique described herein (e.g., feature vector 550 or the normalized feature vector generated by method 600).

The example further illustrates K-expansion dimension 1517 or 2817, which can be any K-dimension or K-expansion dimension (e.g., an integer value) as described herein (e.g., the K-dimension illustrated in method 1400). S sparsity 1519 or 2819 is also shown, which can be any S sparsity (e.g., an integer value) as described herein (e.g., the S sparsity illustrated in method 1400 ). In the example, K-expansion dimension 1517 or 2817 and S sparsity 1519 or 2819 can be received by a matrix generator 1520 or 2820, which can generate a D×K matrix 1525 or 2825. Although the matrix generator 1520 or 2820 is shown in the example as generating the matrix 1525 or 2825, respectively, any matrix described herein (e.g., D×K sparse, random matrix 745 or 2445) can be produced using the matrix generator 1520 or 2820.

In practice, the matrix 1525 or 2825 can be used across feature vectors (e.g., it is reused for both sample and query items).

Further illustrated in the example is dimension expander 1530 or 2830, which can take the form of any hash generator described herein (e.g., hash generator 130, 730, or 2430). The example illustrates the dimension expander 1530 or 2830 receiving normalized feature vector 1515 or 2815 and D×K matrix 1525 or 2825 as inputs. Although the example shows the normalized feature vector 1515 or 2815 and the D×K matrix 1525 or 2825 as received by the dimension expander 1530 or 2830, any feature vector (e.g., feature vector 350, 510, 550, 710, or 2410) and matrix (e.g., matrix 745 or 2445) described herein can be received by dimension expander 1530 or 2830, where the K dimension of the matrix received is greater or much greater than the dimension of the feature vector received.

The dimension expander 1530 or 2830 can perform any hashing technique described herein to generate K-dimensional hash 1535 or 2835. For example, the dimension expander 1530 or 2830 can apply (e.g., multiply) any feature vector described herein, such as the normalized feature vector 1515 or 2815, to any matrix described herein, such as D×K matrix 1525 or 2825. In other examples, the dimension expander 1530 or 2830 can use any hashing technique described herein, such as used by a hash model as described herein (e.g., the hash model 137, 740, or 2440).

Although a K-dimensional hash 1535 or 2835 is shown in the examples, any hash can be used as described herein (e.g., the sample hashes of the database 140 or the hash 760, 1010, or 2410).

The example further shows a sparsifier 1550 or 2850 receiving K-dimensional hash 1535 or 2835 and hash length 1545 or hash threshold 2845 that can be implemented by the hash generators described herein. The sparsifier 1550 or 2850 can sparsify any hash, such as hash 1535, 760, 1010, or 2410 or the sample hashes of the database 140 using any sparsification technique described herein (e.g., method 1300 or 2700). Further, any hash length can be selected as the hash length 1545 (e.g., L) as described herein (e.g., method 1300) or any hash threshold can be selected as the has threshold 2845 as described here (e.g., method 2700). Also shown in the example is the resulting sparsified hash 1570 or 2870, which can take the form of any sparsification output described herein (e.g., sparsified hash result 1260 or 2660) and is ultimately used as the resulting hash (e.g., for similarity searching).

### EXAMPLE 27

### Example System Implementing Similarity Search Via Hashes with Expanded Dimensionality and Sparsification and Pseudo-Hashes with Reduced Dimensionality

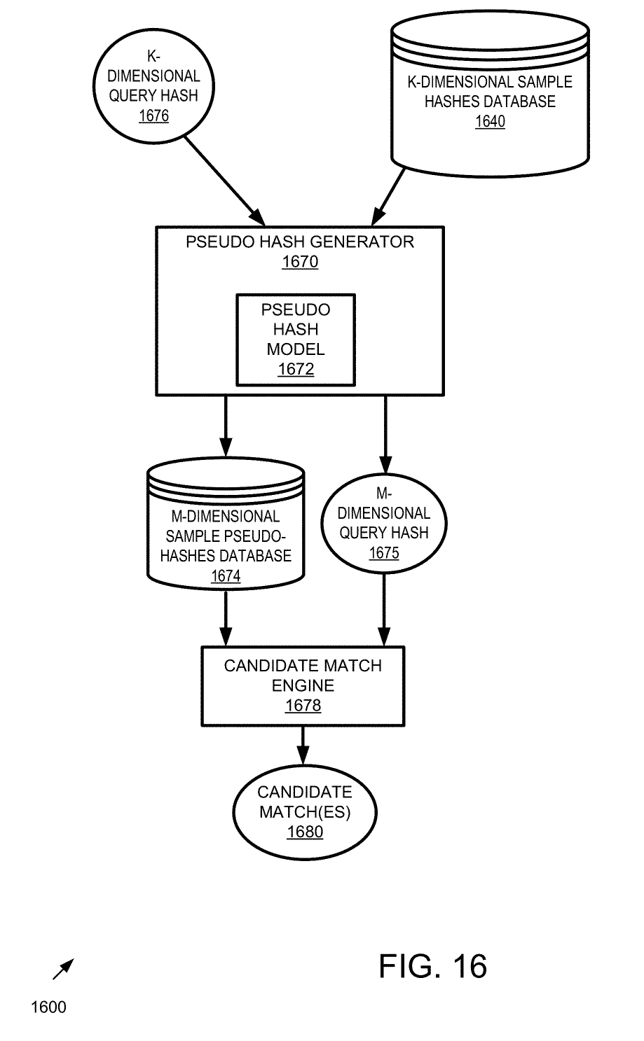

FIG. 16 is a block diagram of an example system 1600 implementing similarity search via pseudo-hashes with reduced dimensionality.

In the illustrated example, both training and use of the technologies are shown. However, in practice, either phase of the technology can be used independently (e.g., a system can be trained and then deployed to be used independently of any training activity) or in tandem (e.g., training continues after deployment). A pseudo-hash generator 1670 can receive K-dimensional sample hashes, for example, stored in a database 1676. The hashes in the database 1676 represent respective sample items 110A-E. Although a database 1676 is shown, in practice, the K-dimensional sample hashes can be stored in a variety of ways without being implemented in an actual database. For example, a hash table, binary object, unstructured storage, or the like can be used.

The pseudo-hash generator 1670 comprises a hash model 1672 that reduces dimensionality of the incoming K-dimensional hashes as described herein. Various features can be implemented by the model 1672, including a summing function, averaging function, and the like as described herein.

To use the similarity searching technologies, a K-dimensional hash of a query item 1676 is received. The pseudo-hash generator 1670 generates an m-dimensional query hash 1675 for the K-dimensional hash of a query item 1676. The same or similar features used to generate pseudo hashes for the K-dimensional sample hashes, for example, as stored in a database 1640 can be used as described herein.

A pseudo-hash generator 1670 can receive K-dimensional sample hashes, for example, stored in a database 1640 and generate respective m-dimensional sample pseudo hashes, which can also be stored in a database 1674. The pseudo-hashes in the database 1674 represent respective K-dimensional sample hashes (e.g., as stored in a database 1640).

The candidate match engine 1650 receives the m-dimensional query pseudo-hash 1675 and finds one or more candidate matches 1680 from the pseudo-hash database 1674. In practice, an intermediate result indicating one or more matching pseudo-hashes can be used to determine the one or more corresponding candidate matching sample items (e.g., the items associated with the matching pseudo-hashes) or one or more bins assigned to the sample items.

The candidate match engine 1678 receives the m-dimensional query pseudo-hash 1675 and finds one or more matches 1680 from the pseudo-hash database 1674. In practice, an intermediate result indicating one or more matching hashes can be used to determine the one or more corresponding matching sample items (e.g., the items associated with the matching hashes) or one or more bins assigned to the sample items.

Although a database 1674 is shown, in practice, the sample pseudo-hashes can be stored in a variety of ways without being implemented in an actual database. For example, a hash table, binary object, unstructured storage, or the like can be used.

In any of the examples herein, although some of the subsystems are shown in a single box, in practice, they can be implemented as systems having more than one device. Boundaries between the components can be varied. For example, although the pseudo-hash generator is shown as a single entity, it can be implemented by a plurality of devices across a plurality of physical locations.

In practice, the systems shown herein, such as system 1600, can vary in complexity, with additional functionality, more complex components, and the like. For example, additional services can be implemented as part of the pseudo-hash generator 1670. Additional components can be included to implement cloud-based computing, security, redundancy, load balancing, auditing, and the like.

The described systems can be networked via wired or wireless network connections to a global computer network (e.g., the Internet). Alternatively, systems can be connected through an intranet connection (e.g., in a corporate environment, government environment, educational environment, research environment, or the like).

The system 1600 and any of the other systems described herein can be implemented in conjunction with any of the hardware components described herein, such as the computing systems described below (e.g., processing units, memory, and the like). In any of the examples herein, the inputs, outputs, feature vectors, hashes, matches, and the like can be stored in one or more computer-readable storage media or computer-readable storage devices. The technologies described herein can be generic to the specifics of operating systems or hardware and can be applied in any variety of environments to take advantage of the described features.

### EXAMPLE 28

### Example Pseudo-Hash

In any of the examples herein, a pseudo-hash can be generated for input digital items (e.g., by performing a pseudo-hash function on a K-dimensional hash representing the digital item). In practice, any type of hashing can be used that aids in identifying similar items. Both data-dependent and data-independent hashing can be used. Example hashing includes locality-sensitive hashing (LSH), locality-preserving hashing (LPH), and the like. Other types of hashing can be used, such as PCA hashing, spectral hashing, semantic hashing, and deep hashing.

In practice, the pseudo-hash can take the form of a vector (e.g., m values). As described herein, elements of the pseudo-hash (e.g., the numerical values of the pseudo-hash vector) can be quantized, sparsified, and the like.

In some examples, LSH or LPH can be used that includes a distance function. In practice, any type of distance function can be used. Example distance functions include Euclidean distance, Hamming distance, cosine similarity distance, spherical distance or the like.

Extensions to hashing are possible. Example extensions include using multiple hash tables (e.g., to boost precision), multiprobe (e.g., to group similar hash tags), quantization, learning (e.g., data-dependent hashing), and the like.

### EXAMPLE 29

### Example Pseudo-Hash Model

In any of the examples herein, a pseudo-hash generator applying a pseudo-hash model can be used to generate pseudo-hashes. In practice, the same pseudo-hash model used to generate pseudo-hashes for sample items can be used to generate a pseudo-hash for a query item, thereby facilitating accurate matching of the query item to the sample items. In practice, any pseudo-hash model can be used that aids in hashing items for a similarity search. In any of the examples herein, a pseudo-hash model can include one or more reduction functions that transform features of input (e.g., elements of a K-dimensional hash) into a pseudo-hash with reduced dimensions.

In practice, the pseudo-hash model applies a reduction function to the input K-dimensional hash, thereby generating the resulting pseudo-hash. Thus, the digital item as represented by the K-dimensional hash of a feature vector is transformed into a digital pseudo-hash of the digital item via the hash of the feature vector representing the digital item. Various parameters can be input to the model for configuration as described herein.

The pseudo-hash model can also include binning In practice, any type of binning can be used that stores the hash into a discrete “bin,” where items assigned to the same bin are considered to be similar. In such a case, the hash can serve as an intermediary similarity search result, and the ultimate result is the bin in which the hash or similar hashes appear(s). In non-limiting examples, multiprobe, any non-LSH hash function, or the like can be used for binning

### EXAMPLE 30

### Example Dimension Reduction

In any of the examples herein, the resulting pseudo-hash can reduce the dimensionality of the input (e.g., a K-dimensional hash of aa feature vector representing a digital item). In practice, such dimension reduction can preserve distances of the input. In some examples, hash model reduction functions are designed to facilitate dimension reduction. As described herein, a variety of reduction functions can be used.

In practice, reduction function can be generated for use across K-dimensional hashes to facilitate matching. The reduction function can be chosen so that the resulting pseudo-hash (e.g., obtained by applying a summing or averaging function to numerical features of a K-dimension hash) has fewer dimensions that the feature vector. The numerical features of a K-dimensional hash can be configured for application of a reduction function in a variety of ways. In practice, a K-dimensional has can, for example, be represented by J blocks of M elements. Thus, by applying a reduction function (e.g., a summing or averaging function to J blocks of M elements of a K-dimensional hash) dimensionality is reduced or decreased (e.g., to an M-dimensional pseudo-hash).

In any of the reduction scenarios described herein, the dimension of the pseudo-hash can be represented as M, where M represents the sum or average of J blocks of M elements in a K-dimensional hash. For example, M can be selected to be less than or much less than K. An example M can be lower than input K by at least about 2-fold, 3-fold, 4-fold, 5-fold, 6-fold, 7-fold, 8-fold, 9-fold, 10-fold, 15-fold, 20-fold, 30-fold, 40-fold, 50-fold, 60-fold, 70-fold, 80-fold, 90-fold, 100-fold, 200-fold, 500-fold, or 1000-fold or 40-fold or 100-fold.

In any of the examples herein, dimension reduction can apply to any step or steps of the examples. For example, in the above scenario, dimension reduction can occur where K is greater than M, even if the dimension of the output is expanded to greater than M at a later step.

### EXAMPLE 31

### Example Method Implementing Pseudo-Hash Generation that Reduces Dimensionality of the Hash

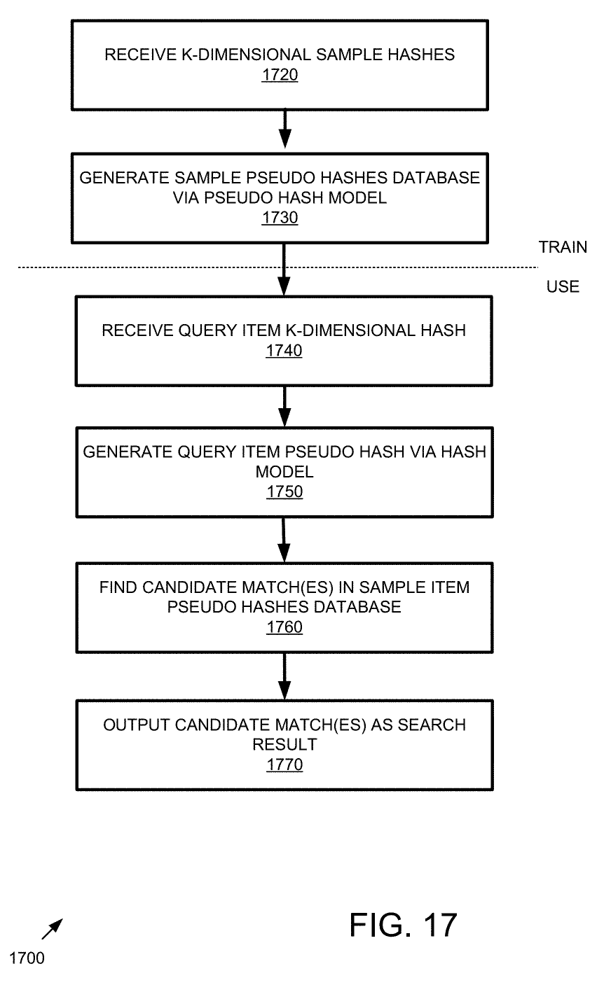

FIG. 17 is a flowchart of an example method 1700 of implementing similarity search via pseudo-hashes with reduced dimensionality and can be implemented in any of the examples herein, such as, for example, the system shown in FIG. 1.

In the example, both training and use of the technologies can be implemented. However, in practice, either phase of the technology can be used independently (e.g., a system can be trained and then deployed to be used independently of any training activity) or in tandem (e.g., training continues after deployment).

At 1720, K-dimensional sample hashes are received. Sample hashes can take the form as described herein.

At 1730, a sample pseudo-hashes database is generated using a pseudo-hash model. In practice, K-dimensional samples hashes are input into the pseudo-hash model, for example, as stored in a K-dimensional sample hash database, and sample pseudo-hashes are output. As shown, the sample pseudo-hashes can be entered into a database, such as for comparison with other pseudo-hashes (e.g., a query item pseudo-hash).

At 1740, one or more K-dimensional query hashes are received. Any K-dimensional query hash described herein can be used, for example, K-dimensional query hash 160, 1676, or 1860).

At 1750, an M-dimensional pseudo-hash of the K-dimensional query hash(es) is generated using a pseudo-hash model that includes reducing the dimension of a K-dimensional hash for an incoming query item. In practice, any such pseudo-hash model can be used. In example pseudo-hash models, summing functions, averaging functions and the like can be used as described herein.

At 1760, the M-dimensional query pseudo-hash(es) are matched to the M-dimensional sample pseudo-hashes database. In practice, any matching can be used that includes a distance function. Exemplary matching includes a nearest neighbor search (e.g., an exact, an approximate, or a randomized nearest neighbor search). A search function typically receives the query item hash and a reference to the database and outputs the matching hashes from the database, either as values, reference, or the like.

Extensions to hashing are possible. Example extensions include using multiple hash tables (e.g., to boost precision), multiprobe (e.g., to group similar hash tags), quantization, learning (e.g., data-dependent hashing), and the like.

At 1770, the matches are output as a candidate match search result. In practice, the candidate matches indicate that the query item and candidate match sample items are similar (e.g., a match). For example, in an image context, matching hashes indicate similar images. In other examples, the matches can be used to identify similar documents or eliminate document redundancy where the sample and query items are documents. In some examples, the matches can be used to identify matching fingerprints where the sample and query items are fingerprints. In another example, the matches can indicate similar genetic traits where the sample and query items are genomic sequences. In still further examples, the matches can be used to identify similar data, where the sample and query items are, for example, audio, image (e.g., biological, medical, facial, or handwriting images), video, geographical, geospatial, seismological, event (e.g., geographical, physiological, and social), app, statistical, spectroscopy, chemical, biological, medical, physical, physiological, or secure data. In additional examples, pseudo-hash matches for query and sample items that are data can be used to aid in predicting unknown or prospective events or conditions.

### EXAMPLE 32

### Example System Implementing Hash Generation that Expands Dimensionality and Sparsifies the Hash

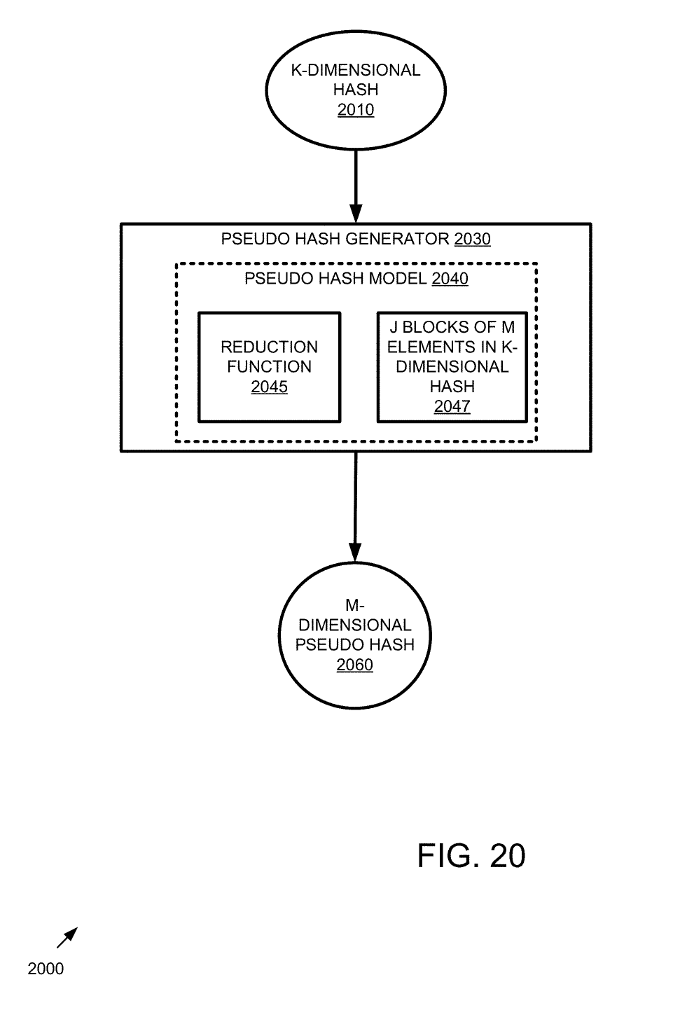

FIG. 20 is a block diagram of example systems 2000, implementing pseudo-hash generation that reduces dimensionality and can be used in any of the examples herein.

In the examples, there is a K-dimensional hash 2010, which can be any K-dimensional hash described herein (e.g., the sample hashes of database 140 or 1840; the K-dimensional hash 760 or 1010; K-dimensional query hash 160, 1676, or 1860, or the like). In practice, the K-dimensional hash represents a digital item.

The pseudo-hash generator 2030, comprising pseudo-hash model 2040, receives K-dimensional hash 2010 as input. The pseudo-hash model 2040 can implement any of the various features described for pseudo-hash models herein (e.g., the features of pseudo-hash model 1672). In the examples, hash model 2040 can include a reduction function (e.g., a summing function or an averaging function) 2045 that reduces the dimensionality of a K-dimensional hash; any reduction function described herein can be used. The model 2040 also includes a stored J blocks of M elements of the K-dimensional hash 2047, which is used for reducing the dimensionality of the hash (e.g., to M-dimensions) as described herein.

The examples further show output of an M-dimensional pseudo-hash 2060; although, any pseudo-hash described herein can be output, including, for example, M-dimensional pseudo hash 1675 or 2210 and the M-dimensional sample hashes of database 1674 or 2230.

### EXAMPLE 33

### Example Method Implementing Hash Generation that Expands Dimensionality and Sparsifies the Hash

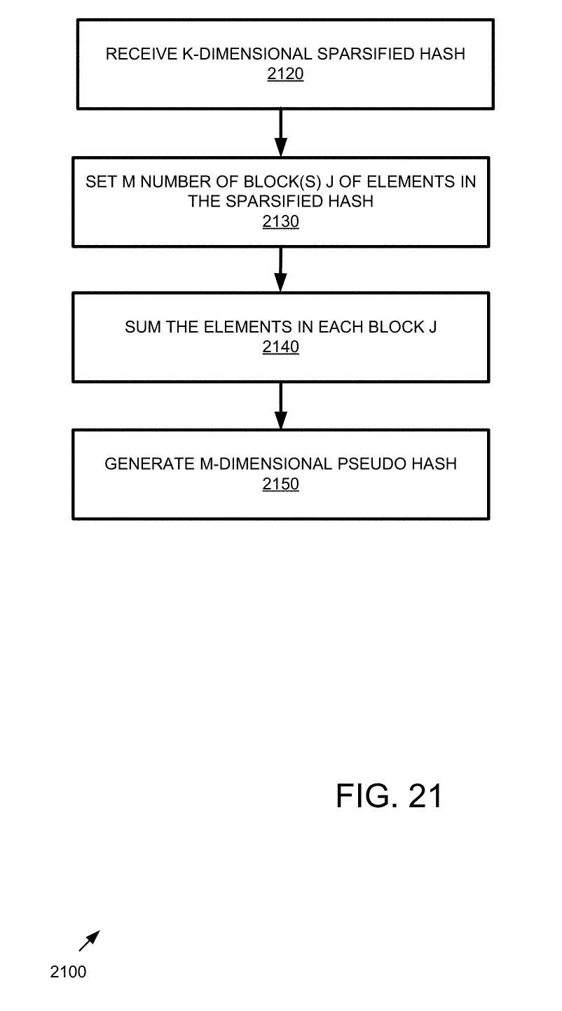

FIG. 21 is a flowchart of an example methods 2100, respectively, implementing hash generation that expands dimensionality and sparsifies the hash and can be implemented in any of the examples herein, such as, for example, by the system shown in FIG. 20 (e.g., by the hash model of the hash generator).

At 2120, a K-dimensional hash, such as a sample or query item K-dimensional hash is received. In practice, any K-dimensional hash as described herein (e.g., a sample hash of database 140 or 1840; the K-dimensional hash 760 or 1010; K-dimensional query hash 160, 1676, or 1860, or the like) can be used. The K-dimension hash can represent any item as described herein (e.g., item 110, 120, 310, 1810, or 1820).

At 2130, M number of blocks J containing the elements of the K-dimensional hash are selected. In practice, any configuration of M number of blocks J can be used.

At 2140, a reduction function is applied to the elements in each block J. Although a summing function is illustrated, in practice, any reduction function can be used as described herein (e.g., a summing or averaging function).

At 2150, the M-dimensional pseudo-hash (e.g., hash 2060) is output. In practice, any hash described herein can be output, including, for example, M-dimensional pseudo hash 1675 or 2210 and the M-dimensional sample hashes of database 1674 or 2230.

### EXAMPLE 34

### Example System Implementing Matching

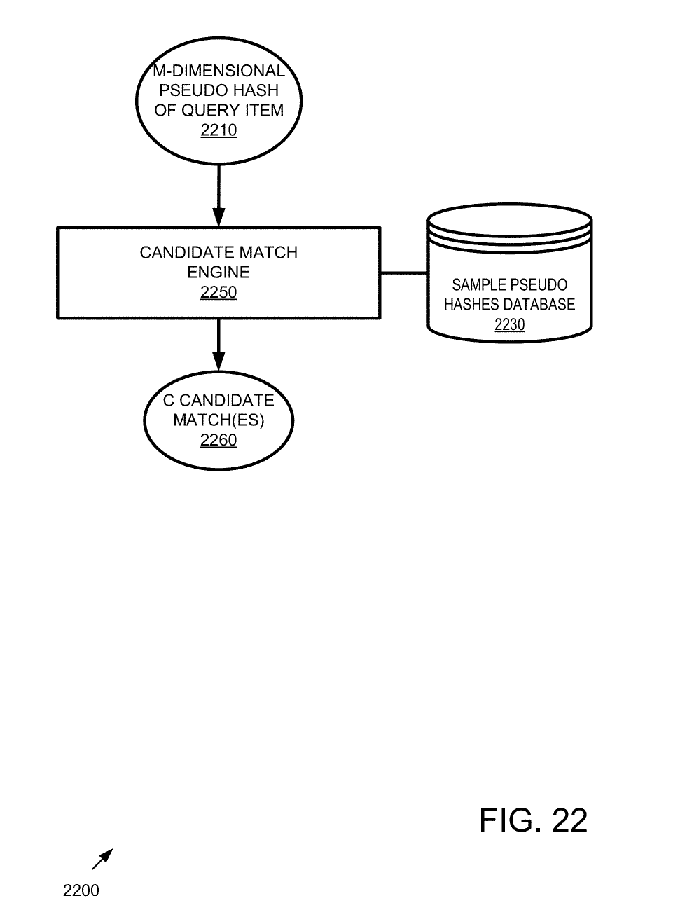

FIG. 22 is a block diagram of example system 2200, that can be used to implement matching in any of the examples herein.

In the example, an M-dimensional pseudo-hash 2210 of a query item (e.g., pseudo-hash 1660 or 2060), such as a pseudo-hash generated using pseudo-hash generator 1630 or 2030, comprising pseudo-hash model 1637 or 2040 is shown. The example further shows a sample pseudo-hash database 2230, which can include any number of any pseudo-hashes described herein (e.g., the sample pseudo-hashes of database 1640). In practice, the sample pseudo-hashes database 2230 contains pseudo-hashes generated by the same model used to generate the pseudo-hash 2210.

The candidate match engine 2250 accepts the pseudo-hash 2210 as input and finds matching pseudo-hashes in the sample pseudo-hashes database 2230. Although candidate match engine 2250 is shown as connected to sample pseudo-hashes database 2230, candidate match engine 2250 can receive sample pseudo-hashes database 2230 in a variety of ways (e.g., sample pseudo-hashes can be received even if they are not compiled in a database). Matching using candidate match engine 2250 can comprise any matching technique described herein.

Also shown, candidate match engine 2250 can output C candidate matches 2260. C candidate matches 2260 can include pseudo-hashes similar to the query item pseudo-hash 2210 (e.g., pseudo-hashes that represent digital items or representations thereof that are similar to the query item represented by pseudo-hash 2210).

Instead of implementing candidate matches, in any of the examples herein, a simple match (e.g., exact match) can be implemented (e.g., that finds one or more sample item pseudo-hashes that match the query item pseudo-hash).

### EXAMPLE 35

### Example Method Implementing Matching

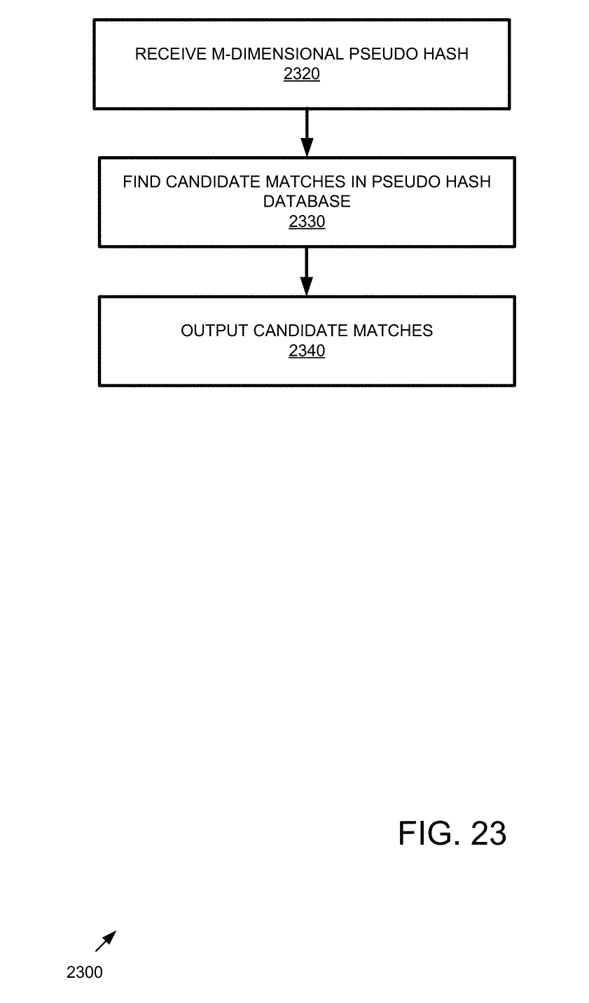

FIG. 23 is a flowchart of example method 2300, implementing matching and can be implemented by any of the example herein, including, for example, by the system 2200 (e.g., by the nearest neighbor(s) engine 2250).

At 2320, an M-dimensional pseudo-hash of a query item is received. Any pseudo-hash can be received as described herein, such as M-dimensional pseudo-hash 2210, of any item described herein, such as item 120, 310, 1610, or 2210.

At 2330, the candidate matches in a pseudo-hash database are found, such as by using candidate match engine 2250, for finding similar pseudo-hashes. Any sample pseudo-hashes or compilation thereof can be used, such as sample pseudo-hashes database 2230. The sample pseudo-hashes represent items (e.g., digital items or representations of items, such as items 120, 310, 1610, or 2210).

At 2340, the example further shows outputting candidate matches as a search result (e.g., C candidate matches 2260). Any pseudo-hashes similar to query item pseudo-hash 2210 can be output, such as pseudo-hashes that represent items similar to the query item can output. In practice, a pseudo-hash corresponds to a sample item, so a match with a pseudo-hash indicates a match with the respective sample item of the pseudo-hash.

### EXAMPLE 36

### Example Implementation

In any of the examples herein, various aspects of the technologies can be architected to mimic those of fly olfactory biology (e.g., as described in Example 37). For example, input odors can be represented as feature vectors, and the resulting hash results represent firing neurons, the set of which can be called a “tag.” In the example, elements of the hash vector are used to mimic the function of Kenyon cells. So, in a winner-take-all scenario, the indexes of the top k Kenyon cells (e.g., the elements of the hash vector) can be used as the tag.

In some examples, input items, such as any digital item or representation of an item as described herein, can undergo one or more preprocessing steps that mimic preprocessing steps implemented in the fly for input odors. An example of such fly preprocessing includes normalization (e.g., mean-centering). The fly implements such normalization by removing the concentration dependence of the input odor through a feedforward connection between odorant receptor neurons (ORNs) that receive the input odor and projection neurons (PNs), which both receive odor information from the ORNs and share recurrent connections with other PNs. The result is that the PNs include a concentration-independent exponential distribution of firing rates for a particular odor. Thus, in some examples, preprocessing in a similarity search can implement steps that mimic such normalization, for example, thorough mean-centering, converting the item input (e.g., feature vector) to an exponential distribution, or both.

In other examples, input items (e.g., feature vectors) can undergo hashing using one or more steps that mimic hash steps implemented in the fly for input odors. Examples of such fly hash steps include a sparse dimensionality expansion step and a sparsification step. In the sparse dimensionality expansion step, the fly expands the dimension of the input odor by randomly projecting the information of PNs to 40-fold more Kenyon cells (KCs). Further, only a subset of the PNs are sampled; thus, the dimensionality expansion is a sparse random projection. Mimicking the random projection of the fly, input items (e.g., feature vectors) can undergo hashing by applying (e.g., multiplying) a feature vector with, for example, D-dimensions to a matrix with K-dimensions, where K is greater or much greater than D. Further, where a subset of the feature vector is sampled (e.g., where a feature vector includes a set of values, and only a subset of the values are sampled), the matrix is sparse, mimicking the sparse projection in the fly.

In its sparsification step, the fly only selects the highest-firing 5% KCs for assigning a tag using inhibitory feedback from a single inhibitory neuron, anterior paired lateral neuron (APL). Mimicking the sparsification step of the fly, hashing results from input items (e.g., feature vectors) can also be sparsified using a similar winner-take-all (WTA) technique. Other steps (e.g., quantization or other normalization steps) can be used in a similarity search hash to enhance the synergistic effects of the hash or preprocessing steps that mimic the fly olfactory biology. Further, a similarity search can use each of the fly hash or preprocessing steps alone or in any combination. In further examples, the degree of sparse dimension expansion and sparsification in fly olfactory biology can be tuned according to the characteristics of the input items (e.g., feature vectors)

### EXAMPLE 37

### Example Implementation

A similarity search, such as identifying similar images in a database or similar documents on the web, is a fundamental computing problem faced by large-scale information retrieval systems. The fruit fly olfactory circuit solves this problem. The fly circuit assigns similar neural activity patterns to similar odors so that behaviors learned from one odor can be applied when a similar odor is experienced. However, the fly algorithm uses three computational strategies that depart from traditional approaches, which can be modified to improve the performance of computational similarity searches. This perspective helps illuminate the logic supporting an important sensory function and provides a conceptually new algorithm for solving a fundamental computational problem.

An essential task of many neural circuits is to generate neural activity patterns in response to input stimuli, so that different inputs can be specifically identified. The circuit used to process odors in the fruit fly olfactory system was studied, and computational strategies were uncovered for solving a fundamental machine learning problem: approximate similarity (or nearest-neighbors) search.

The fly olfactory circuit generates a “tag” for each odor, which is a set of neurons that fire when that odor is presented (C. F. Stevens, Proc. Natl. Acad. Sci. U.S.A. 112,9460-9465 (2015)). This tag aids in learning behavioral responses to different odors (D. Owald, et al., Curr. Opin. Neurobiol. 35,178-184 (2015)). For example, if a reward (e.g., sugar water) or a punishment (e.g., electric shock) is associated with an odor, that odor becomes attractive (a fly will approach the odor) or repulsive (a fly will avoid the odor), respectively. The tags assigned to odors are sparse because only a small fraction of the neurons that receive odor information respond to each odor (G. C. Turner, et al., J. Neurophysiol. 99,734-746 (2008); A. C. Lin, et al., Nat. Neurosci. 17,559-568 (2014); M. Papadopoulou, et al., Science 332,721-725 (2011)) and nonoverlapping because tags for two randomly selected odors share few, if any, active neurons to easily distinguish different odors (C. F. Stevens, Proc. Natl. Acad. Sci. U.S.A. 112,9460-9465 (2015)).

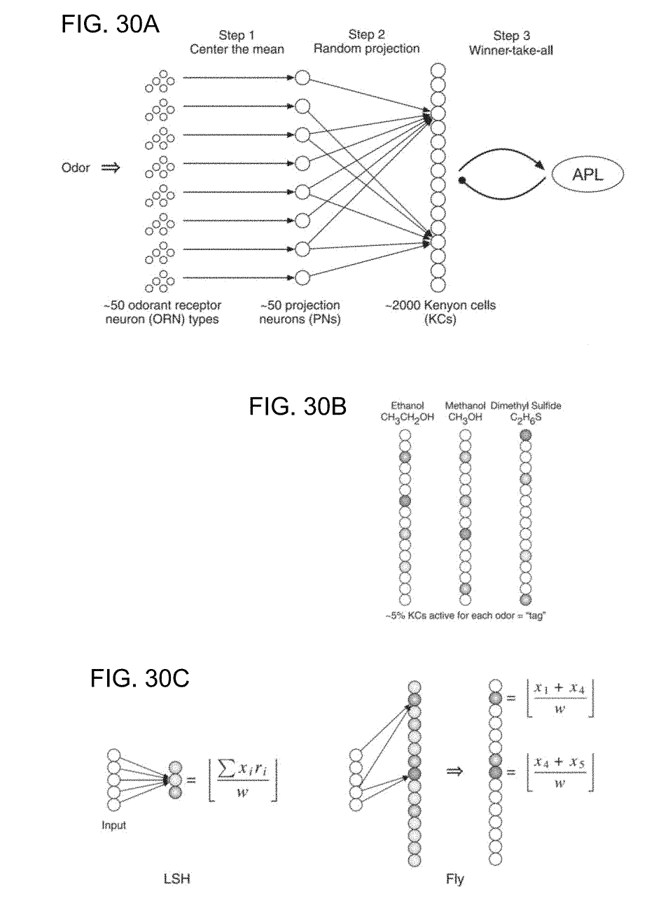

The tag for an odor is computed by a three-step procedure (FIG. 30A). The first step involves feedforward connections from odorant receptor neurons (ORNs) in the fly's nose to projection neurons (PNs) in structures referred to as glomeruli. There are 50 ORN types, each with a different sensitivity and selectivity for different odors. Thus, each input odor has a location in a 50-dimensional space determined by the 50 ORN firing rates. For each odor, the distribution of ORN firing rates across the 50 ORN types is exponential with a mean that depends on the concentration of the odor (E. A. Hallem, et al., Cell 125,143-160 (2006); C. F. Stevens, Proc. Natl. Acad. Sci. U.S.A. 113,6737-6742 (2016)). For the PNs, this concentration dependence is removed (C. F. Stevens, Proc. Natl. Acad. Sci. U.S.A. 113,6737-6742 (2016); S. R. Olsen, et al., Neuron 66, 287-299 (2010)). That is, the distribution of firing rates across the 50 PN types is exponential with close to the same mean for all odors and all odor concentrations (C. F. Stevens, Proc. Natl. Acad. Sci. U.S.A. 112, 9460-9465 (2015)). Thus, the first step in the circuit essentially “centers the mean,” which is a preprocessing step in many computational pipelines, using a technique referred to as divisive normalization (S. R. Olsen, et al., Neuron 66,287-299 (2010)). This step is important so that the fly does not mix up odor intensity with odor type.

The second step, involves a 40-fold expansion in the number of neurons: fifty PNs project to 2000 Kenyon cells (KCs), connected by a sparse, binary random connection matrix (S. J. Caron, et al., Nature 497, 113-117 (2013)). Each KC receives and sums the firing rates from approximately six randomly selected PNs (S. J. Caron, et al., Nature 497,113-117 (2013)). The third step involves a winner-take-all (WTA) circuit in which strong inhibitory feedback comes from a single inhibitory neuron referred to as APL (anterior paired lateral neuron). As a result, all but the highest-firing 5% of KCs are silenced (C. F. Stevens, Proc. Natl. Acad. Sci. U.S.A. 112,9460-9465 (2015); G. C. Turner, et al., J. Neurophysiol. 99,734-746 (2008); A. C. Lin, et al., Nat. Neurosci. 17,559-568 (2014)). The firing rates of these remaining 5% correspond to the tag assigned to the input odor.

The fly's circuit can be viewed as a hash function, the input for which is an odor, and the output for which is a tag (referred to as a hash) for that odor. Although tags should discriminate odors, it is also to the fly's advantage to associate very similar odors with similar tags (FIG. 30B) so that conditioned responses learned for one odor can be applied when a very similar odor or a noisy version of the learned odor is experienced. Thus, the fly's circuit produces tags that may be locality-sensitive; that is, the more similar a pair of odors (as defined by the 50 ORN firing rates for that odor), the more similar their assigned tags. Locality-sensitive hash [LSH (A. Andoni, et al., Commun. ACM 51,117 (2008); A. Gionis, et al., in VLDB'99, Proceedings of the 25th International Conference on Very Large Data Bases, (Morgan Kaufman, 1999), pp. 158-529)] functions serve as the foundation for solving numerous similarity search problems in computer science. Insights from the fly's circuit were modified to develop a class of LSH algorithms for efficiently finding approximate nearest neighbors of high-dimensional points.

In an example of a nearest neighbors search problem, an image of an elephant is given, and the problem entails seeking 100 images out of the billions of images on the web that look most similar to the elephant image. This type of nearest-neighbors search problem is fundamentally important in information retrieval, data compression, and machine learning (A. Andoni, et al., Commun. ACM 51,117 (2008)). Each image is typically represented as a d-dimensional vector of feature values. (Each odor that a fly processes is a 50-dimensional feature vector of firing rates.) A distance metric is used to compute the similarity between two images (feature vectors), and the goal is to efficiently find the nearest neighbors of any query image. If the web contained only a few images, then a brute force linear search could easily be used to find the exact nearest neighbors. If the web contained many images, but each image was represented by a low-dimensional vector (e.g., 10 or 20 features), then space-partitioning methods (H. Samet, Foundations of Multidimensional and Metric Data Structures (Morgan Kaufmann Series in Computer Graphics and Geometric Modeling, Morgan Kaufmann, 2005)) would similarly suffice. However, for large databases with high-dimensional data, neither approach scales (A. Gionis, et al., in VLDB'99, Proceedings of the 25th International Conference on Very Large Data Bases, (Morgan Kaufman, 1999), pp. 158-529)).

In many applications, returning an approximate set of nearest neighbors that are “close enough” to the query is adequate so long as they can be found quickly. For the fly, a locality-sensitive property states that two odors that generate similar ORN responses will be represented by two tags that are similar (FIG. 30B). Likewise, for an image search, the tag of an elephant image will be more similar to the tag of another elephant image than to the tag of a skyscraper image.

Unlike a traditional (non-LSH) hash function, where the input points are scattered randomly and uniformly over the range, an LSH function provides distance-preserving embedding of points from d-dimensional space into m-dimensional space (the latter corresponds to the tag). Thus, points that are closer to one another in input space have a higher probability of being assigned the same or a similar tag than points that are far apart.

To design an LSH function, one common trick is to compute random projections of input data (A. Andoni, et al., Commun. ACM 51,117 (2008); A. Gionis, et al., in VLDB'99, Proceedings of the 25th International Conference on Very Large Data Bases, (Morgan Kaufman, 1999), pp. 158-529)), that is, to multiply the input feature vector by a random matrix. The Johnson-Lindenstrauss lemma (W. Johnson, et al., in Conference on Modern Analysis and Probability, vol. 26 of Contemporary Mathematics (1984), pp. 189-206; S. Dasgupta, et al., Random Structures Algorithms 22,60-65 (2003)) and its many variants (D. Achlioptas, J. Comput. Syst. Sci. 66,671-687 (2003); Z. Allen-Zhu, et al., Proc. Natl. Acad. Sci. U.S.A. 111,16872-16876 (2014); D. Kane, et al., J. Assoc. Comput. Mach. 61,4 (2014)) provide strong theoretical bounds on how well locality is preserved when embedding data from d- into m-dimensions by using various types of random projections.

The fly also assigns tags to odors through random projections (step 2 in FIG. 30A; 50 PNs→2000 KCs), which provides a key clue to the function of this part of the circuit. There are, however, three differences between the fly algorithm and conventional LSH algorithms. First, the fly uses sparse, binary random projections, whereas LSH functions typically use dense, Gaussian random projections that require many more mathematical operations to compute. Second, the fly expands the dimensionality of the input after projection (d«m), whereas LSH reduces the dimensionality (d»m). Third, the fly sparsifies the higher-dimensionality representation by a WTA mechanism, whereas LSH preserves a dense representation.

Show below (SUPPLEMENTAL), analytically, sparse, binary random projections of the type in the fly olfactory circuit generate tags that preserve the neighborhood structure of input points. This proves that the fly's circuit represents a previously unknown LSH family.

The fly algorithm was then empirically evaluated versus traditional LSH (A. Andoni, et al., Commun. ACM 51, 117 (2008); A. Gionis, et al., in VLDB'99, Proceedings of the 25th International Conference on Very Large Data Bases, (Morgan Kaufman, 1999), pp. 158-529)) on the basis of how precisely each algorithm could identify nearest neighbors of a given query point. To perform a fair comparison, the computational complexity of both algorithms was the same (FIG. 30C). That is, the two approaches used the same number of mathematical operations to generate a hash of length k (i.e., a vector with k non-zero values) for each input (below, SUPPLEMENTAL).

The two algorithms were compared by using each one for finding nearest neighbors in three benchmark data sets: SIFT (d=128), GLOVE (d=300), and MNIST (d=784) (below, SUPPLEMENTAL). SIFT and MNIST both contain vector representations of images used for image similarity search, whereas GLOVE contains vector representations of words used for semantic similarity search. A subset of each data set was used with 10,000 inputs each, in which each input was represented as a feature vector in d-dimensional space. To test performance, 1000 random query inputs were selected from the 10,000, and true versus predicted nearest neighbors were compared. That is, for each query, the top 2% (M. S. Charikar, in Proceedings of the Thirty-Fourth Annual ACM Symposium on Theory of Computing, ACM (2002) pp. 380-388) true nearest neighbors in input space was found, as determined on the basis of Euclidean distance between feature vectors. The top 2% of predicted nearest neighbors in m-dimensional hash space was then found, as determined on the basis of the Euclidean distance between tags (hashes). The length of the hash (k) was varied, and the overlap between the ranked lists of true and predicted nearest neighbors was computed by using the mean average precision (Y. Lin, et al., in 2013 IEEE Conference on Computer Vision and Pattern Recognition (IEEE Computer Society, 2013), pp. 446-451). The mean average precision was then averaged over 50 trials, in which, for each trial, the random projection matrices and the queries changed. Each of the three differences between the fly algorithm and LSH was isolated to test their individual effect on nearest-neighbors retrieval performance.

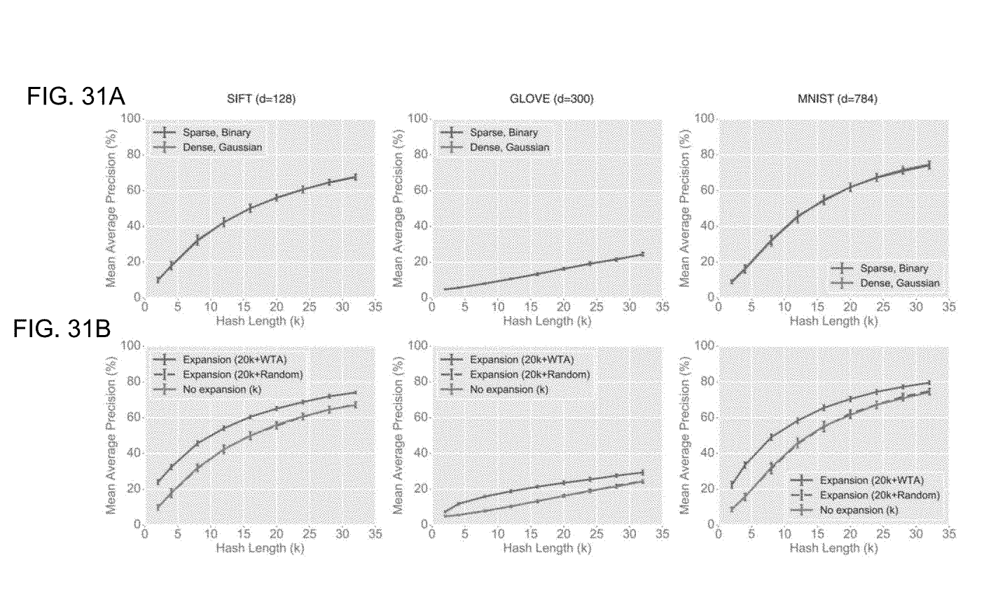

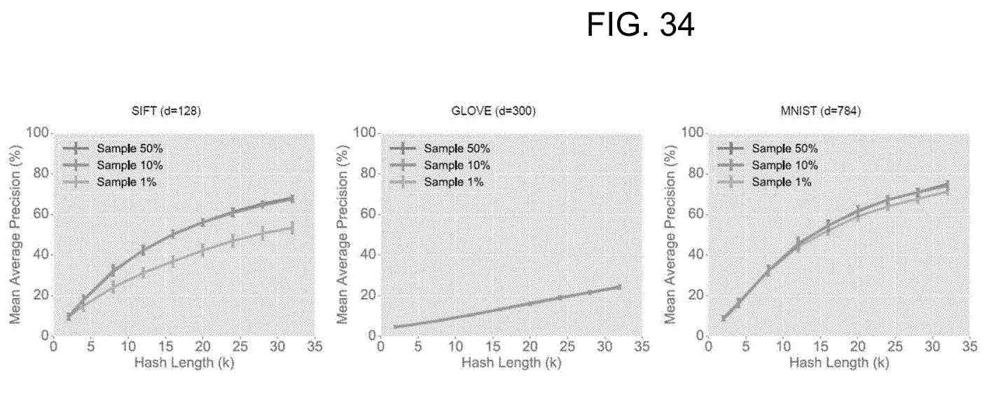

Replacing the dense Gaussian random projection of LSH with a sparse binary random projection did not hurt how precisely nearest neighbors could be identified (FIG. 31A). These results support the theoretical calculations, showing that the fly's random projection is locality-sensitive. Moreover, the sparse, binary random projection achieved a computational savings of a factor of 20 relative to the dense, Gaussian random projection (below, SUPPLEMENTAL; FIG. 34).

When expanding the dimensionality, sparsifying the tag using WTA resulted in better performance than using random tag selection (FIG. 18B). WTA selected the top k firing KCs as the tag, unlike random tag selection, which selected k random KCs. For both, 20 k random projections were for the fly to equate the number of mathematical operations used by the fly and LSH (below, SUPPLEMENTAL). For example, for the SIFT data set with hash length k=4, random selection yielded a 17.7 % mean average precision, versus roughly double that (32.4%) using WTA. Thus, selecting the top firing neurons best preserves relative distances between inputs; the increased dimensionality also makes it easier to segregate dissimilar inputs. For random tag selection, k random (but fixed for all inputs) KCs were selected for the tag; hence, its performance is effectively the same as doing k random projections, as in LSH. With further expansion of the dimensionality (from 20 k to 10 d KCs, closer to the actual fly's circuitry), further gains were obtained relative to LSH in identifying nearest neighbors across all data sets and hash lengths (FIG. 19). The gains were highest for very short hash lengths, where there was an almost threefold improvement in mean average precision (e.g., for MNIST with k=4, 16.0% for LSH, versus 44.8% for the fly algorithm).

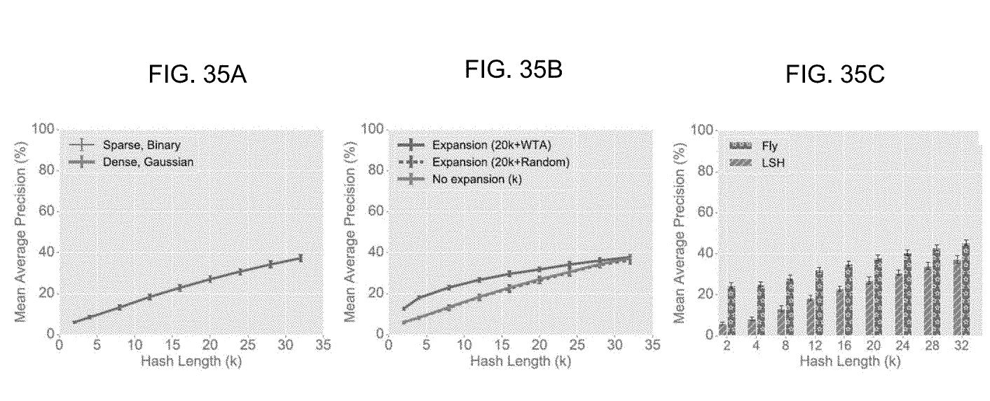

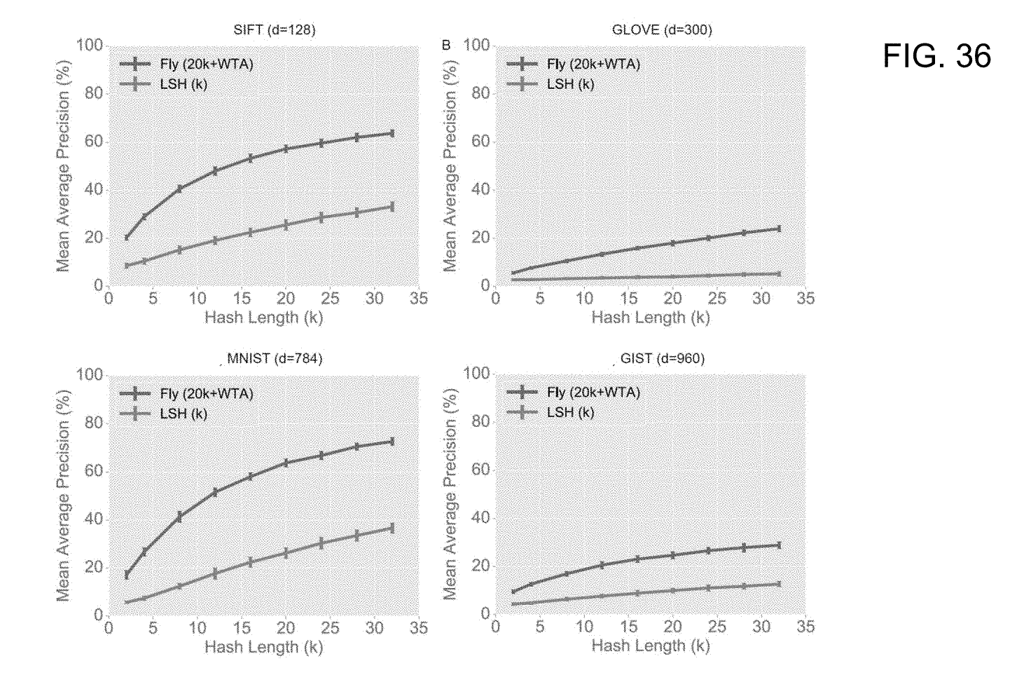

Similar gains in performance were also found when testing the fly algorithm in higher dimensions and for binary LSH (M. S. Charikar, in Proceedings of the Thirty-Fourth Annual ACM Symposium on Theory of Computing, ACM (2002) pp. 380-388) (below, SUPPLEMENTAL; FIGS. 35-36). Thus, the fly algorithm is scalable and may be useful across other LSH families

A synergy between strategies was identified for similarity matching in the brain (C. Pehlevan, et al., in NIPS'15, Proceedings of the 28th International Conference on Neural Information Processing Systems (MIT Press, 2015), pp. 2269-2277) and hashing algorithms for nearest-neighbors search in large-scale information retrieval systems. The synergy may also have applications in duplicate detection, clustering, and energy-efficient deep learning (R. Spring, et al., Scalable and sustainable deep learning via randomized hashing (2016)). There are numerous extensions to LSH (M. Slaney, et al., Proc. IEEE 100, 2604-2623 (2012)), including the use of multiple hash tables (A. Gionis, et al., in VLDB'99, Proceedings of the 25th International Conference on Very Large Data Bases, (Morgan Kaufman, 1999), pp. 158-529)) to boost precision (we used one for both algorithms), the use of multiprobe (Q. Lv, et al., in VLDB '07, Proceedings of the 33rd International Conference on Very Large Data Bases (ACM, 2007), pp. 950-961) so that similar tags can be grouped together (which may be easier to implement for the fly algorithm because tags are sparse), various quantization tricks for discretizing hashes (P. Li, et al., in Proceedings of the 31st International Conference on Machine Learning (Proceedings of Machine Learning Research, 2014), pp. 676-684), and learning [called data-dependent hashing (below, SUPPLEMENTAL)]. There are also methods to speed up the random projection multiplication, both for LSH schemes by fast Johnson-Lindenstrauss transforms (A. Dasgupta, et al., in KDD '11, The 17th ACM SIGKDD International Conference on Knowledge Discovery and Data Mining (ACM, 2011), pp. 1073-1081; A. Andoni, et al., in NIPS'15, Proceedings of the 28th International Conference on Neural Information Processing Systems (MIT Press, 2015), pp. 1225-1233) and for the fly by fast sparse matrix multiplication.

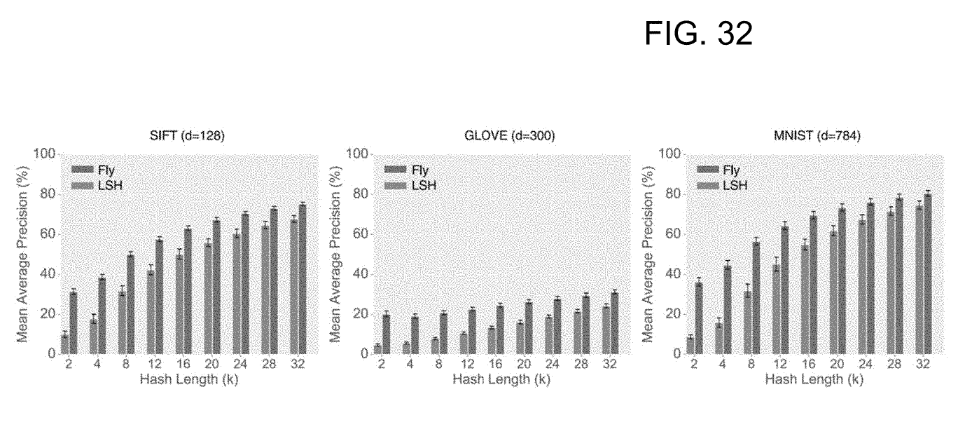

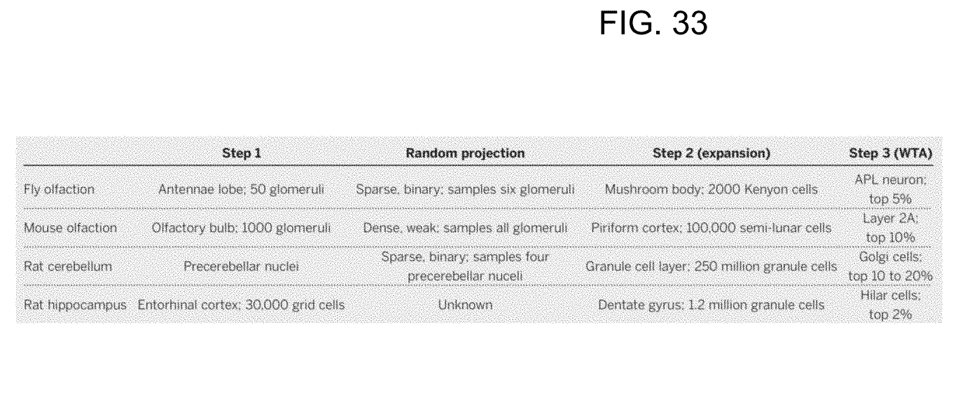

Algorithms that are similar to the fly's strategies are known. For example, MinHash (A. Broder, in Proceedings of the Compression and Complexity of Sequences 1997 (IEEE Computer Society, 1997), p. 21) and winner-take-all hash (J. Yagnik, et al., in 2011 International Conference on Computer Vision (IEEE Computer Society, 2011), pp. 2431-2438) both use WTA-like components, though neither propose expanding the dimensionality; similarly, random projections are used in many LSH families, but none use sparse, binary projections. The fly olfactory circuit appears to have evolved to use a distinctive combination of these computational ingredients. The three hallmarks of the fly's circuit motif may also appear in other brain regions and species (FIG. 32). Thus, locality-sensitive hashing may be a general principle of computation used in the brain (L. G. Valiant, Curr. Opin. Neurobiol. 25, 15-19 (2014)).

SUPPLEMENTAL: Datasets and pre-processing. Empirical evaluations were performed on four benchmark datasets: SIFT (L. G. Valiant, Curr. Opin. Neurobiol. 25, 15-19 (2014)) (d=128), GLOVE (J. Pennington, et al. in Empirical Methods in Natural Language Processing (EMNLP), pp. 1532-1543, 2014) (d=300), MNIST (Y. Lecun, et al. Proc. of the IEEE, vol. 86, no. 11, pp. 2278-2324, 1998) (d=784), and GIST (H. Jegou, et al. IEEE Transactions on Pattern Analysis and Machine Intelligence, vol. 33, no. 1, pp. 117-128, 2011) (d=960). For each dataset, a subset of size 10,000 inputs was selected to efficiently perform the all-vs-all comparison in determining true nearest neighbors. For all datasets, each input vector was normalized to have the same mean.

Fixing the computational complexity for LSH and the fly to be the same. To perform a fair comparison between the fly's approach and LSH, the computational complexity of both algorithms was fixed as the same (FIG. 30C). That is, the two approaches were fixed to use the same number of mathematical operations to generate a hash with length k (i.e., a vector with k non-zero values) for each input. LSH computes m=k random projections per input, but each projection requires 2 d operations—multiplying each entry of the d-dimensional input by an i.i.d. Gaussian random value, and then doing d summations. For the fly, each binary random projection only requires 0.1 d operations to compute—summing the roughly 10% of the input indices sampled (6 out of 50) by each Kenyon cell. Thus, the fly can compute m=20 k random projections, while incurring the same computational expense as LSH. The only additional expense for the fly is the sparsification step so that only k (of the 20 k) values are non-zero, as in the LSH tag.

Formal definition of a locality-sensitive hash function. The formal definition of a locality-sensitive hash function is as follows:
Definition 1. A hash function h: [symbol] ^{d}→ [symbol] ^{m} is called locality-sensitive if for any two points p, q ∈ [symbol] ^{d}, Pr[h(p)=h(q)]=sim(p, q), where sim(p, q) ∈ [0, 1] is a similarity function defined on two input points.
In practical applications for nearest-neighbors search, a second (traditional) hash function is used to place each m-dimensional point into a discrete bin so that all similar images lie in the same bin, for easy retrieval.

Designs for the LSH function (h) and study how tags are generated and the computational properties of the tag are considered. How the tag is subsequently used is also considered. Computationally, the binning step (placing each m-dimensional point into a discrete bin) is important because processing a query image then involves simply finding its bin and returning the most similar images that lie in the same bin, which takes sub-linear time. Biologically, the tag is used in the mushroom body for learning, which occurs by identifying which Kenyon cells respond to an odor (the tag), and modifying the strength of their synapses onto approach and avoidance circuits. How learning occurs algorithmically using this tag remains an open problem. Even if learning does not require a similar “binning” step, both problems require the same first step—forming the tag/hash of an input point—which is considered.

Theoretical analysis of the fly olfactory circuit. The mapping from projection neurons (PNs) to Kenyon cells (KCs) can be viewed as a bipartite connection matrix, with d=50 PNs on the left and the m=2000 KCs on the right. The nodes on the left take values x₁, . . . , x_{d} and those on the right are y₁, . . . , yₘ. Each value yⱼ is equal to the sum of a small number of the xᵢ's; this relationship is related by an undirected edge connecting every such xᵢ with yⱼ. This bipartite graph can be summarized by an m×d adjacency matrix M:

$${M}_{ji} = \{ \begin{matrix}1 & if {x}_{i} connects to {y}_{j} \\ 0 & otherwise\end{matrix} .$$

Moving to vector notation, with x=(x₁, . . . , x_{d}) ∈ [symbol] ^{d} and y=(y₁, . . . , yₘ) ∈ [symbol] ^{m}, y=Mx. (In practice, an additional quantization step is used for discretization:

$$y ⌊ \frac{M x}{w} ⌋$$

where w is a constant, and └•┘ is the floor operation). After feedback inhibition from the APL neuron, only the k highest firing KCs retain their values; the rest are zeroed out. This winner-take-all mechanism produces a sparse vector z ∈ [symbol] ^{m} (called the tag) with:

$${z}_{i} = \{ \begin{matrix}{y}_{i} & if {y}_{i} is one of the k largest entries in y \\ 0 & otherwise\end{matrix} .$$

A simple model of M is a sparse, binary random matrix: each entry Mᵢⱼ is set independently with probability p. Choosing p=6/d, for instance, would mean that each row of M has roughly 6 entries equal to 1 (and all of the other entries are 0), which matches experimental findings.

The proof below shows that the first two steps of the fly's circuitry produces tags that preserve [symbol] ₂ distances of input odors in expectation. The third step (winner-take-all) is then a simple method for sparsifying the representation while preserving the largest and most discriminative coefficients (Donoho, IEEE Trans. Inf. Theory 52, pp. 1289-1306, 2006). The proof further shows that when m is large enough (i.e., the number of random projections is O(d)), the variance ∥y∥² is tightly concentrated around its expected value.

Distance-preserving properties of sparse binary projections. Sparse binary random projections, of the type outlined above, are shown to preserve neighborhood structure if the number of projections m is sufficiently large. A key determiner of how well distances are preserved is the sparsity of the vectors x.

Fix any x ∈ [symbol] ^{d} denoting the activations of the projection neurons. Let Mⱼ denote the j^{th} row of matrix M , so that Yⱼ=Mⱼ·x is the value of the j^{th} Kenyon cell. The first and second moments of Yj are computed as follows.
Lemma 1. Fix any x∈ [symbol] ^{d} and define Y=(Y₁, . . . , Yₘ)=Mx. For any 1≤j≤m,

[symbol]

Yⱼ=p(1·x)

[symbol]

Yⱼ²=p(1−p)∥x∥²+p²(1·x)²

where 1 is the all-ones vector (and thus 1·x is the sum of the entries of x). For the squared Euclidean norm of Y, namely ∥Y∥²=Y₁²+ . . . +Yₘ², this implies

[symbol]

∥Y∥²=mp((1−p)∥x∥²+p(1·x)²).

Likewise, if two inputs x, x′ ∈ [symbol] ^{d} get projected to Y, Y′ ∈ [symbol] ^{m}, respectively, then

[symbol]

∥Y−Y′∥²=mp((1−p)∥x−x′∥²+p(1·(x−x′))²).

In the fly, the second (bias) term, p²(1·(x−x′))²≈0, because x and x′ have roughly the same total activation level. This is because all odors are represented as an exponential distribution of firing rates with the same mean, for all odors and all odor concentrations. Thus, the bias term is negligible, and the random projection x→Y preserves l₂ distances.

The result (C. F. Stevens, Proc. Natl. Acad. Sci. U.S.A., vol. 112, no. 30, pp. 9460-9465 (2015) is only a statement about expected distances. The reality could be very different if the variance of ∥Y∥² is high. However, we will see that when m is large enough, ∥Y∥² is tightly concentrated around its expected value, in the sense that

(1−ϵ) [symbol] ∥Y∥²≤∥Y∥²≤(1+ϵ) [symbol] ∥Y∥²,

with high probability, for small ϵ>0. The required m depends on how sparse x is.

It is useful to look at two extremal cases in more detail:

1. x is very sparse.

Suppose the only non-zero coordinate of x is x₁. Then Yⱼ=Mⱼ·x has the following distribution:

$${Y}_{j} = \{ \begin{matrix}{x}_{1} & with probability p \\ 0 & otherwise\end{matrix}$$

This is usually zero, and if not, then

2. x is uniformly spread.

If x=(xₒ, xₒ, . . . , xₒ), then Yⱼ has mean pdxₒ=c∥x∥/\sqrt{d}. The distribution of Yⱼ/xₒ is roughly Poisson.

Thus individual Yⱼ can have a fairly large spread of possible values if x is sparse. Consider how large must m be for ∥Y∥² to be tightly concentrated around its expected value. It is always sufficient to take m=O(d), and that this upper bound is also necessary for sparse x. For x closer to uniform, m=O(1) is sufficient.
Lemma 2. Fix any x ∈ [symbol] ^{d} and pick 0<δ, E<1. If we take

$$m \geq \frac{5}{{ϵ}^{2} δ} ( 2 c + \frac{d {‖ x ‖}_{4}^{4}}{{‖ x ‖}^{4}} ) ,$$

then with probability at least 1−δ, (1−ϵ) [symbol] ∥Y∥²≤∥Y∥²≤(1+ϵ) [symbol] ∥Y∥².

Here ∥x∥₄ is the 4-norm of x, so

$${‖ x ‖}_{4}^{4} = {\sum }_{i = 1}^{d} {x}_{i}^{4} .$$

The ratio ∥x∥₄⁴/∥x∥⁴ lies in the range [1/d, 1]. It is 1 when xis very sparse and 1/d when x is uniformly spread out. Shown below, this ratio is roughly 6/d when the individual coordinates of x are independent draws from the same exponential distribution.
Lemma 3. Suppose X=(X₁, . . . , X_{d}), where the Xᵢ are i.i.d. draws from an exponential distribution (with any mean parameter).

$$( a ) \frac{𝔼 {‖ X ‖}_{4}^{4}}{{( 𝔼 {‖ X ‖}_{2}^{2} )}^{2}} = \frac{6}{d} .$$

(b) Moreover, ∥X∥₂² and ∥X∥₄⁴ are tightly concentrated around their expectations. In particular, for any positive integer c, and any 0<δ<1, with probability at least 1−δ,

$${‖ X ‖}_{c}^{c} = 𝔼 ( {‖ X ‖}_{c}^{c} ) ( 1 \pm \frac{{2}^{c}}{\sqrt{d δ}} ) .$$

Proof of Lemma 1. Fix any x ∈ [symbol] ^{d} and 1≤j≤m. For any i≠i′.

[symbol]

Mⱼᵢ=p

[symbol]

(MⱼᵢM_{ji′})=p²
The expressions for [symbol] Yⱼ and [symbol] Yⱼ² then follow immediately, using linearity of expectation:

$$\begin{matrix}{𝔼Y}_{j} = 𝔼 ( {\sum }_{i} {M}_{ji} {x}_{i} ) = p {\sum }_{i} {x}_{i} \\ {𝔼Y}_{j}^{2} = {𝔼 ( {\sum }_{i} {M}_{ji} {x}_{i} )}^{2} = {\sum }_{{ii}^{′}} 𝔼 ( {M}_{ji} {M}_{jk} ) {x}_{i} {x}_{{i}^{′}} \\ = p {\sum }_{i} {x}_{i}^{2} + {p}^{2} {\sum }_{i \neq {i}^{′}} {x}_{i} {x}_{{i}^{′}} = p {‖ x ‖}^{2} + {p}^{2} ( {( 1 \cdot x )}^{2} - {‖ x ‖}^{2} )\end{matrix}$$

Proof of Lemma 2. Applying Chebyshev's bound, for any t>0,

$$Pr ( \vert {‖ Y ‖}^{2} - 𝔼 {‖ Y ‖}^{2} \vert \geq t ) \leq \frac{var ( {‖ Y ‖}^{2} )}{{t}^{2}} = \frac{var ( {Y}_{1}^{2} + … + {Y}_{m}^{2} )}{{t}^{2}} = \frac{m \cdot var ( {Y}_{1}^{2} )}{{t}^{2}} .$$

Using t=ϵ [symbol] ∥Y∥²=ϵm [symbol] Y₁² then gives

$$Pr ( \vert {‖ Y ‖}^{2} - 𝔼 {‖ Y ‖}^{2} \vert \geq ϵ 𝔼 {‖ Y ‖}^{2} ) \leq \frac{1}{{ϵ}^{2} m} \cdot \frac{var ( {Y}_{1}^{2} )}{{( 𝔼 {Y}_{1}^{3} )}^{2}} .$$

It remains to bound the last ratio. [symbol] Y₁² is from Lemma 1. To compute var (Y₁², begin with [symbol] Y₁⁴:

$$\begin{matrix}{EY}_{1}^{4} = {𝔼 ( {M}_{11} {x}_{1} + ⋯ + {M}_{1 d} {x}_{d} )}^{4} \\ = {\sum }_{i} 𝔼 [ {M}_{1 i}^{4} {x}_{i}^{4} ] + 4 {\sum }_{i \neq j} 𝔼 [ {M}_{1 i} {x}_{i} {M}_{1 j}^{3} {x}_{j}^{3} ] + \\ 3 {\sum }_{i \neq j} 𝔼 [ {M}_{1 i}^{2} {x}_{i}^{2} {M}_{1 j}^{2} {x}_{j}^{2} ] + 6 {\sum }_{i \neq j \neq k} 𝔼 [ {M}_{1 i}^{2} {x}_{i}^{2} {M}_{1 j} {x}_{j} {M}_{1 k} {x}_{k} ] + \\ {\sum }_{i \neq j \neq k \neq 𝓁} 𝔼 [ {M}_{1 i} {x}_{i} {M}_{1 j} {x}_{j} {M}_{1 k} {x}_{k} {M}_{1 𝓁} {x}_{𝓁} ] \\ = p {\sum }_{i} {x}_{i}^{4} + 4 {p}^{2} {\sum }_{i \neq j} {x}_{i} {x}_{j}^{3} + 3 {p}^{2} {\sum }_{i \neq j} {x}_{i}^{2} {x}_{j}^{2} + 6 {p}^{3} {\sum }_{i \neq j \neq k} {x}_{i}^{2} {x}_{j} {x}_{k} + \\ {p}^{4} {\sum }_{i \neq j \neq k \neq 𝓁} {x}_{i} {x}_{j} {x}_{k} {x}_{𝓁} .\end{matrix}$$

This is maximized when all the xᵢ are positive, so

$$\begin{matrix}𝔼 {Y}_{1}^{4} \leq p {\sum }_{i} {x}_{i}^{4} + 4 {p}^{2} {\sum }_{i , j} {x}_{i} {x}_{j}^{3} + 3 {p}^{2} {\sum }_{i , j} {x}_{i}^{2} {x}_{j}^{2} + 6 {p}^{3} {\sum }_{i , j , k} {x}_{i}^{2} {x}_{j} {x}_{k} + \\ {p}^{4} {\sum }_{i , j , k , 𝓁} {x}_{i} {x}_{j} {x}_{k} {x}_{𝓁} \\ = p {‖ x ‖}_{4}^{4} + 4 {p}^{2} {\sum }_{i , j} {x}_{i} {x}_{j}^{3} + 3 {p}^{2} {‖ x ‖}^{4} + 6 {p}^{3} {‖ x ‖}^{2} {( 1 \cdot x )}^{2} + \\ {{p}^{4} ( 1 \cdot x )}^{4} \\ \leq p {‖ x ‖}_{4}^{4} + 4 {p}^{2} d {‖ x ‖}_{4}^{4} + 3 {p}^{2} {‖ x ‖}^{4} + 6 {p}^{3} {‖ x ‖}^{2} {( 1 \cdot x )}^{2} + {{p}^{4} ( 1 \cdot x )}^{4} \\ \leq p ( 1 + 4 c ) {‖ x ‖}_{4}^{4} + 3 {p}^{2} ( 1 + 2 c ) {‖ x ‖}^{4} + {{p}^{4} ( 1 \cdot x )}^{4} ,\end{matrix}$$

where the inequality 2ab≤a²+b² has been twice invoked to get

$$\begin{matrix}{\sum }_{i , j} {x}_{i} {x}_{j}^{3} = \frac{1}{2} {\sum }_{i , j} ( {x}_{i} {x}_{j}^{3} + {x}_{j} {x}_{i}^{3} ) \\ \frac{1}{2} {\sum }_{i , j} {x}_{i} {x}_{j} ( {x}_{i}^{2} + {x}_{j}^{2} ) \leq \frac{1}{2} {\sum }_{i , j} \frac{1}{2} {( {x}_{i}^{2} + {x}_{j}^{2} )}^{2} \leq \frac{1}{2} {\sum }_{i , j} ( {x}_{i}^{4} + {x}_{j}^{4} ) \\ = d {\sum }_{i} {x}_{i}^{4} .\end{matrix}$$

and the Cauchy-Schwarz has been used inequality to get (1·x)²≤d∥x∥². Continuing,

var(Y₁²)= [symbol] Y₁⁴−( [symbol] Y₁²)²≤5cp∥x∥₄⁴+9cp²∥x∥⁴.
Plugging this into

$$Pr ( \vert {‖ Y ‖}^{2} - 𝔼 {‖ Y ‖}^{2} \vert \geq ϵ 𝔼 {‖ Y ‖}^{2} ) \leq \frac{1}{{ϵ}^{2} m} \cdot \frac{var ( {Y}_{1}^{2} )}{{( 𝔼 {Y}_{1}^{3} )}^{2}}$$

then gives the bound.
Proof of Lemma 3. Suppose X₁, . . . , X_{d} are i.i.d. draws from an exponential distribution with parameter λ. It is well-known that for any positive integer k,

$$𝔼 {X}_{1}^{k} = \frac{k !}{{λ}^{k}} . \\ Thus \text{:}$$

$$𝔼 {‖ X ‖}_{2}^{2} = 𝔼 ( {X}_{1}^{2} + ⋯ + {X}_{d}^{2} ) = d 𝔼 {X}_{1}^{2} = \frac{2 d}{{λ}^{2}}$$

$$𝔼 {‖ X ‖}_{4}^{4} = 𝔼 ( {X}_{1}^{4} + ⋯ + {X}_{d}^{4} ) = d 𝔼 {X}_{1}^{4} = \frac{24 d}{{λ}^{4}}$$

Part (a) of the lemma follows immediately.

Pick any positive integer c. To show that ∥X∥_{c}^{c}=X₁^{c}+ . . . +X_{d}^{c} is concentrated around its expected value, Chebyshev's inequality was used. First, the variance of X₁^{c} is computed,

$$var ( {X}_{1}^{c} ) = 𝔼 {X}_{1}^{2 c} - {( 𝔼 {X}_{1}^{c} )}^{2} = \frac{( 2 c ) !}{{λ}^{2 c}} - {( \frac{c !}{{λ}^{c}} )}^{2} = \frac{( 2 c ) ! - {( c ! )}^{2}}{{λ}^{2 c}} ,$$

so that var(∥X∥_{c}^{c})=var(X₁^{c}+ . . . +X_{d}^{c})=d var(X₁^{c}) is exactly d times this. Thus, for any ϵ>0,

$$\begin{matrix}Pr ( \vert {‖ X ‖}_{c}^{c} - E {‖ X ‖}_{2}^{2} \vert \geq ϵ𝔼 {‖ X ‖}_{2}^{2} ) \leq \frac{var ( {‖ X ‖}_{c}^{c} )}{{{ϵ}^{2} ( 𝔼 {‖ ‖}_{c}^{c} )}^{2}} \\ = \frac{d var ( {X}_{1}^{c} )}{{{ϵ}^{2} ( d 𝔼 {X}_{1}^{c} )}^{2}} \\ = \frac{d ( ( 2 c ) ! - {( c ! )}^{2} )}{{λ}^{2 c}} \cdot \frac{{λ}^{2 c}}{{ϵ}^{2} {{d}^{2} ( c ! )}^{2}} \\ \leq \frac{{2}^{2 c}}{{ϵ}^{2} d}\end{matrix}$$

Part (b) of the lemma follows by choosing a value of ϵ that makes this expression ≤δ.

Varying the density of the binary random projection. The number of projection neurons (PNs) each Kenyon cell (KC) samples from was varied, and its effect on nearest-neighbors retrieval performance was evaluated (FIG. 34). In the fly, each KC samples from roughly 10% of the PNs (6 out of 50). In some examples, this value was set to 1% and to 50%. For some datasets, 1% sufficed, though this is likely more sensitive to noise. Across all datasets, the most consistent performance was obtained when sampling 10%, with no improvement in performance at 50%. Sampling 10%, thus, achieved the best trade-off between computational efficiency and performance
See Litwin-Kumar et al. (Litwin-Kumar et al., Neuron 93, pp. 1153-1164, 2017) for a perspective of how sampling affects associative learning.

Empirical analysis on the GIST dataset. The fly algorithm was examined in even higher dimensions (d=960, GIST image dataset (Jegou, et al. IEEE Transactions on Pattern Analysis and Machine Intelligence, vol. 33, no. 1, pp. 117-128, 2011), a similar trend in performance was observed (FIG. 35). Thus, although designed biologically for d=50, the fly algorithm is scalable.

Binary locality-sensitive hashing. The fly algorithm was used to implement binary locality-sensitive hashing (Wang et al., arXiv: 1408.2927 cs.DS, 2014), where the LSH function h: [symbol] ^{d}→ [symbol] ^{m}. In other words, instead of using the values of the top k Kenyon cells as the tag, their indices were used, setting those indices to 1 and the remaining to 0. For LSH, binary hashes are typically computed by: y=sgn(Mx), where M is a dense, i.i.d. Gaussian random matrix, and x is the input. If the (i, j)^{th} element of Mx is greater than 0, yᵢⱼ is set to 1, and 0 otherwise. In other words, each Kenyon cell is binarized to 0 or 1 based on whether its value is ≤0 or >0, respectively.

For binary hashing, the fly algorithm performed better than traditional binary LSH across all four datasets (FIG. 36).

Discussion. Algorithmically, random projections provide better theoretical guarantees and better bounds than use the inputting the data itself as the hash tag. Moreover, in LSH applications, it is often necessary to build multiple hash tables to boost recall. Some randomization is thus critical because it allows construction of multiple independent hash functions. Further, empirically, the fly's algorithm works best when the distribution of feature values for each input has a high-firing rate tail (e.g., a Gaussian or exponential). Kenyon cells that sample PNs at the tail of the distribution are least probable to fire at the same rate for a different input, and these KCs end up constituting the tag following the winner-take-all step. Thus, using these KCs as the tag serves as a strong discriminator between different inputs and a strong indicator for similarity if the inputs are similar. Interestingly, such a distribution is what the PNs in the brain produce: an exponential distribution of firing rates with a high-firing rate tail.

### EXAMPLE 38

### Example Implementation

METHODS: Considered are two types of binary hashing schemes that include hash functions, h₁ and h₂. The LSH function h₁ provides a distance-preserving embedding of items in d-dimensional input space to mk-dimensional binary hash space, where the values of m and k are algorithm specific and selected to make the space or time complexity of all algorithms comparable (Section 3.5). The function h₂ places each input item into a discrete bin for lookup. Formally:
Definition 1. A hash function h₁: [symbol] ^{d}→{0, 1}^{mk} is called locality sensitive if for any two input items p, q ∈ [symbol] ^{d}, Pr[h₁(p)=h₁(q)]=sim(p,q), where sim(p,q) ∈ [0, 1] is a similarity measure between p and q.
Definition 2. A hash function h₂: [symbol] ^{d}→[0, . . . , b] places each input item in to a discrete bin.

Two disadvantages of using h₁—be it low or high dimensional—for lookup are that some bins may be empty and that true nearest-neighbors may lie in a nearby bin. This has motivated multi-probe LSH (Q. Lv, et al., in Proc. of the Intl. Conf. on Very Large Data Bases, ser. VLDB '07, 2007, pp. 950-961) where, instead of probing only the bin the query falls in, nearby bins are searched, as well.

Described below are three existing methods for designing h₁ (SimHash, WTAHash, FlyHash) plus an additional method disclosed herein (Dense-Fly). Described thereafter are methods for providing low dimensional binning for h₂ to FlyHash and DenseFly. All algorithms described below are data-independent, meaning that the hash for an input is constructed without using any other input items. A hybrid fly hashing scheme is described that takes advantage of high-dimensionality to provide better ranking of candidates and low-dimensionality to quickly find candidate neighbors to rank.

SimHash: Charikar (M. S. Charikar, in Proc. of the Annual ACM Symposium on Theory of Computing, ser. STOC '02, 2002, pp. 380-388) proposed the following hashing scheme for generating a binary hash code for an input vector, x. First, mk (i.e., the hashing dimension) random projection vectors, r₁, r₂, . . . , rₘₖ, are generated, each of dimension d. Each element in each random projection vector is drawn uniformly from a Gaussian distribution, [symbol] (0, 1). Then, the i^{th} value of the binary hash is computed as:

$${{h}_{1} ( x )}_{i} = \{ \begin{matrix}1 & if {r}_{i} \cdot x \geq 0 \\ 0 & if {r}_{i} \cdot x < 0.\end{matrix}$$

This scheme preserves distances under the angular and Euclidean distance measures (M. Datar, et al. in Proc. of the 20th Annual ACM Symposium on Computational Geometry, ser. SCG '04, 2004, pp. 253-262).

WTAHash (Winner-take-all hash): Yagnik et al. (J. Yagnik, et al. in Proc. of the Intl. Conf. on Computer Vision, Washington, D.C., USA: IEEE Computer Society, 2011, pp. 2431-2438) proposed the following binary hashing scheme. First, m permutations, θ₁, θ₂, . . . , θₘ of the input vector are computed. For each permutation i, the first k components are considered, and the index of the component with the maximum value is found. Cᵢ is then a zero vector of length k with a single 1 at the index of the component with the maximum value. The concatenation of the m vectors h₁(x)=[C₁, C₂, . . . , Cₘ] corresponds to the hash of x. This hash code is sparse—there is exactly one 1 in each successive block of length k—and by setting mk>d, hashes can be generated that are of a dimension greater than the input dimension. k is referred to as the WTA factor.

WTAHash preserves distances under the rank correlation measure (J. Yagnik, et al. in Proc. of the Intl. Conf. on Computer Vision, Washington, D.C., USA: IEEE Computer Society, 2011, pp. 2431-2438). It also generalizes MinHash (A. Broder, in Proc. of the Compression and Complexity of Sequences, IEEE Computer Society, 1997, pp. 21; A. Shrivastava et al. in Proc. of the Intl. Conf. on Artificial Intelligence and Statistics, 2014, pp. 886-894), and was shown to outperform several data-dependent LSH algorithms, including PCAHash (B. Wang, et al. in IEEE Intl. Conf. on Multimedia and Expo, July 2006, pp. 353-356; X.-J. Wang, et al. in IEEE Computer Society Conf. on Computer Vision and Pattern Recognition, vol. 2,2006, pp. 1483-1490), spectral hash, and, by transitivity, restricted Boltzmann machines (Y. Weiss, et al. in Proc. Of the Intl. Conf. on Neural Information Processing, 2008, pp. 1753-1760).

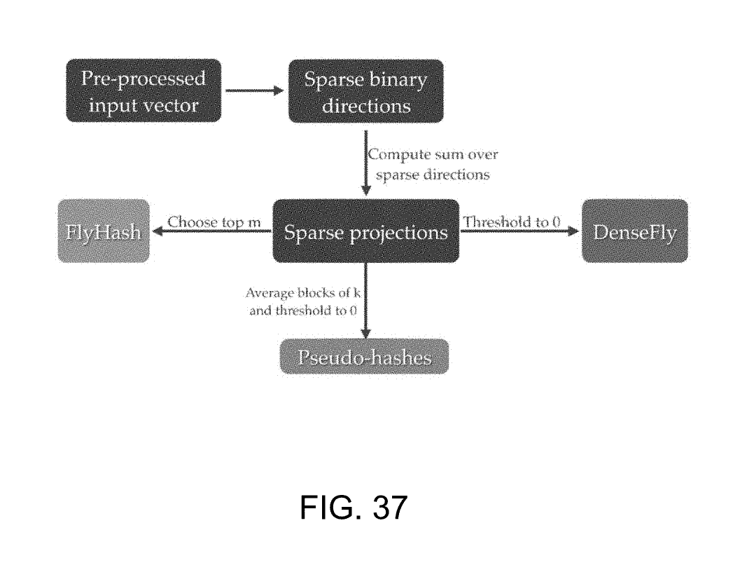

FlyHash and DenseFly: The two fly hashing schemes (Algorithm 1, FIG. 37) first project the input vector into an mk-dimensional hash space using a sparse, binary random matrix, proven to preserve locality (S. Dasgupta, et al. Science, vol. 358, no. 6364, pp. 793-796, (2017)). This random projection has a sampling rate of α, meaning that in each random projection, only [αd] input indices are considered (summed). In the fly circuit, α˜0.1 since each Kenyon cell samples from roughly 10% (6/50) of the projection neurons.

The first scheme, FlyHash (S. Dasgupta, et al. Science, vol. 358, no. 6364, pp. 793-796, (2017)), sparsifies and binarizes this representation by setting the indices of the top m elements to 1 and the remaining indices to 0. In the fly circuit, k=20, since the top firing 5% of Kenyon cells are retained, and the rest are silenced by the APL inhibitory neuron. Thus, a FlyHash hash is an mk-dimensional vector with exactly m ones, as in WTAHash. However, in contrast to WTAHash, where the WTA is applied locally onto each block of length k, for FlyHash, the sparsification happens globally considering all mk indices together. We later prove (Lemma 3) that this difference allows more pairwise orders to be encoded within the same hashing dimension.

For FlyHash, the number of unique Hamming distances between two hashes is limited by the hash length m. Greater separability can be achieved if the number of 1 s in the high dimensional hash is allowed to vary. The second scheme, DenseFly, sparsifies and binarizes the representation by setting all indices with values ≥0 to 1, and the remaining to 0 (akin to SimHash though in high dimensions). As shown below, this method provides even better separability than FlyHash in high dimensions.

Multi-probe hashing to find candidate nearest neighbors: In practice, the most similar item to a query may have a similar, but not exactly the same, mk-dimensional hash as the query. In such a case, it is important to also identify candidate items with a similar hash as the query. Dasgupta et al. (S. Dasgupta, et al. Science, vol. 358, no. 6364, pp. 793-796, (2017)) did not propose a multi-probe binning strategy, without which their FlyHash algorithm is unusable in practice.

SimHash. For low-dimensional hashes, SimHash efficiently probes nearby hash bins using a technique called multi-probe (Q. Lv, et al., in VLDB '07, Proceedings of the 33rd International Conference on Very Large Data Bases (ACM, 2007), pp. 950-961). All items with the same mk-dimensional hash are placed into the same bin; then, given an input x, the bin of h₁(x) is probed, as well as all bins within Hamming distance r from this bin. This approach leads to large reductions in search space during retrieval as only bins which differ from the query point by r bits are probed. Notably, even though multi-probe avoids a linear search over all points in the dataset, a linear search over the bins is unavoidable.

FlyHash and DenseFly. For high-dimensional hashes, multi-probe is even more essential because even if two input vectors are similar, it is unlikely that their high dimensional hashes will be exactly the same. For example, using the SIFT-1M dataset with a WTA factor k=20 and m=16, FlyHash produces about 860,000 unique hashes (about 86% the size of the dataset). In contrast, SimHash with mk=16 produces about 40,000 unique hashes (about 4% the size of the dataset). Multi-probing directly in the high-dimensional space using the SimHash scheme, however, is unlikely to reduce the search space without spending significant time probing many nearby bins.

One solution to this problem is to use low-dimensional hashes to reduce the search space and quickly find candidate neighbors and then to use high-dimensional hashes to rank these neighbors according to their similarity to the query. Disclosed herein is a simple algorithm for computing such low-dimensional hashes, called pseudo-hashes (Algorithm 1). To create an m-dimensional pseudo-hash of an mk-dimensional hash, each successive block j of length k is considered; if the sum (or equivalently, the average) of the activations of this block is >0, the j^{th} bit of the pseudo-hash is set to 1, and 0 otherwise. Binning, then, can be performed using the same procedure as SimHash.

Given a query, multi-probe is performed on its low dimensional pseudo-hash (h₂) to generate candidate nearest neighbors. Candidates are then ranked based on their Hamming distance to the query in high-dimensional hash space (h₁). Thus, this approach combines the advantages of low-dimensional probing and high-dimensional ranking of candidate nearest-neighbors.

Algorithm 1 FlyHash and DenseFly

```
Input: vector x ∈ [symbol]   ^{d}, hash length m, WTA factor k,
sampling rate α for the random projection.
# Generate mk sparse, binary ramdom projections by
# summing from └αd┘ random indices each.
S = {Sᵢ | Sᵢ = rand(└αd┘, d)}, where |S| = mk
# Compute high-dimensional hash, h₁.
for j = 1 to mk do
  α(x)ⱼ = Σ_{i∈S}, xᵢ  # Compute activations
end for
if FlyHash then
  h₁(x) = WTA(α(x)) ∈ {0, 1}^{mk}  # Winner-take-all
else if DenseFly then
  h₁(x) = sgn(α(x)) ∈ {0, 1}^{mk}  # Threshold at 0
end if
# Compute low-dimensional pseudo-hash (bin), h₂.
for j = 1 to m do
  p(x)ⱼ = sgn(Σᵤ₌ₖ₍ⱼ₋₁₎₊₁^{u=kj} α(x)ᵤ/k)
end for
h₂(x) = g(p(x)) ∈ [0, ..., b] # Place in bin
Note:
The function rand(a, b) returns a set of a random integers in [0, b]. The function g(·) is a conventional hash function used to place a pseudo-hash into a discrete bin.
```

WTAHash. Prior to the disclosure herein, no method has been previously described for performing multi-probe with WTAHash. Pseudo-hashing cannot be applied for WTAHash because there is a 1 in every block of length k; hence, all pseudo-hashes will be a 1-vector of length m.

Strategy for comparing algorithms: A strategy for fairly comparing two algorithms by equating either their computational cost or their hash dimensionality is described below.

Selecting hyperparameters. Hash lengths m ∈ [16, 128] are considered. All algorithms were compared using k=4, which was reported to be optimal by Yagnik et al. (J. Yagnik, et al., in 2011 International Conference on Computer Vision (IEEE Computer Society, 2011), pp. 2431-2438) for WTAHash, and k=20, which is used by the fly circuit (i.e., only the top 5% of Kenyon cells fire for an odor).

Comparing SimHash versus FlyHash. SimHash random projections are more expensive to compute than FlyHash random projections; this additional expense allows for computation of more random projections (i.e., higher dimensionality), while not increasing the computational cost of generating a hash. Specifically, for an input vector x of dimension d, SimHash computes the dot product of x with a dense Gaussian random matrix. Computing the value of each hash dimension requires 2 d operations: d multiplications plus d additions. FlyHash (effectively) computes the dot product of x with a sparse binary random matrix, with sampling rate α. Each dimension requires └αd┘ addition operations only (no multiplications are needed). Using α=0.1, as per the fly circuit, to equate the computational cost of both algorithms, the Fly is afforded k=20 additional hashing dimensions. Thus, for SimHash, mk=m (i.e., k=1), and, for FlyHash, mk=20m. The number of ones in the hash for each algorithm may be different. In experiments with k=4, α=0.1, meaning that both fly-based algorithms have ⅕^{th} the computational complexity as SimHash.

Comparing WTAHash versus FlyHash. Since WTAHash does not use random projections, it is difficult to equate the computational cost of generating hashes. Instead, to compare WTAHash and FlyHash, the hash dimensionality and the number of 1s in each hash was set as equal. Specifically, for WTAHash, m permutations of the input were computed, and the first k components of each permutation were considered. This produces a hash of dimension mk with exactly m ones. For FlyHash, mk random Projections were computed, and the indices of the top m dimensions were set to 1.

Comparing FlyHash versus DenseFly. DenseFly computes sparse binary random projections akin to FlyHash, but, unlike FlyHash, it does not apply a WTA mechanism, but rather uses the sign of the activations to assign a value to the bit, similar to SimHash. To fairly compare FlyHash and DenseFly, the hashing dimension (mk) was set to be the same to equate the computational complexity of generating hashes, though the number of ones may differ.

Comparing multi-probe hashing. SimHash uses low dimensional hashes to both build the hash index and to rank candidates (based on Hamming distances to the query hash) during retrieval. DenseFly uses pseudo-hashes of the same low dimensionality as SimHash to create the index; however, unlike SimHash, DenseFly uses the high-dimensional hashes to rank candidates. Thus, once the bins and indices are computed, the pseudo-hashes do not need to be stored. A pseudo-hash for a query is only used to determine which bin to look in to find candidate neighbors.

Evaluation datasets and metrics: Datasets. Each algorithm was evaluated on six datasets (Table 1). There are three datasets with a random subset of 10,000 inputs each (GLoVE, LabelMe, and MNIST) and two datasets with 1 million inputs each (SIFT-1M and GIST-1M). A dataset of 10,000 random inputs was also included, in which each input is a 128-dimensional vector drawn from a uniform random distribution, U (0; 1). This dataset was included because it has no structure and presents a worst-case empirical analysis. For all datasets, the only pre-processing step used is to center each input vector about the mean.

TABLE 1
Datasets used in the evaluation.

| Dataset | Size | Dimension | Reference |
|---|---|---|---|
| Random | 10,000 | 128 | — |
| GLoVE | 10,000 | 300 | Pennington et al. [33] |
| LabelMe | 10,000 | 512 | Russell et al. [34] |
| MNIST | 10,000 | 784 | Lecun et al. [35] |
| SIFT-1M | 1,000,000 | 128 | Jegou et al. [36] |
| GIST-1M | 1,000,000 | 960 | Jegou et al. [36] |

Accuracy in identifying nearest-neighbors. Following Yagnik et al. (J. Yagnik, et al., in 2011 International Conference on Computer Vision (IEEE Computer Society, 2011), pp. 2431-2438) and Weiss et al. (Y. Weiss, et al. in Proc. Of the Intl. Conf. on Neural Information Processing, 2008, pp. 1753-1760), each algorithm's ability to identify nearest neighbors was evaluated using two performance metrics: area under the precision-recall curve (AUPRC) and mean average precision (mAP). For all datasets, following Jin et al. (Z. Jin, et al., IEEE transactions on cybernetics, vol. 44, no. 8, pp. 1362-1371, (2014)). and given a query point, a ranked list of the top 2% of true nearest neighbors was computed (excluding the query) based on the Euclidean distance between vectors in input space. Each hashing algorithm similarly generates a ranked list of predicted nearest neighbors based on Hamming distance between hashes (h₁). The mAP and AUPRC were then computed for the two ranked lists. Means and standard deviations are calculated over 500 runs.

Time and space complexity. While mAP and AUPRC evaluate the quality of hashes, in practice, such gains may not be practically usable if constraints such as query time, indexing time, and memory usage are not met. Two approaches were used to evaluate the time and space complexity of each algorithm's multi-probe version (h₂). The goal of the first evaluation was to examine the mAP of SimHash and DenseFly under the same query time. For each algorithm, the query was hashed to a bin. Bins near the query bin are probed with an increasing search radius. For each radii, the mAP is calculated for the ranked candidates. As the search radius increases, more candidates are pooled and ranked, leading to larger query times and larger mAP scores.

The goal of the second evaluation is to roughly equate the performance (mAP and query time) of both algorithms and compare the time to build the index and the memory consumed by the index. To do this, it is noted that, to store the hashes, DenseFly requires k times more memory to store the high-dimensional hashes. Thus, SimHash was allowed to pool candidates from k independent hash tables while using only 1 hash table for DenseFly. While this ensures that both algorithms use roughly the same memory to store hashes, SimHash also requires: (a) k times the computational complexity of DenseFly to generate k hash tables, (b) roughly k times more time to index the input vectors to bins for each hash table, and (c) more memory for storing bins and indices. Following Lv et al. (Q. Lv, et al., in VLDB '07, Proceedings of the 33rd International Conference on Very Large Data Bases (ACM, 2007), pp. 950-961), mAP was evaluated at a fixed number of nearest neighbors (100). As before, each query is hashed to a bin. If the bin has 100 candidates, the process is stopped, and the candidates are ranked. Else, the search radius is continually increased by 1 until the bin includes at least 100 candidates to rank. All candidates are then ranked, and the mAP versus the true 100 nearest-neighbors is computed. Each algorithm uses the minimal radius required to identify 100 candidates (different search radii may be used by different algorithms).

RESULTS: First, a theoretical analysis of the DenseFly and FlyHash high-dimensional hashing algorithms is presented, proving that DenseFly generates hashes that are locality-sensitive according to Euclidean and cosine distances and that FlyHash preserves rank similarity for any [symbol] ₚ norm; that pseudo-hashes are effective for reducing the search space of candidate nearest-neighbors without increasing computational complexity is also proven. Second, how well each algorithm identifies nearest-neighbors using the hash function h₁ is evaluated based on its query time, computational complexity, memory consumption, and indexing time. Third, the multi-probe versions of SimHash, FlyHash, and DenseFly (h₂) are evaluated.

Theoretical analysis of high-dimensional hashing algorithms: Lemma 1. DenseFly generates hashes that are locality-sensitive. Proof: The proof demonstrates that DenseFly approximates a high-dimensional SimHash, but at k times lower computational cost. Thus, by transitivity, DenseFly preserves cosine and Euclidean distances, as shown for SimHash (M. Datar, et al. in Proc. of the 20th Annual ACM Symposium on Computational Geometry, 2004, pp. 253-262).

The set S (Algorithm 1), containing the indices that each Kenyon cell (KC) samples from, can be represented as a sparse binary matrix, M. In Algorithm 1, each column of M was fixed to contain exactly └αd┘ ones. However, maintaining exactly └αd┘ ones is not necessary for the hashing scheme, and, in fact, in the fly's olfactory circuit, the number of projection neurons sampled by each KC is approximately a binomial distribution with a mean of 6 (C. F. Stevens, Proc. Natl. Acad. Sci. U.S.A., vol. 112, no. 30, pp. 9460-9465 (2015); S. J. Caron, et al. Nature, vol. 497, no. 7447, pp. 113-117 (2013)). Suppose the projection directions in the fly's hashing schemes (FlyHash and DenseFly) are sampled from a binomial distribution; i.e., let M ∈ {0, 1}^{dmk} be a sparse binary matrix whose elements are sampled from dmk independent Bernoulli trials each with success probability α, so that the total number of successful trials follows B(dmk, α). Pseudohashes are calculated by averaging m blocks of k sparse projections. Thus, the expected activation of Kenyon cell j to input x is:

$$𝔼 [ {{a}_{DenseFly} ( x )}_{j} ] = 𝔼 [ {\sum }_{u = k ( j - 1 ) + 1}^{u = kj} {\sum }_{i} {M}_{ui} {x}_{i} / k ] .$$

Using the linearity of expectation,

$$𝔼 [ {{a}_{DenseFly} ( x )}_{j} ] = k 𝔼 [ {\sum }_{i} {M}_{ui} {x}_{i} ] / k ,$$

where u is any arbitrary index in [1, mk]. Thus, [symbol] [α_{DenseFly}(x)ⱼ]=αΣᵢxᵢ, as m→∞. The expected value of a DenseFly activation is given in Equation (2) with special condition that k=1.

Similarly, the projection directions in SimHash are sampled from a Gaussian distribution; i.e., let M^{D} ∈ | [symbol] |^{d×m} be a dense matrix whose elements are sampled from [symbol] (μ, σ). Using linearity of expectation, the expected value of the j^{th} SimHash projection to input x is:

$$𝔼 [ {{a}_{SimHash} ( x )}_{j} ] = 𝔼 [ {\sum }_{i} {M}_{ji}^{D} {x}_{i} ] = μ {\sum }_{i} {x}_{i} .$$

Thus, [symbol] [α_{DenseFly}(x)ⱼ]= [symbol] [α_{SimHash}(x)ⱼ] ∀ j ∈ [1, m], if μ=α.

In other words, sparse activations of DenseFly approximate the dense activations of SimHash as the hash dimension increases. Thus, a DenseFly hash approximates SimHash of dimension mk. In practice, this approximation works well even for small values of m since hashes depend only on the sign of the activations.

This result is supported by an empirical analysis showing that the AUPRC for DenseFly is similar to that of SimHash when using equal dimensions. DenseFly, however, takes k-times less computation. In other words, that the computational complexity of SimHash could be reduced k-fold while still achieving the same performance was proven. In a subsequent analysis, how FlyHash preserves a popular similarity measure for nearest-neighbors, referred to as rank similarity (J. Yagnik, et al., in 2011 International Conference on Computer Vision (IEEE Computer Society, 2011), pp. 2431-2438), and how FlyHash better separates items in high-dimensional space compared to WTAHash (which was designed for rank similarity) were investigated. Dasgupta et al. (S. Dasgupta, et al. Science, vol. 358, no. 6364, pp. 793-796, (2017)) did not analyze FlyHash for rank similarity, either theoretically nor empirically.

Lemma 2. FlyHash preserves rank similarity of inputs under any lₚ norm. Proof: As demonstrated below, small perturbations to an input vector does not affect its hash.

Consider an input vector x of dimensionality d whose hash of dimension mk is to be computed. The activation of the j^{th} component (Kenyon cell) in the hash is given by aⱼ=Σ_{i∈Sj}xᵢ, where Sⱼ is the set of dimensions of x that the j^{th} Kenyon cell samples from. Consider a perturbed version of the input, x′=x+δx, where ∥δx∥ₚ=ϵ. The activity of the j^{th} Kenyon cell to the perturbed vector x′ is given by:

$${a}_{j}^{′} = {\sum }_{i ∈ {S}_{j}} {x}_{i}^{′} = {a}_{j} + {\sum }_{i ∈ {S}_{j}} δ {x}_{i} .$$

By the method of Lagrange multipliers, |a′ⱼ−aⱼ|≤dαϵ/ [symbol] ∀j. Moreover, for any index u≠j, ∥a′ⱼ−a′ᵤ|−|aⱼ−aᵤ∥≤|(a′ⱼ−a′ᵤ)−(aⱼ−aᵤ)|≤2dαϵ/ [symbol] .
In particular, let j be the index of h₁(x) corresponding to the smallest activation in the ‘winner’ set of the hash (i.e., the smallest activation such that its bit in the hash is set to 1). Conversely, let u be the index of h₁(x) corresponding to the largest activation in the ‘loser’ set of the hash.
Let β=aⱼ−aᵤ>0. Then,

β−2dαϵ/ [symbol] ≤|a′ᵢ−a′ᵤ|≤β+2dαϵ/ [symbol] .
For ϵ<β [symbol] /2dα, it follows that (a′ⱼ−a′ᵤ) ∈ [β−2dαϵ/ [symbol] , β+2dαϵ/ [symbol] . Thus, a′ⱼ>a′ᵤ. Since j and u correspond to the lowest difference between the elements of the winner and loser sets, it follows that all other pairwise rank orders defined by FlyHash are also maintained. Thus, FlyHash preserves rank similarity between two vectors whose distance in input space is small. As ϵ increases, the partial order corresponding to the lowest difference in activations is violated first, leading to progressively higher Hamming distances between the corresponding hashes.

Lemma 3. FlyHash encodes m-times more pairwise orders than WTAHash for the same hash dimension. Proof: That WTAHash imposes a local constraint on the winner-take-all (exactly one 1 in each block of length k) is demonstrated, whereas FlyHash uses a global winner-take-all, which allows FlyHash to encode more pairwise orders.

The pairwise order function PO(X, Y) defined by Yagnik et al. (J. Yagnik, et al., in 2011 International Conference on Computer Vision (IEEE Computer Society, 2011), pp. 2431-2438) is considered, where (X, Y) are the WTA hashes of inputs (x, y). In simple terms, PO(X, Y) is the number of inequalities on which the two hashes X and Y agree.

To compute a hash, WTAHash concatenates pairwise orderings for m independent permutations of length k. Let i be the index of the 1 in a given permutation. Then, xᵢ≥xⱼ ∀ j ∈ [1, k]\{i}. Thus, a WTAHash denotes m(k−1) pairwise orderings. The WTA mechanism of FlyHash encodes pairwise orderings for the top m elements of the activations, α. Let W be the set of the top m elements of α as defined in Algorithm 1. Then, for any j ∈ W, aⱼ≥aᵢ ∀i ∈ [1, mk]\W. Thus, each j ∈ W denotes m(k−1) inequalities, and FlyHash encodes m²(k−1) pairwise orderings. Thus, the pairwise order function for FlyHash encodes m times more orders.

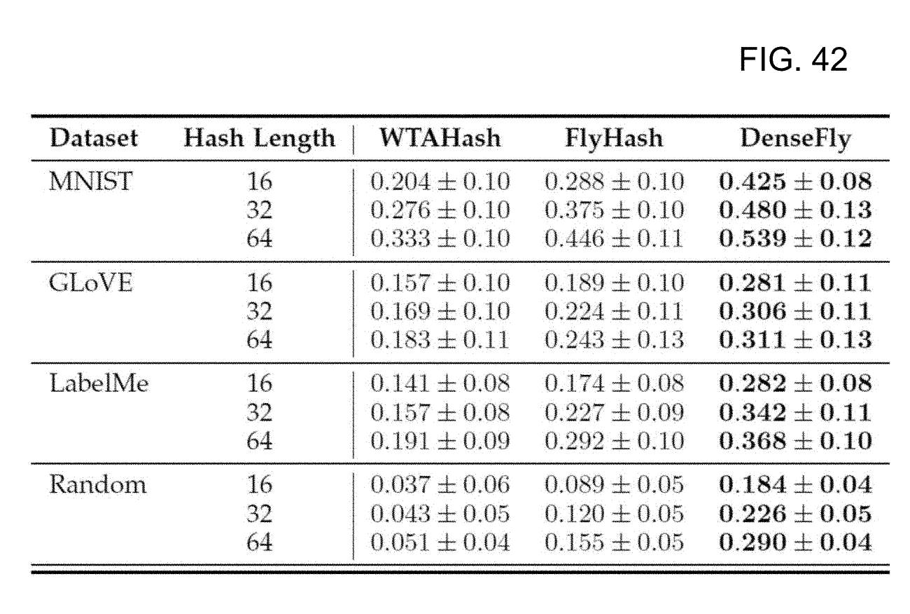

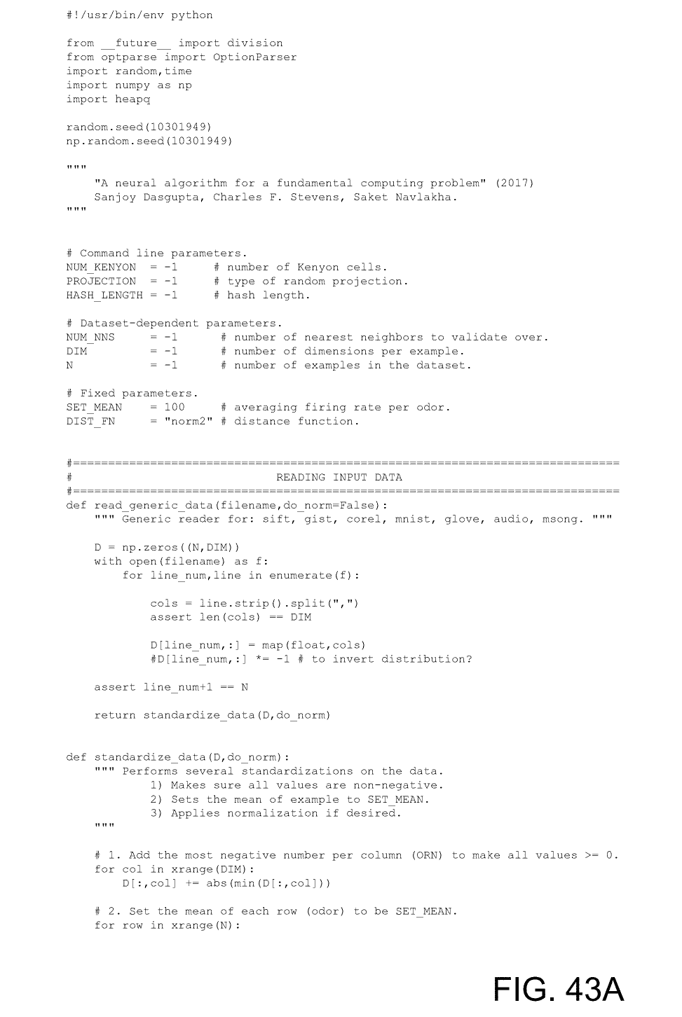

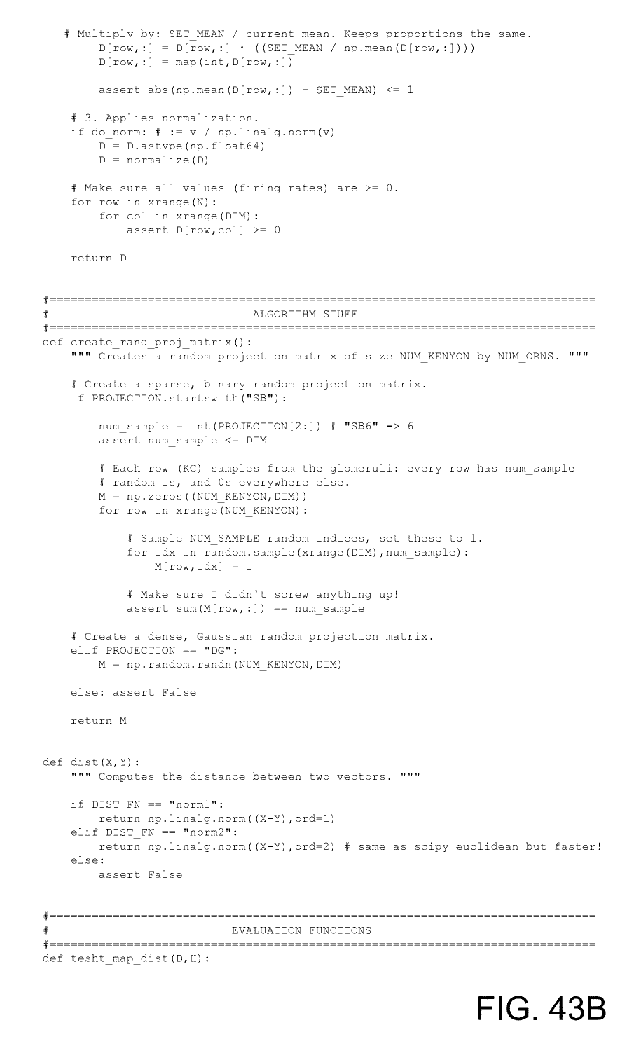

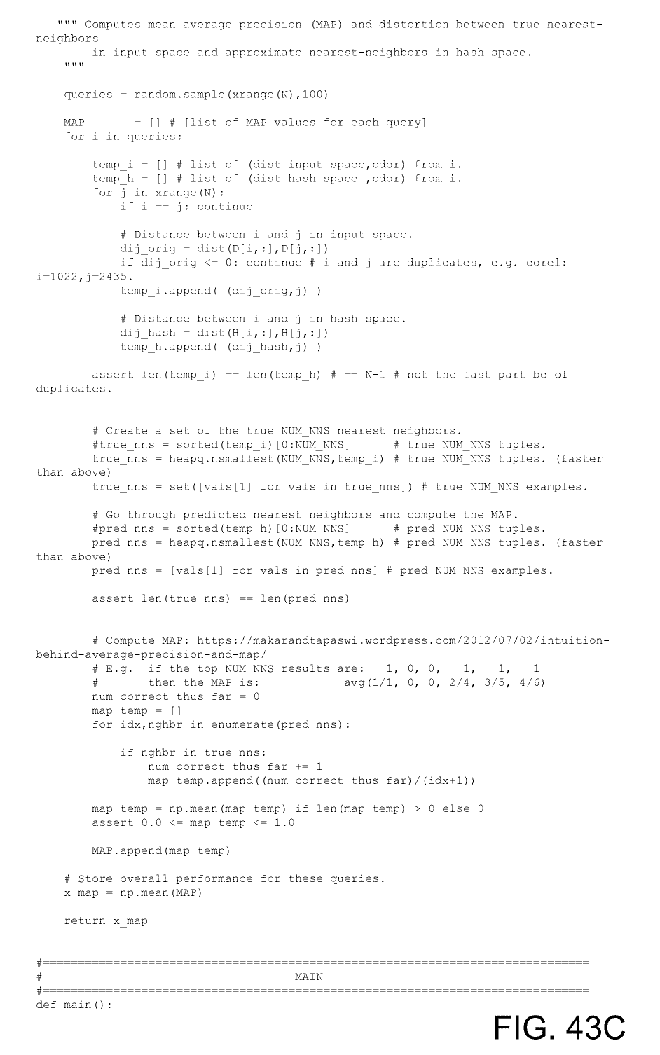

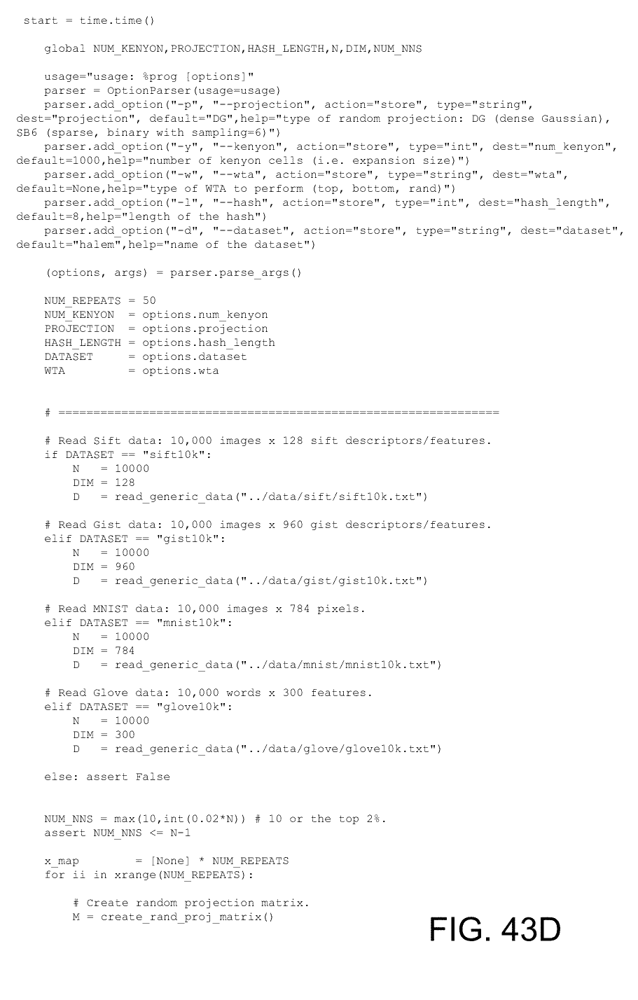

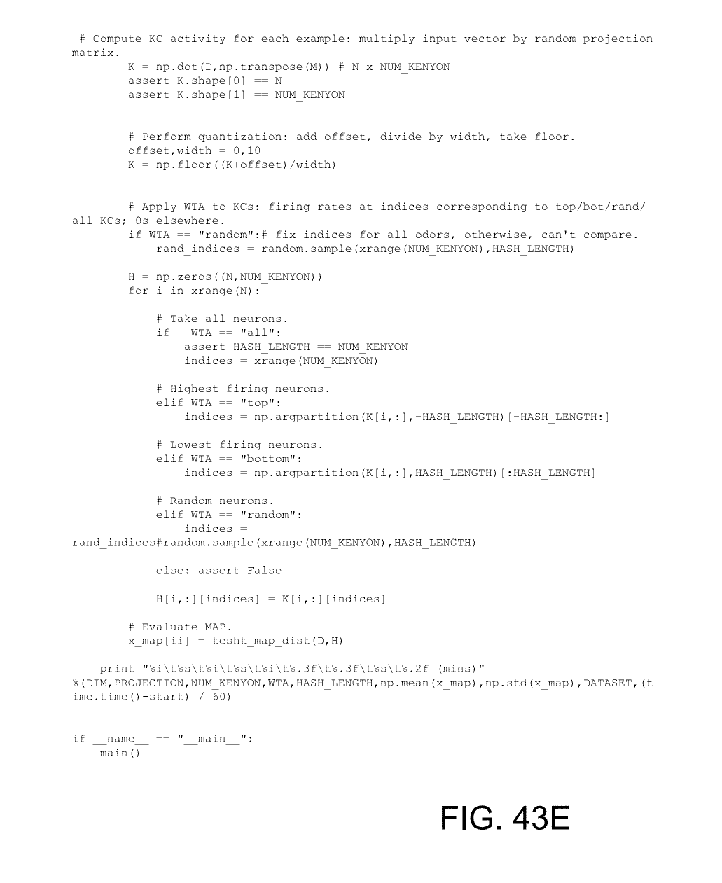

Empirically, FlyHash and DenseFly achieved a higher Kendall-τ rank correlation than WTAHash, which was specifically designed to preserve rank similarity (J. Yagnik, et al., in 2011 International Conference on Computer Vision (IEEE Computer Society, 2011), pp. 2431-2438) (Results, FIG. 42). This validates the theoretical results.

Lemma 4. Pseudo-hashes approximate SimHash with increasing WTA factor k. Proof: That expected activations of pseudohashes calculated from sparse projections is the same as the activations of SimHash calculated from dense projections is demonstrated.

The analysis of Equation (2) can be extended to show that pseudo-hashes approximate SimHash of the same dimensionality. Specifically,

$$𝔼 [ {{a}_{pseudo} ( x )}_{j} ] = α {\sum }_{i} {x}_{i} , as k \to ∞ .$$

Similarly, the projection directions in SimHash are sampled from a Gaussian distribution; i.e., let M^{D} ∈ [symbol] ^{d×m} be a dense matrix whose elements are sampled from [symbol] (μ, σ). Using linearity of expectation, the expected value of the j^{th} SimHash projection is:

$$𝔼 [ {{a}_{SimHash} ( x )}_{j} ] = 𝔼 [ {\sum }_{i} {M}_{ji}^{D} {x}_{i} ] = μ {\sum }_{i} {x}_{i} .$$

Thus, [symbol] [a_{pseudo}(x)ⱼ]= [symbol] [a_{SimHash}(x)ⱼ] ∀ j ∈ [1, m] if μ=α. Similarly, the variances of a_{SimHash}(x) and a_{pseudo}(x) are equal if σ²=α(1−α). Thus, SimHash can be interpreted as the pseudo-hash of a FlyHash with large dimensions.

Although in theory, this approximation holds for only large values of k, in practice, the approximation can operate under a high degree of error since equality of hashes requires only that the sign of the activations of pseudo-hash be the same as that of SimHash.

Empirically, performance of only using pseudo-hashes (not using the high-dimensional hashes) for ranking nearest-neighbors performs similarly with SimHash for values of k as low as k=4, confirming our theoretical results. Notably, the computation of pseudo-hashes is performed by re-using the activations for DenseFly, as explained in Algorithm 1 and FIG. 37. Thus, pseudo-hashes incur little computational cost and provide an effective tool for reducing the search space due to their low dimensionality.

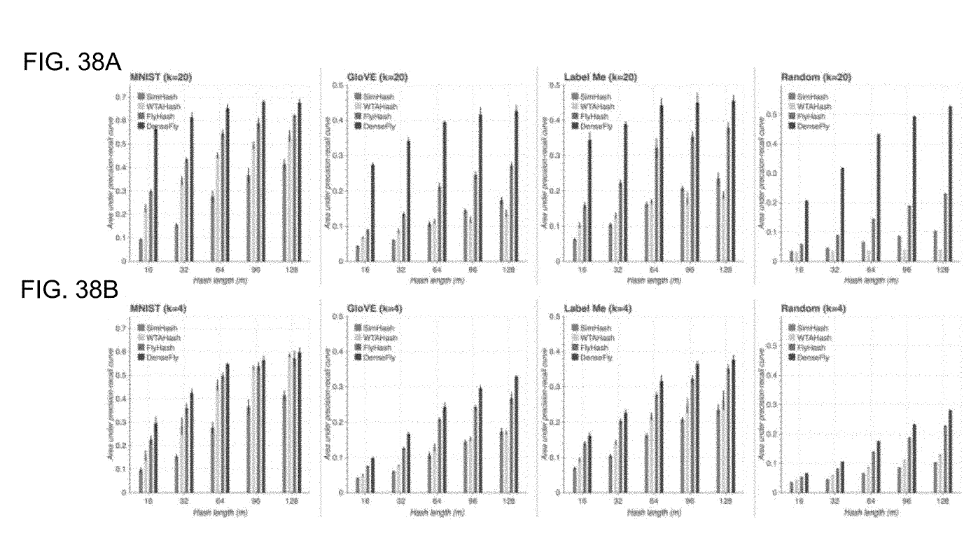

Empirical evaluation of low-versus high-dimensional hashing. The quality of the hashes (h₁) for identifying the nearest-neighbors of a query using the four 10 k-item datasets (FIG. 38A) was compared. For nearly all hash lengths, DenseFly outperformed all other methods in area under the precision recall curve (AUPRC). For example, using the GLoVE dataset with hash length m=64 and WTA factor k=20, the AUPRC of DenseFly was about three-fold higher than SimHash and WTAHash, and almost two-fold higher than FlyHash (DenseFly=0.395, FlyHash=0.212, SimHash=0.106, WTAHash=0.112). Using the Random dataset, which has no inherent structure, DenseFly provides a higher degree of separability in hash space compared to FlyHash and WTAHash, especially for large k (e.g., nearly 0.440 AUPRC for DenseFly versus 0.140 for FlyHash, 0.037 for WTAHash, and 0.066 for SimHash with k=20; m=64). FIG. 38B shows empirical performance for all methods using k=4, which shows similar results.

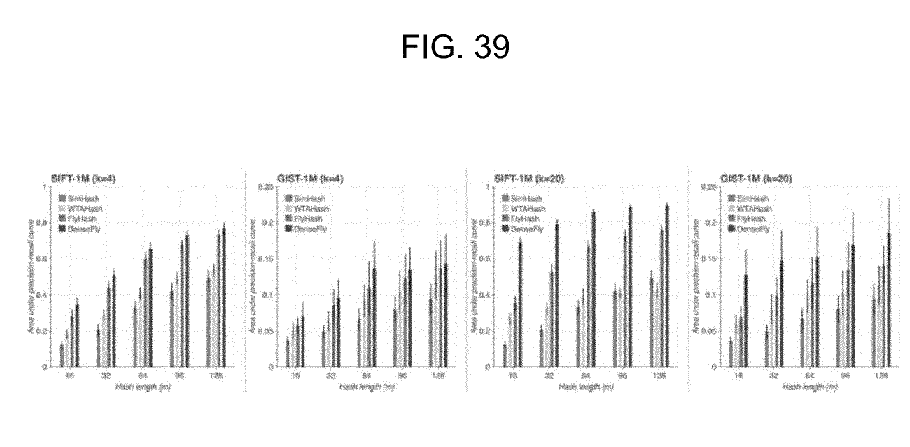

DenseFly also outperforms the other algorithms in identifying nearest neighbors on two larger datasets with 1M items each (FIG. 39). For example, using SIFT-1M with m=64 and k=20, DenseFly achieves a 2.6×, 2.2×, and 1.3× higher AUPRC compared with SimHash, WTAHash, and FlyHash, respectively. These results demonstrate the performance of high dimensional hashing on practical datasets.

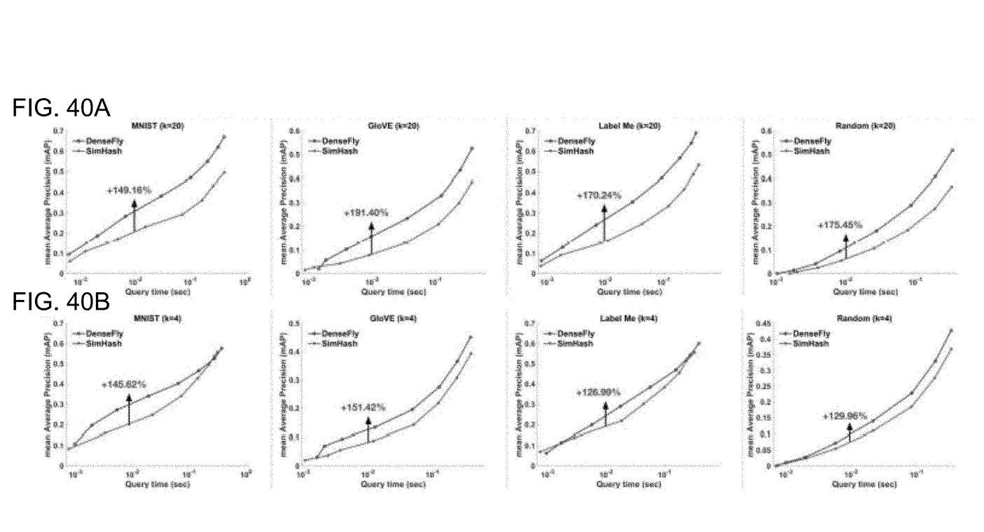

Evaluating multi-probe hashing. The multi-probing schemes of SimHash and DenseFly (pseudo-hashes) were evaluated. Using k=20, DenseFly achieves a higher mAP for the same query time (FIG. 40A). For example, using the GLoVE dataset with a query time of 0.01 seconds, the mAP of DenseFly was 91.40% higher than that of SimHash, with similar gains across other datasets. Thus, the high-dimensional DenseFly is better able to rank the candidates than low-dimensional SimHash. FIG. 40B shows that similar results hold for k=4; i.e., DenseFly achieves higher mAP for the same query time as SimHash.

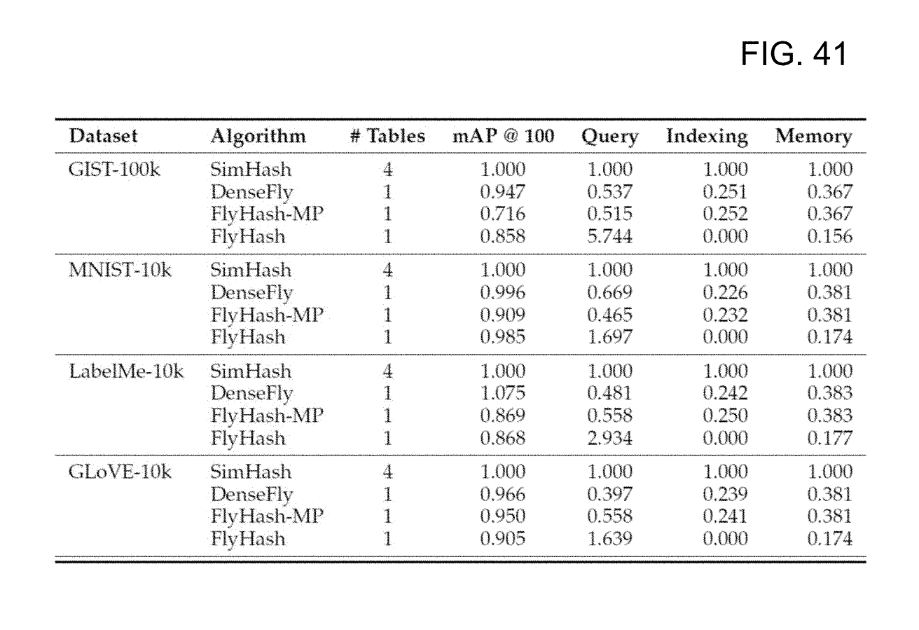

Next, the multi-probe schemes of SimHash, FlyHash (as originally conceived by Dasgupta et al. (S. Dasgupta, et al. Science, vol. 358, no. 6364, pp. 793-796, (2017)) without multi-probe), the FlyHash multi-probe version (referred to as FlyHash-MP) disclosed herein, and DenseFly were evaluated based on mAP as well as query time, indexing time, and memory usage. To boost the performance of SimHash, candidates were pooled and ranked over k independent hash tables as opposed to 1 table for DenseFly (Section 3.6). FIG. 41 shows that, for nearly the same mAP as SimHash, DenseFly significantly reduces query times, indexing times, and memory consumption. For example, using the Glove-10 k dataset, DenseFly achieves a marginally lower mAP compared to SimHash (0.966 vs. 1.000) but requires only a fraction of the querying time (0.397 vs. 1.000), indexing time (0.239 vs. 1.000), and memory (0.381 vs. 1.000). The multi-probe FlyHash algorithm disclosed herein is an improvement over the original FlyHash, but it still produces a lower mAP compared to DenseFly. Thus, DenseFly more efficiently identifies a small set of high-quality candidate nearest neighbors for a query compared to the other algorithms.

Empirical analysis of rank correlation for each method. Finally, DenseFly, FlyHash, and WTAHash were empirically compared based on how well they preserved rank similarity (J. Yagnik, et al., in 2011 International Conference on Computer Vision (IEEE Computer Society, 2011), pp. 2431-2438). For each query, the lₚ distances of the top 2% of true nearest neighbors were calculated. The Hamming distances between the query and the true nearest neighbors in hash space were also calculated. Next, the Kendell-τ rank correlation between these two lists of distances were calculated. Across all datasets and hash lengths tested, DenseFly outperformed both FlyHash and WTAHash (FIG. 42), confirming our theoretical results.

A new family of neural-inspired binary locality-sensitive hash functions that perform better than existing data-independent methods (SimHash, WTAHash, FlyHash) across several datasets and evaluation metrics were analyzed and evaluated. The key insight was to use efficient projections to generate high-dimensional hashes, which can be done without increasing computation or space complexity, as shown herein. Demonstrated herein, DenseFly is locality-sensitive under the Euclidean and cosine distances, and FlyHash preserves rank similarity for any lₚ norm. Also disclosed herein is a multi-probe version of the FlyHash algorithm that offers an efficient binning strategy for high-dimensional hashes, which is important for making this scheme usable in practical applications. This method also performs well with only 1 hash table; thus, this approach easier to deploy in practice. Overall, the results demonstrate that dimensionality expansion is helpful (A. N. Gorban et al. CoRR, vol. arXiv: 1801.03421, 2018; Y. Delalleau, et al. in Proc. of the 24th Intl. Conf. on Neural Information Processing Systems, 2011, pp. 666-674; D. Chen, et al. in Proc. of the IEEE Conference on Computer Vision and Pattern Recognition, 2013, pp. 3025-3032) especially for promoting separability for nearest-neighbors search.

### EXAMPLE 39

### Example Computing System

FIG. 16 illustrates a generalized example of a suitable computing system 1600 in which any of the described technologies may be implemented. The computing system 1600 is not intended to suggest any limitation as to scope of use or functionality, as the innovations may be implemented in diverse computing systems, including special-purpose computing systems. In practice, a computing system can comprise multiple networked instances of the illustrated computing system.

With reference to FIG. 16, the computing system 1600 includes one or more processing units 1610, 1615 and memory 1620, 1625. In FIG. 16, this basic configuration 1630 is included within a dashed line. The processing units 1610, 1615 execute computer-executable instructions. A processing unit can be a central processing unit (CPU), processor in an application-specific integrated circuit (ASIC), or any other type of processor. In a multi-processing system, multiple processing units execute computer-executable instructions to increase processing power. For example, FIG. 16 shows a central processing unit 1610 as well as a graphics processing unit or co-processing unit 1615. The tangible memory 1620, 1625 may be volatile memory (e.g., registers, cache, RAM), non-volatile memory (e.g., ROM, EEPROM, flash memory, etc.), or some combination of the two, accessible by the processing unit(s). The memory 1620, 1625 stores software 1680 implementing one or more innovations described herein, in the form of computer-executable instructions suitable for execution by the processing unit(s).

A computing system may have additional features. For example, the computing system 1600 includes storage 1640, one or more input devices 1650, one or more output devices 1660, and one or more communication connections 1670. An interconnection mechanism (not shown) such as a bus, controller, or network interconnects the components of the computing system 1600. Typically, operating system software (not shown) provides an operating environment for other software executing in the computing system 1600, and coordinates activities of the components of the computing system 1600.

The tangible storage 1640 may be removable or non-removable, and includes magnetic disks, magnetic tapes or cassettes, CD-ROMs, DVDs, or any other medium which can be used to store information in a non-transitory way and which can be accessed within the computing system 1600. The storage 1640 stores instructions for the software 1680 implementing one or more innovations described herein.

The input device(s) 1650 may be a touch input device such as a keyboard, mouse, pen, or trackball, a voice input device, a scanning device, or another device that provides input to the computing system 1600. For video encoding, the input device(s) 1650 may be a camera, video card, TV tuner card, or similar device that accepts video input in analog or digital form, or a CD-ROM or CD-RW that reads video samples into the computing system 1600. The output device(s) 1660 may be a display, printer, speaker, CD-writer, or another device that provides output from the computing system 1600.

The communication connection(s) 1670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 40

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

### EXAMPLE 41

### Computer-Executable Implementations

Any of the methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

Such acts of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

In any of the technologies described herein, the illustrated actions can be described from alternative perspectives while still implementing the technologies. For example, “receiving” can also be described as “sending” for a different perspective.

### EXAMPLE 42

### Further Description

Any of the following embodiments can be implemented.

Clause 1. A computer-implemented method of generating a hash, the method comprising:

for a query item, generating a query item hash via a hash model, wherein generating the query item hash comprises expanding dimensionality of a query item feature vector representing the query item and sparsifying the hash after expanding dimensionality.

Clause 2. A computer-implemented method of performing a similarly search, the method comprising:

receiving a d-dimensional query item feature vector representing a query item;

generating a k-dimensional hash from the query item feature vector, wherein the generating comprises applying a random matrix to the query item feature vector; and k is greater than d, whereby dimensionality of the query item feature vector is increased in the hash;

reducing a length of the hash, resulting in a sparsified k-dimensional hash;

matching the sparsified k-dimensional hash against hashes in a sample item database of sparsified k-dimensional hashes representing respective sample items for which a hash has been previously generated with the random matrix, wherein the matching identifies one or more matching hashes in the database; and

outputting the one or more matching hashes as a result of the similarity search.

Clause 3. A similarity search system comprising:

one or more processors,

memory coupled to the one or more processors, wherein the memory comprises computer-executable instructions causing the one or more processors to perform a process comprising:

receiving one or more samples and/or query items;

extracting feature vectors from the samples and/or query items to generate feature vectors;

compiling feature vectors into a sample feature vector database;

receiving a query;

extracting a feature vector from the query to produce a query feature vector;

providing the sample feature vector database and query feature vector to a hasher; and

performing hashing to generate a hash of the sample feature vectors and query feature vector, wherein the hashing comprises: receiving the sample feature vector database and query feature vector; expanding dimensionality of the sample feature vectors and query feature vector; quantizing the hash; and sparsifying the hash.

Clause 4. A similarity search system comprising:

one or more processors; and

memory coupled to the one or more processors, wherein the memory comprises computer-executable instructions causing the one or more processors to perform a process comprising: for a query item, generating a query item hash via a hash model, wherein generating the query item hash comprises expanding dimensionality of a query item feature vector representing the query item and sparsifying the hash after expanding dimensionality; matching the query item hash against hashes in a sample item hash database, wherein the hashes in the sample item hash database are previously generated via the hash model for respective sample items and represent the respective sample items, and wherein the matching identifies one or more matching hashes in the database; and outputting the one or more matching hashes as a result of the similarity search.

Clause 5. The system of Clause 4, wherein the sparsifying the hash comprises:

applying a winner-take-all technique to choose one or more winning values of the hash; and

eliminating values from the hash that are not chosen as winning values.

Clause 6. The system of Clause 4, wherein:

the matching comprises finding a matching hash in the sample item hash database, wherein the matching hash is associated with a bin identifier; and

the method further comprises outputting the bin identifier.

Clause 7. The system of Clause 4, wherein the matching comprises:

receiving the query item hash and the sample item hash database; and

finding one or more nearest neighbors in the sample item hash database to the query item hash.

Clause 8. The system of Clause 4, further comprising:

before generating the query item hash, normalizing the query item feature vector.

Clause 9. The system of Clause 4, wherein normalizing the query item feature vector comprises:

setting the same mean for the query item as the hashes in the sample item hash database; or

converting feature vector values of the query item feature vector to positive numbers.

Clause 10. A similarity search system comprising:

a database of hashes generated by via a hash model on sample items, wherein the hash model expands dimensionality and subsequently sparsifies the hash;

a hash generator configured to generate a query item hash via the hash model on a query item; and

a match engine configured to find one or more matching hashes in the database that match the query item hash and output the one or more matching hashes as a result of the similarity search.

Clause 11. A computer-implemented method of generating an image hash, the method comprising:

for a query image, generating a query image hash via a hash model, wherein generating the query image hash comprises expanding dimensionality of a query image feature vector representing the query image and sparsifying the hash after expanding dimensionality.

Clause 12. A computer-implemented method of performing an image similarly search, the method comprising:

receiving a d-dimensional query image feature vector representing a query image;

generating a k-dimensional hash from the query image feature vector, wherein the generating comprises applying a random matrix to the query image feature vector; and k is greater than d, whereby dimensionality of the query image feature vector is increased in the hash;

reducing a length of the hash, resulting in a sparsified k-dimensional hash;

matching the sparsified k-dimensional hash against hashes in a sample image database of sparsified k-dimensional hashes representing respective sample images for which a hash has been previously generated with the random matrix, wherein the matching identifies one or more matching hashes in the database; and

outputting the one or more matching hashes as a result of the similarity search.

Clause 13. An image similarity search system comprising:

one or more processors,

memory coupled to the one or more processors, wherein the memory comprises computer-executable instructions causing the one or more processors to perform a process comprising:

receiving one or more sample images and/or query images;

extracting feature vectors from the samples and/or query images to generate feature vectors;

compiling feature vectors into a sample feature vector database;

receiving a query;

extracting a feature vector from the query to produce a query feature vector;

providing the sample feature vector database and query feature vector to a hasher; and

performing hashing to generate a hash of the sample feature vectors and query feature vector, wherein the hashing comprises: receiving the sample feature vector database and query feature vector; expanding dimensionality of the sample feature vectors and query feature vector; quantizing the hash; and sparsifying the hash.

Clause 14. An image similarity search system comprising:

one or more processors; and

memory coupled to the one or more processors, wherein the memory comprises computer-executable instructions causing the one or more processors to perform a process comprising: for a query image, generating a query image hash via a hash model, wherein generating the query image hash comprises expanding dimensionality of a query image feature vector representing the query image and sparsifying the hash after expanding dimensionality; matching the query image hash against hashes in a sample image hash database, wherein the hashes in the sample image hash database are previously generated via the hash model for respective sample images and represent the respective sample images, and wherein the matching identifies one or more matching hashes in the database; and outputting the one or more matching hashes as a result of the image similarity search.

Clause 15. The system of Clause 14, wherein the expanding dimensionality comprises applying a matrix that is sparse or binary to the feature vector.

Clause 16. The system of Clause 14, wherein the expanding dimensionality comprises multiplying the query image feature vector by a random projection matrix.

Clause 17. The system of Clause 14, wherein the random projection matrix is sparse and binary.

Clause 18. The method of Clause 14, wherein the hash model implements locality-sensitive hashing.

Clause 19. The system of Clause 14, further comprising:

quantizing the hash before sparsifying the hash.

Clause 20. The system of Clause 14, wherein the sparsifying the hash comprises:

applying a winner-take-all technique to choose one or more winning values of the hash; and

eliminating values from the hash that are not chosen as winning values.

Clause 21. The system of Clause 14, wherein:

the matching comprises finding a matching hash in the sample image hash database, wherein the matching hash is associated with a bin identifier; and

the method further comprises outputting the bin identifier.

Clause 22. The system of Clause 14, wherein the matching comprises:

receiving the query image hash and the sample image hash database; and

finding one or more nearest neighbors in the sample image hash database to the query image hash.

Clause 23. The system of Clause 14, further comprising:

before generating the query image hash, normalizing the query image feature vector.

Clause 24. The system of Clause 14, wherein normalizing the query image feature vector comprises:

setting the same mean for the query image as the hashes in the sample image hash database; or

converting feature vector values of the query image feature vector to positive numbers.

Clause 25. An image similarity search system comprising:

a database of hashes generated by via a hash model on sample images, wherein the hash model expands dimensionality and subsequently sparsifies the hash;

a hash generator configured to generate a query image hash via the hash model on a query image; and

a match engine configured to find one or more matching hashes in the database that match the query image hash and output the one or more matching hashes as a result of the similarity search.

Clause 26. A computer-implemented method of performing an image similarly search, the method comprising:

for a query image, generating a query image hash via a hash model, wherein generating the query image hash comprises expanding dimensionality of a query image feature vector representing the query image and sparsifying the hash after expanding dimensionality;

matching the query image hash against hashes in a sample image hash database, wherein the hashes in the sample image hash database are previously generated via the hash model for respective sample images and represent the respective sample images, and wherein the matching identifies one or more matching hashes in the database; and

outputting the one or more matching hashes as a result of the similarity search.

Clause 27. The method of Clause 26, wherein the hash comprises a K-dimensional vector.

Clause 28. The method of Clause 26, wherein the expanding dimensionality comprises applying a matrix that is sparse or binary to the feature vector.

Clause 29. The method of Clause 26, wherein the matrix is random.

Clause 30. The method of Clause 26, wherein the expanding dimensionality comprises multiplying the query image feature vector by a random projection matrix.

Clause 31. The method of Clause 26, wherein the random projection matrix is sparse or binary.

Clause 32. The method of Clause 26, wherein the hash model implements locality-sensitive hashing.

Clause 33. The method of Clause 26, further comprising:

quantizing the hash before sparsifying the hash.

Clause 34. The method of Clause 26, wherein the sparsifying the hash comprises:

applying a winner-take-all technique to choose one or more winning values of the hash; and

eliminating values from the hash that are not chosen as winning values.

Clause 35. The method of Clause 26, wherein the matching comprises:

receiving the query image hash and the sample image hash database; and

finding one or more nearest neighbors in the sample image hash database to the query image hash.

Clause 36. The method of Clause 26, wherein:

the matching comprises finding a matching hash in the sample image hash database, wherein the matching hash is associated with a bin identifier; and

the method further comprises outputting the bin identifier.

Clause 37. The method of Clause 26, further comprising:

before generating the query image hash, normalizing the query image feature vector.

Clause 38. The method of Clause 26, wherein normalizing the query image feature vector comprises:

setting the same mean for the query image as the hashes in the sample image hash database; or

converting feature vector values of the query image feature vector to positive numbers.

Clause 39. A computer-implemented method of generating an semantic hash, the method comprising:

for a query document, generating a query semantic hash via a hash model, wherein generating the query semantic hash comprises expanding dimensionality of a query document feature vector representing the query document and sparsifying the hash after expanding dimensionality.

Clause 40. A computer-implemented method of performing an semantic similarly search, the method comprising:

receiving a d-dimensional query document feature vector representing a query document;

generating a k-dimensional hash from the query document feature vector, wherein the generating comprises applying a random matrix to the query document feature vector; and k is greater than d, whereby dimensionality of the query document feature vector is increased in the hash;

reducing a length of the hash, resulting in a sparsified k-dimensional hash;

matching the sparsified k-dimensional hash against hashes in a sample document database of sparsified k-dimensional hashes representing respective sample documents for which a hash has been previously generated with the random matrix, wherein the matching identifies one or more matching hashes in the database; and

outputting the one or more matching hashes as a result of the semantic similarity search.

Clause 41. A semantic similarity search system comprising:

one or more processors,

memory coupled to the one or more processors, wherein the memory comprises computer-executable instructions causing the one or more processors to perform a process comprising:

receiving one or more sample documents and/or query documents;

extracting feature vectors from the samples and/or query documents to generate feature vectors;

compiling feature vectors into a sample feature vector database;

receiving a query;

extracting a feature vector from the query to produce a query feature vector;

providing the sample feature vector database and query feature vector to a hasher; and

performing hashing to generate a hash of the sample feature vectors and query feature vector, wherein the hashing comprises: receiving the sample feature vector database and query feature vector; expanding dimensionality of the sample feature vectors and query feature vector; quantizing the hash; and sparsifying the hash.

Clause 42. A semantic similarity search system comprising:

one or more processors; and

memory coupled to the one or more processors, wherein the memory comprises computer-executable instructions causing the one or more processors to perform a process comprising: for a query document, generating a query semantic hash via a hash model, wherein generating the query semantic hash comprises expanding dimensionality of a query document feature vector representing the query document and sparsifying the hash after expanding dimensionality; matching the query semantic hash against hashes in a sample semantic hash database, wherein the hashes in the sample semantic hash database are previously generated via the hash model for respective sample documents and represent the respective sample documents, and wherein the matching identifies one or more matching hashes in the database; and outputting the one or more matching hashes as a result of the semantic similarity search.

Clause 43. The system of Clause 42, wherein the expanding dimensionality comprises applying a matrix that is sparse or binary to the feature vector.

Clause 44. The system of Clause 42, wherein the expanding dimensionality comprises multiplying the query document feature vector by a random projection matrix.

Clause 45. The system of Clause 42, wherein the random projection matrix is sparse and binary.

Clause 46. The method of Clause 42, wherein the hash model implements locality-sensitive hashing.

Clause 47. The system of Clause 42, further comprising:

quantizing the hash before sparsifying the hash.

Clause 48. The system of Clause 42, wherein the sparsifying the hash comprises:

applying a winner-take-all technique to choose one or more winning values of the hash; and

eliminating values from the hash that are not chosen as winning values.

Clause 49. The system of Clause 42, wherein:

the matching comprises finding a matching hash in the sample semantic hash database, wherein the matching hash is associated with a bin identifier; and

the method further comprises outputting the bin identifier.

Clause 50. The system of Clause 42, wherein the matching comprises:

receiving the query semantic hash and the sample semantic hash database; and

finding one or more nearest neighbors in the sample semantic hash database to the query semantic hash.

Clause 51. The system of Clause 42, further comprising:

before generating the query semantic hash, normalizing the query document feature vector.

Clause 52. The system of Clause 42, wherein normalizing the query document feature vector comprises:

setting the same mean for the query document as the hashes in the sample semantic hash database; or

converting feature vector values of the query document feature vector to positive numbers.

Clause 53. A semantic similarity search system comprising:

a database of hashes generated by via a hash model on sample documents, wherein the hash model expands dimensionality and subsequently sparsifies the hash;

a hash generator configured to generate a query semantic hash via the hash model on a query document; and

a match engine configured to find one or more matching hashes in the database that match the query semantic hash and output the one or more matching hashes as a result of the similarity search.

Clause 54. A computer-implemented method of performing a semantic similarly search, the method comprising:

for a query document, generating a query semantic hash via a hash model, wherein generating the query semantic hash comprises expanding dimensionality of a query document feature vector representing the query document and sparsifying the hash after expanding dimensionality;

matching the query semantic hash against hashes in a sample semantic hash database, wherein the hashes in the sample semantic hash database are previously generated via the hash model for respective sample documents and represent the respective sample documents, and wherein the matching identifies one or more matching hashes in the database; and

outputting the one or more matching hashes as a result of the similarity search.

Clause 55. The method of Clause 54, wherein the hash comprises a K-dimensional vector.

Clause 56. The method of Clause 54, wherein the expanding dimensionality comprises applying a matrix that is sparse or binary to the feature vector.

Clause 57. The method of Clause 54, wherein the matrix is random.

Clause 58. The method of Clause 54, wherein the expanding dimensionality comprises multiplying the query document feature vector by a random projection matrix.

Clause 59. The method of Clause 54, wherein the random projection matrix is sparse or binary.

Clause 60. The method of Clause 54, wherein the hash model implements locality-sensitive hashing.

Clause 61. The method of Clause 54, further comprising:

quantizing the hash before sparsifying the hash.

Clause 62. The method of Clause 54, wherein the sparsifying the hash comprises:

applying a winner-take-all technique to choose one or more winning values of the hash; and

eliminating values from the hash that are not chosen as winning values.

Clause 63. The method of Clause 54, wherein the matching comprises:

receiving the query semantic hash and the sample semantic hash database; and

finding one or more nearest neighbors in the sample semantic hash database to the query semantic hash.

Clause 64. The method of Clause 54, wherein:

the matching comprises finding a matching hash in the sample semantic hash database, wherein the matching hash is associated with a bin identifier; and

the method further comprises outputting the bin identifier.

Clause 65. The method of Clause 54, further comprising:

before generating the query semantic hash, normalizing the query document feature vector.

Clause 66. The method of Clause 54, wherein normalizing the query document feature vector comprises:

setting the same mean for the query document as the hashes in the sample semantic hash database; or

converting feature vector values of the query document feature vector to positive numbers.

Clause 67. One or more computer-readable media having encoded thereon computer-executable instructions that, when executed, cause a computing system to perform a semantic similarity search method comprising:

receiving one or more sample documents;

extracting feature vectors from the sample documents, the extracting generating sample document feature vectors;

normalizing the sample document feature vectors;

with a hash model, generating sample semantic hashes from the normalized sample document feature vectors, wherein the hash model expands dimensionality of the normalized sample document feature vectors and subsequently sparsifies the sample semantic hashes after expanding dimensionality;

storing the hashes generated from the normalized sample document feature vectors into a sample semantic hash database;

receiving a query document;

extracting a feature vector from the query document, the extracting generating a query document feature vector;

normalizing the query document feature vector;

with the hash model, generating a query semantic hash from the normalized query document feature vector, wherein the hash model expands dimensionality of the normalized query document feature vector and subsequently sparsifies the query semantic hash after expanding dimensionality;

matching the query semantic hash against hashes in the sample semantic hash database; and

outputting matching sample semantic hashes of the sample semantic hash database as a result of the semantic similarity search.

Clause 68. A computer-implemented method of performing a similarly search, the method comprising:

for a query item, generating a query item hash via a hash model, wherein generating the query item hash comprises expanding dimensionality of a query item feature vector representing the query item and sparsifying the hash after expanding dimensionality;

matching the query item hash against hashes in a sample item hash database, wherein the hashes in the sample item hash database are previously generated via the hash model for respective sample items and represent the respective sample items, and wherein the matching identifies one or more matching hashes in the database; and

outputting the one or more matching hashes as a result of the similarity search.

Clause 69. The method of clause 68, wherein the hash comprises a K-dimensional vector.

Clause 70. The method of clause 68, wherein the expanding dimensionality comprises applying a matrix that is sparse or binary to the feature vector.

Clause 71. The method of clause 70, wherein the matrix is random.

Clause 72. The method of clause 68, wherein the expanding dimensionality comprises multiplying the query item feature vector by a random projection matrix.

Clause 73. The method of clause 72, wherein the random projection matrix is sparse or binary.

Clause 74. The method of clause 68, wherein the hash model implements locality-sensitive hashing.

Clause 75. The method of clause 68, further comprising quantizing the hash before sparsifying the hash.

Clause 76. The method of clause 68, wherein the sparsifying the hash comprises:

applying a winner-take-all technique or a value threshold to choose one or more winning values of the hash; and

eliminating values from the hash that are not chosen as winning values.

Clause 77. The method of clause 68, further comprising:

for the query item hash, generating a pseudo-hash via a pseudo-hash model, wherein generating the pseudo-hash comprises reducing the dimensionality of the query item hash after sparsifying the hash; and

matching the pseudo-hash of the query item hash against pseudo-hashes in a sample item pseudo-hash database, wherein the pseudo-hashes in the sample item pseudo-hash database are previously generated via the pseudo-hash model for respective sample item hashes and represent the respective sample item hashes, and wherein the matching identifies one or more matching pseudo-hashes in the database; and

outputting the sample item hashes of the one or more matching sample item pseudo-hashes in the sample item hash database.

Clause 78. The method of clause 77, wherein reducing the dimensionality of the query item comprises applying a sum or average function.

Clause 79. The method of clause 68, wherein the matching comprises:

receiving the query item hash and the sample item hash database; and

finding one or more nearest neighbors in the sample item hash database to the query item hash.

Clause 80. The method of clause 68, wherein:

the matching comprises finding a matching hash in the sample item hash database, wherein the matching hash is associated with a bin identifier; and

the method further comprises outputting the bin identifier.

Clause 81. The method of clause 68, further comprising:

before generating the query item hash, normalizing the query item feature vector.

Clause 82. The method of clause 81, wherein normalizing the query item feature vector comprises:

setting the same mean for the query item as the hashes in the sample item hash database; or

converting feature vector values of the query item feature vector to positive numbers.

Clause 83. A similarity search system comprising:

one or more processors; and

memory coupled to the one or more processors, wherein the memory comprises computer-executable instructions causing the one or more processors to perform a process comprising:

for a query item, generating a query item hash via a hash model, wherein generating the query item hash comprises expanding dimensionality of a query item feature vector representing the query item and sparsifying the hash after expanding dimensionality;

matching the query item hash against hashes in a sample item hash database, wherein the hashes in the sample item hash database are previously generated via the hash model for respective sample items and represent the respective sample items, and wherein the matching identifies one or more matching hashes in the database; and

outputting the one or more matching hashes as a result of the similarity search.

Clause 84. The system of clause 83, wherein the expanding dimensionality comprises applying a matrix that is sparse or binary to the feature vector.

Clause 85. The system of clause 83, wherein the expanding dimensionality comprises multiplying the query item feature vector by a random projection matrix.

Clause 86. The system of clause 85, wherein the random projection matrix is sparse and binary.

Clause 87. The system of clause 83, wherein the hash model implements locality-sensitive hashing.

Clause 88. The system of clause 83, further comprising:

for the query item, generating a pseudo-hash via a pseudo-hash model, wherein generating the pseudo-hash comprises reducing the dimensionality of the query item hash after sparsifying the hash; and

matching the pseudo-hash of the query item hash against pseudo-hashes in a sample item pseudo-hash database, wherein the pseudo-hashes in the sample item pseudo-hash database are previously generated via the pseudo-hash model for respective sample item hashes and represent the respective sample item hashes, and wherein the matching identifies one or more matching pseudo-hashes in the database; and

outputting the one or more matching pseudo-hashes in the sample item hash database as candidate matches for the similarity search.

Clause 89. The system of clause 88, wherein reducing the dimensionality of the query item comprises applying a sum or average function.

Clause 90. The system of clause 83, further comprising:

quantizing the hash before sparsifying the hash.

### EXAMPLE 43

### Example Alternatives

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-implemented method of performing an image similarly search, the method comprising:
for a query image, generating a query image hash via a hash model, wherein generating the query image hash comprises expanding dimensionality of a query image feature vector representing the query image and sparsifying the hash after expanding dimensionality;
matching the query image hash against hashes in a sample image hash database, wherein the hashes in the sample image hash database are previously generated via the hash model for respective sample images and represent the respective sample images, and wherein the matching identifies one or more matching hashes in the database; and
outputting the one or more matching hashes as a result of the similarity search.

2. The method of claim 1, wherein the hash comprises a K-dimensional vector.

3. The method of claim 1, wherein the expanding dimensionality comprises applying a matrix that is sparse or binary to the feature vector.

4. The method of claim 3, wherein the matrix is random.

5. The method of claim 1, wherein the expanding dimensionality comprises multiplying the query image feature vector by a random projection matrix.

6. The method of claim 5, wherein the random projection matrix is sparse or binary.

7. The method of claim 1, wherein the hash model implements locality-sensitive hashing.

8. The method of claim 1, wherein the sparsifying the hash comprises:
applying a winner-take-all technique or a value threshold to choose one or more winning values of the hash; and
eliminating values from the hash that are not chosen as winning values.

9. The method of claim 1, further comprising:
for the query image hash, generating a pseudo-hash via a pseudo-hash model, wherein generating the pseudo-hash comprises reducing the dimensionality of the query image hash after sparsifying the hash; and
matching the pseudo-hash of the query image against pseudo-hashes in a sample image pseudo-hash database, wherein the pseudo-hashes in the sample image pseudo-hash database are previously generated via the pseudo-hash model for respective sample image hashes and represent the respective sample image hashes, and wherein the matching identifies one or more matching pseudo-hashes in the database; and
outputting the sample image hashes of the one or more matching sample image pseudo-hashes in the sample image hash database.

10. The method of claim 1, wherein the matching comprises:
receiving the query image hash and the sample image hash database; and
finding one or more nearest neighbors in the sample image hash database to the query image hash.

11. The method of claim 1, wherein:
the matching comprises finding a matching hash in the sample image hash database, wherein the matching hash is associated with a bin identifier; and
the method further comprises outputting the bin identifier.

12. The method of claim 1, further comprising:
before generating the query image hash, normalizing the query image feature vector.

13. The method of claim 12, wherein normalizing the query image feature vector comprises:
setting the same mean for the query image as the hashes in the sample image hash database; or
converting feature vector values of the query image feature vector to positive numbers.

14. A similarity search system comprising:
one or more processors; and
memory coupled to the one or more processors, wherein the memory comprises computer-executable instructions causing the one or more processors to perform a process comprising:
for a query image, generating a query image hash via a hash model, wherein generating the query image hash comprises expanding dimensionality of a query image feature vector representing the query image and sparsifying the hash after expanding dimensionality;
matching the query image hash against hashes in a sample image hash database, wherein the hashes in the sample image hash database are previously generated via the hash model for respective sample images and represent the respective sample images, and wherein the matching identifies one or more matching hashes in the database; and
outputting the one or more matching hashes as a result of the similarity search.

15. The system of claim 14, wherein the expanding dimensionality comprises applying a matrix that is sparse or binary to the feature vector.

16. The system of claim 14, wherein the expanding dimensionality comprises multiplying the query image feature vector by a random projection matrix.

17. The system of claim 16, wherein the random projection matrix is sparse and binary.

18. The method of claim 14, wherein the hash model implements locality-sensitive hashing.

19. The method of claim 14, further comprising:
for the query image, generating a pseudo-hash via a pseudo-hash model, wherein generating the pseudo-hash comprises reducing the dimensionality of the query image hash after sparsifying the hash; and
matching the pseudo-hash of the query image against pseudo-hashes in a sample image pseudo-hash database, wherein the pseudo-hashes in the sample image pseudo-hash database are previously generated via the pseudo-hash model for respective sample image hashes and represent the respective sample image hashes, and wherein the matching identifies one or more matching pseudo-hashes in the database; and
outputting the one or more matching pseudo-hashes in the sample image hash database as candidate matches for the similarity search.

20. One or more computer-readable media having encoded thereon computer-executable instructions that, when executed, cause a computing system to perform a similarity search method comprising:
receiving one or more sample images;
extracting feature vectors from the sample images, the extracting generating sample image feature vectors;
normalizing the sample image feature vectors;
with a hash model, generating sample image hashes from the normalized sample image feature vectors, wherein the hash model expands dimensionality of the normalized sample image feature vectors and subsequently sparsifies the sample image hashes after expanding dimensionality;
storing the hashes generated from the normalized sample image feature vectors into a sample image hash database;
receiving a query image;
extracting a feature vector from the query image, the extracting generating a query image feature vector;
normalizing the query image feature vector;
with the hash model, generating a query image hash from the normalized query image feature vector, wherein the hash model expands dimensionality of the normalized query image feature vector and subsequently sparsifies the query image hash after expanding dimensionality;
matching the query image hash against hashes in the sample image hash database; and
outputting matching sample image hashes of the sample image hash database as a result of the similarity search.
